(19) United States
(12) Patent Application Publication
(10) Pub. No.: US 2026/0317245 A1
(43) Pub. Date: Oct. 15, 2026

(54) DURABLE SURFACE DECORATED CEMENTITIOUS BUILDING PRODUCTS

(71) Applicant: James Hardie Technology Limited, Dublin 2 (IE)

(72) Inventors: Weiling PENG, Rancho Cucamonga, CA (US); Luan GIANG, Rancho Cucamonga, CA (US); Guadalupe Alicia OLIVE, Rialto, CA (US); Caidian LUO, Rancho Cucamonga, CA (US)

(21) Appl. No.: 19/630,225

(22) Filed: Mar. 26, 2026

Related U.S. Application Data
(60) Provisional application No. 63/781,141, filed on Mar. 31, 2025.

(51) Int. Cl. C04B 41/45; C04B 41/48; C04B 41/52

(52) U.S. Cl. CPC C04B 41/4539; C04B 41/4853; C04B 41/52

(57) ABSTRACT

Surface decorated cementitious building articles for external use are provided. The article comprises an ink printed surface decoration ink layer in the form of a tie coat comprising crosslinked ink embedded-polymer matrix covalently bonded to an adjacent coated supporting surface.

### CROSS-REFERENCE TO RELATED APPLICATIONS

This application claims the benefit of U.S. Provisional Application Ser. No. 63/781,141, filed Mar. 31, 2025, entitled “DURABLE SURFACE DECORATED FIBER CEMENT PRODUCTS,” which is incorporated by reference herein in its entirety.

### FIELD

The present disclosure relates to durable surface decorated cementitious materials and methods of manufacturing the same, in particular such products which are suitable for exterior applications where weathering conditions are experienced.

### BACKGROUND

Cementitious materials including fiber cement and autoclave aerated concrete materials are commonly used in building construction. Fiber cement boards, for example, can be used both in the interior of a house, such as for tile backing, and on the exterior of the house, such as for siding.

Cementitious materials may be coated to protect the product and add aesthetic appeal. Typical coatings for fiber cement products include sealant and/or primer and a paint topcoating layer.

Fiber cement articles, when provided as decorated prefinished products, may be coated with a clear topcoat layer to protect the product against mechanical damage such as scratching and/or against environmental damage including fading due to UV light exposure thereby aiding in durability and as well as adding aesthetic appeal.

Compared to conventional methods of applying a decorative paint layer to cementitious materials, digital printing is considered more advantageous because the printing technique offers great flexibility in printing various colors, patterns and designs, supports high resolution and sharp authentic looks, supports repeatability and precision in the application of decorative color, patterns and designs including those with three-dimensional effects to a fiber cement product. High quality printed three-dimensional effects have the potential to replace real three-dimensional effects created by the milling, cutting, molding and shaping of fiber cement and non-fiber cement through mechanical means, noting that machining needed to create real three-dimensional effects can be costly and can generate a waste stream that needs to be disposed of. The ability to effectively digitally print high quality images on fiber cement products opens up the possibility of high-end internal and external products that have an appearance representing desirable aesthetics such as natural materials like stone, marble, granite, timber, etc.

Digital printing on fiber cement can be achieved by applying printable inks to the fiber cement surface using an inkjet printer for example. However, ink printed building products are typically only used for indoor applications and are not suitable for exterior applications due to issues with water and weathering resistance. Key components of printable inks include dyes or pigments which provide color to the ink; resin/polymer binder component(s) that aid in substrate adherence; and a carrier to dissolve the resin and dye/pigment to form a printable ink mixture, whereby the carrier is usually water, solvent or resin based. Colorants in inks can be organic dyes, organic pigments or inorganic pigments. Inks made from dyes and organic pigments on their own do not have sufficient UV resistance or overall durability for most external fiber cement product applications. Inorganic pigments, while more durable than organic pigments, tend to show better UV durability than organic pigment ink and other types of inks, but have a tendency towards poor water resistance.

An important property of paints, coatings and inks is adhesion, which refers to the strength of the bonds between layers. Adhesion failure occurs when either the bonds fail, or the adhesive loosens from the substrate. Loss of adhesion can be observed in several ways, including cracking, sagging, blistering, peeling, and flaking. It was believed that conventional coatings formed from suitable clear waterborne thermally curable topcoating technology or from suitable clear UV cured topcoatings provided over the ink surface decoration/images on fiber cement products could impart the necessary adhesions, longevity and weather durability required for fiber cement products used in exterior applications. However, it has been found that for an inkjet ink comprising inorganic pigments printed on fiber cement products, protection with a waterborne clear coating alone was not sufficient as significant blistering and ink cohesive picking (where the coating fails within the ink layer rather than at the junction between distinct coating layers) occurred at the ink layer in paint adhesion tests, both in wet and in freeze thaw conditions. While UV cured clear coatings might improve durability of the ink provided on a fiber cement product digitally printed surface, they are a less desirable option as UV clear coatings on fiber cement surfaces can reduce the breathability of the fiber cement products and increase the risk of blistering under cold or under freeze thaw (FT) conditions. Furthermore, UV cured clear coatings could potentially crack on exposure to UV and adverse color changes might occur. For these reasons, UV cured clear coatings also might not be ideally suited for the exterior conditions experienced by fiber cement products. Therefore, alternative approaches for improving ink durability on digitally printed fiber cement products for external applications would be desirable.

### SUMMARY

In a first aspect, the present disclosure provides a method of manufacturing a surface decorated cementitious building article for external use, the method comprising the steps of:
contacting an inkjet printed surface decoration ink layer provided on a surface of a cementitious building article with a tie coating formulation which comprises one or more of monomer(s) and oligomer(s) with polymerizable functional groups, and optionally, at least a first curing agent comprising amine hydrogen functional groups and preferably further comprises oxyalkylene, and further optionally comprises a second curing agent comprising amine hydrogen functional groups, preferably comprising a polyamine of ammoniated oxirane;
and wherein the surface decoration ink layer comprises an arrangement of one or more of: a plurality of cured ink droplets and/or cured ink domains having interstitial ink-free spaces that provide access to the surface bearing the surface decoration ink layer;
allowing the monomers and/or oligomers of the tie formulation to bridge the surface decorated ink layer and the fiber cement article surface bearing the surface decoration ink layer via the ink-free spaces of the surface decorated ink layer;
inducing polymerization of the monomers and/or oligomers of the tie coating formulation, thereby forming a crosslinked ink embedded-polymer matrix that covalently bonds to the surface bearing the surface decorated ink layer and embeds the ink droplets and/or domains in situ within the crosslinked polymer matrix while preserving fiber cement article's surface decoration;
optionally providing the fiber cement building article with a clear top coating composition, and curing same to form a clear topcoat.

The clear (translucent) topcoat is designed to protect the surface decoration and the product itself against mechanical damage such as scratching during transport, handling and installation, and/or against environmental damage such as protection against the applied image fading due to UV light exposure, thereby aiding in durability and as well adding aesthetic appeal.

In some embodiments, the tie coating formulation is formulated with molecular components including the monomers and/or oligomers having a size that permits penetration through at least a portion of ink-free spaces in the surface decoration ink layer to contact the fiber cement article surface.

In some embodiments, the cementitious building article is a fiber cement building article or an autoclave aerated concrete building article.

In certain embodiments, the tie coating formulation consists essentially of: one or more of monomer(s) and oligomer(s) with polymerizable functional groups, and optionally, at least a first curing agent comprising amine hydrogen functional groups, preferably wherein the first curing agent further comprises oxyalkylene; and the tie coating formulation further optionally comprising a second curing agent comprising amine hydrogen functional groups, preferably wherein the second curing agent comprises a polyamine of ammoniated oxirane. “By consists essentially of”, it is meant that the tie coating formulation includes the listed elements and any non-listed other elements that do not materially affect the basic characteristics of the tie coat function.

Embodiments involving the optional clear topcoating over the crosslinked ink embedded-polymer matrix provides further durability to the surface decorated fiber cement products in external applications, which presents a challenge for ink surface decorated fiber cement products due to problems with durability and/or color fade. In embodiments where a clear topcoating is used to protect a surface decoration, the nanosized particles should not impact the color(s) and quality of the surface decoration. In some embodiments, the surface decoration ink layer may be provided on the supporting surface at a loading of 0.5 gsm and greater, in some embodiments, at a 1 gsm to 5 gsm loading.

The tie coating formulation can be formulated with molecular components including the one or more of monomer(s) and/or oligomer(s), and the optional additional curing components when present, that can access/contact the cementitious article (e.g. fiber cement or autoclave aerated concrete article) surface bearing the surface decoration ink layer via the ink-free spaces in the surface decoration ink layer for reaction therewith.

The monomer(s) and/or oligomer(s) and optional first and optional second curing agents when present, of the tie coating formulation can be low molecular weight monomers and oligomers having a molecular weight of less than about 50,000 g/mol or less, 40,000 g/mol or less, 30,000 g/mol or less, or 20,000 g/mol or less. In some embodiments, the monomer(s) and/or oligomer(s) and optional first and optional second curing agents when present have a molecular weight of less than about 15,000 g/mol or less, about 10,000 g/mol or less, about 5,000 g/mol or less, about 3,000 g/mol or less, about 2,000 g/mol or less, about 1,000 g/mol or less, about 500 g/mol or less, about 300 g/mol or less, or about 100 g/mol or less. It will be appreciated that the monomer(s) and/or oligomer(s) are much smaller than polymer resins used in coalescent coatings which are typically a dispersion of polymer components having molecular weights in the hundreds of thousands to millions of Daltons range.

The tie coat formulation can be substantially free or contains no detectable amount of polymer resin components, or substantially free or contains no detectable amount of latex polymer components, particularly acrylic latex polymer components. Not wishing to be bound by theory, the inventors have found that tie formulations involving resin binder polymers (e.g. latex polymers) in the tie coat formulations cannot access, contact or bridge the surface decorated ink layer and the cementitious article (e.g. fiber cement or autoclave aerated concrete article) surface bearing the surface decoration ink layer via the ink-free spaces of the surface decorated ink layer.

At least the monomer(s) and/or oligomer(s) and other optional components of the tie coating formulation of the tie coating formulation can be liquid at room temperature (e.g., 20-25° C.).

At least some of the monomer(s) and/or oligomer(s), and other optional components, of the tie coating formulation may be solid at room temperature (e.g., 20-25° C.) but have a melting point temperature that lies in a range of oven temperature where water evaporation of the water carrier occurs to form the film (e.g. 160-180° F.) or lies in the range of polymerization temperature of the monomers and oligomers.

The monomers and/or oligomers of the tie coating formulation can be emulsified in a liquid medium, such as an aqueous medium, water or water and a polar solvent. In some embodiments, the emulsion or dispersion comprises monomers and/or oligomers with a distribution of particle sizes of about 0.1 to about 50 microns in the liquid medium, such as an aqueous medium, water, or water and a polar solvent.

, All of the monomer(s) and/or oligomer(s), and other optional components, of the tie coating formulation can be emulsified or dispersed in a liquid medium, preferably an aqueous medium, such as water or water and a polar solvent.

The monomer(s) and/or oligomer(s), and/or other optional components, of the tie coating formulation can be emulsified in a liquid medium, such as an aqueous medium, water or water and a polar solvent, and wherein the emulsion breaks down on contact with the surface decoration ink layer to deliver at least the monomer(s) and/or oligomer(s), and other optional components to cementitious article (e.g. fiber cement or autoclave aerated concrete article) surface bearing the surface decoration ink layer via the interstitial ink-free spaces of the surface decorated ink layer.

The monomer(s) and/or oligomer(s) of the curable tie coating formulation can have one or more polymerizable and/or crosslinkable functional groups selected from the group consisting of: oxirane, amino, hydroxy, alkene (e.g., vinyl), alkenyl, cyanate, aminosilane. In some embodiments, suitable polymerizable and/or crosslinkable functional groups may comprise acrylic functionality, e.g., one or more of: acrylic, styrene acrylic, fluoropolymer acrylic, urethane acrylic, vinyl acrylic and acrylated ethylene vinyl acetate copolymer. Typically, the one or more monomer(s) may be selected from the group consisting of: polyvinylidine fluoride, styrene, alpha-methyl styrene, vinyl chloride, acrylonitrile, methacrylonitrile, ureido methacrylate, vinyl acetate, vinyl esters of branched tertiary monocarboxylic acids, itaconic acid, crotonic acid, maleic acid, fumaric acid, ethylene, and C₄-C₈ conjugated dienes.

In some embodiments, the tie coating formulation used in the method of the disclosure is an emulsion or a dispersion comprising an aliphatic epoxy resin.

The aliphatic epoxy resin can comprise epoxide functional groups. The aliphatic epoxy resin can comprise a monomer including a cycloalkyl group, wherein the aliphatic epoxy resin further comprises epoxide functional groups. The aliphatic epoxy resin can have a monomer structure:

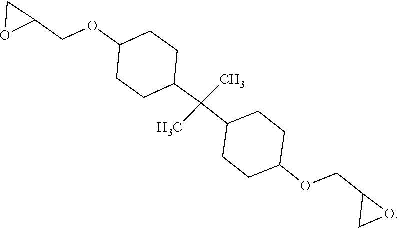 [SMILES: CC(C)(C1CCC(OCC2CO2)CC1)C1CCC(OCC2CO2)CC1]

The emulsion can have emulsion particle size of about 0.1 to about 50 microns.

In some embodiments, the emulsion or a dispersion may comprise optional other components including at least a first curing agent, or including a first and a second curing agent, wherein the first curing agent, or each of the first curing agent and the second curing agent comprise amine hydrogen (e.g., primary amine) functional groups.

The other optional components may comprise functional groups that crosslink with the polymerizable groups of the monomer(s) and/or oligomer(s), for example, such functional groups include amine groups, carboxylate group, and hydroxy groups. Preferred such functional groups include amines and amine hydrogen groups.

The first amine curing agent can comprise an oxyalkylene group.

When present, the second amine curing agent can comprise a polyamine.

In some embodiments, the first curing agent has a viscosity of about 100 to 1,000 cP.

In some embodiments, when present, the second amine curing agent has a higher viscosity than the first amine curing agent.

In some embodiments, the first amine curing agent has amine hydrogen functional groups in about 0.25 to about 2 equivalents, relative to one equivalent of epoxide functional groups in the aliphatic epoxy resin.

In some embodiments, when present, the second amine curing agent has amine hydrogen functional groups in about 0.05 to about 0.5 equivalents, relative to one equivalent of epoxide functional groups in the aliphatic epoxy resin.

In certain implementations, the first curing agent comprises compounds having the formula:

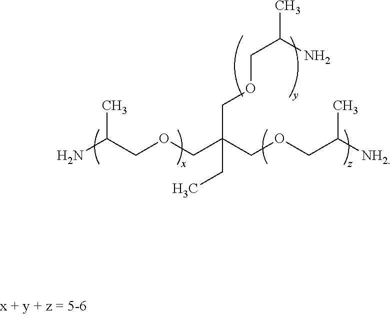

In certain implementations, when present the second curing agent preferably has a viscosity of 25,000 to 50,000 cP. In some embodiments, the second curing agent comprises a polyamine of ammoniated oxirane.

In some embodiments, where a first and second curing agent are present, the first curing agent has amine hydrogen functional groups in about 0.25 to about 2 equivalents, and the second curing agent has amine hydrogen functional groups in about 0.05 to about 0.5 equivalents, relative to one equivalent of epoxide functional groups in the aliphatic epoxy resin.

In certain implementations, the tie coating formulation comprises water.

In certain implementations, the tie coating formulation comprises from 10 to 30 wt % total solids.

In certain implementations, the tie coating formulation comprises an emulsifier.

In certain implementations, the tie coating formulation comprises a defoamer.

In certain implementations, the tie coating formulation comprises a titanium dioxide pigment.

In one embodiment, the tie coating formulation used in the method of the disclosure is an emulsion comprising:
an aliphatic epoxy resin, wherein the aliphatic epoxy resin comprises epoxide functional groups, and the aliphatic epoxy resin has a monomer:

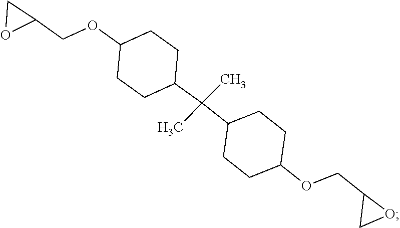 [SMILES: CC(C)(C1CCC(OCC2CO2)CC1)C1CCC(OCC2CO2)CC1]

wherein the emulsion is characterized by an emulsion particle size of about 0.1 to about 50 microns;
a first curing agent and a second curing agent, wherein each of the first curing agent and the second curing agent comprise amine hydrogen functional groups;
wherein the first curing agent has a viscosity of about 100 to 1,000 cP and comprises compounds having the formula

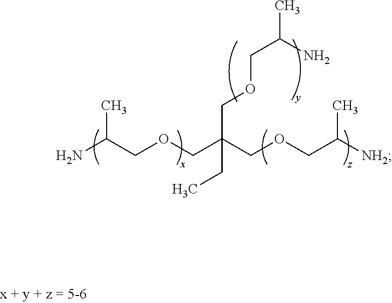

wherein the second curing agent has a viscosity of 25,000 to 50,000 cP, and comprises a polyamine of ammoniated oxirane; and
wherein the first curing agent has amine hydrogen functional groups in about 0.25 to about 2 equivalents, and the second curing agent has amine hydrogen functional groups in about 0.05 to about 0.5 equivalents, relative to one equivalent of epoxide functional groups in the aliphatic epoxy resin.

In another embodiment a curable tie coating formulation used in the method of the first aspect comprises:
an emulsion comprising the aliphatic epoxy resin, wherein the aliphatic epoxy resin comprises a monomer including a cycloalkyl group, wherein the aliphatic epoxy resin further comprises epoxide functional groups, and wherein the emulsion is characterized by an emulsion particle size of about 0.1 to about 50 microns;
a first amine curing agent and a second amine curing agent, wherein each of the first amine curing agent and the second amine curing agent comprise amine hydrogen functional groups;
wherein the first amine curing agent comprises an oxyalkylene; and
wherein the second amine curing agent comprises a polyamine, and wherein the second amine curing agent has a higher viscosity than the first amine curing agent; and
wherein the first amine curing agent has amine hydrogen functional groups in about 0.25 to about 2 equivalents, and the second amine curing agent has amine hydrogen functional groups in about 0.05 to about 0.5 equivalents, relative to one equivalent of epoxide functional groups in the aliphatic epoxy resin.

In certain implementations, the tie coating formulation comprise the first curing agent having amine hydrogen functional groups in about 1 to about 1.5 equivalents relative to one equivalent of epoxide functional groups in the aliphatic epoxy resin.

In certain implementations, the second curing agent has amine hydrogen functional groups in about 0.1 to about 0.3 equivalents, relative to one equivalent of epoxide functional groups in the aliphatic epoxy resin.

In certain implementations, the curable tie coating formulation is applied over the surface decoration ink layer at a coating level to provide a dry film thickness (DFT) of 0.1 mil or higher. In some embodiments, the tie coating formulation is applied at a coating level to provide a coating dry film thickness (DFT) of at least 0.01 mil, and preferably at least from 0.1 mil.

In certain implementations, the surface directly bearing the crosslinked ink embedded-polymer matrix is a cured sealer coating provided on a raw surface of the cementitious article (e.g. fiber cement or autoclave aerated concrete article) building article.

In certain implementations, the surface directly bearing the crosslinked ink embedded-polymer matrix is a cured primer coating provided on a raw surface or a sealed surface of the cementitious building article (e.g. fiber cement or autoclave aerated concrete building article).

In certain implementations, the surface directly bearing the crosslinked ink embedded-polymer matrix is a cured paint coating provided on a sealed surface or a primed surface of the cementitious building article (e.g. fiber cement or autoclave aerated concrete building article.

In certain implementations, the surface directly bearing the crosslinked ink embedded-polymer matrix is a cured paint coating provided on a sealed surface and/or a primer surface and/or the raw surface of the cementitious building article (e.g. fiber cement or autoclave aerated concrete building article).

In some embodiments, the crosslinked ink embedded-polymer matrix is sandwiched between a lower tie coating and an upper tie coating, preferably of the same crosslinked polymer chemistry as the crosslinked ink embedded-polymer matrix.

In certain implementations, the surface decorated cementitious building article (e.g. fiber cement or autoclave aerated concrete building article) comprises a clear topcoating, e.g., at a DFT of at least 0.1 mil, or from about 0.1 to 0.4 mil, or about 0.2 mil.

In certain implementations, the clear top coating is formed from a waterborne thermally cured coating system.

In certain implementations, the clear top coating is formed from a UV cured coating system, e.g., at a DFT of from 0.1 to 0.4 mil, or 0.2 mil.

In certain implementations, the clear topcoating composition provided to the cementitious building article (e.g. fiber cement or autoclave aerated concrete building article) is a waterborne thermally cured coating system, optionally comprising UV stabilizers and/or UV filters, such as HALs and UVAs.

In certain implementations, the clear topcoating composition provided to the cementitious building article (e.g. fiber cement or autoclave aerated concrete building article) is a UV cured coating system, optionally comprising UV stabilizers and/or UV filters, such as HALs and UVAs.

In some embodiments, a method according to the present disclosure comprises providing a surface, such as a prepared surface of a cementitious building article (e.g. fiber cement or autoclave aerated concrete building article), comprising a surface decoration, e.g. a printed ink surface decoration such as a digitally printed image, e.g., an image imitating a natural material, e.g., a wood grain image, a natural stone image, a natural plant image, an animal image or an image of another living creature. In some embodiments, the surface decoration may comprise an image of at least one manufactured material such as concrete, synthetic stone, metal, polymer, composite materials, textiles, ceramics and the like. In another embodiment, the decorative digital image comprises at least one work of figurative art, abstract art, digital art, cartooning, text, symbols, regular shapes, and irregular shapes.

In some embodiments, a prepared surface means a surface that is provided one or more layers, e.g., that may each be provided at a DFT of 1.75 to 2 mils to the surface. In one embodiment, a prepared surface means a surface that is provided with a sealer layer. In another embodiment a prepared surface means a surface that is provided a primer layer. In a further exemplary embodiment, a prepared surface means a surface that is provided with a combined sealer primer layer. In a further alternate exemplary embodiment, a prepared surface means a surface that is provided a sealer layer and a primer layer. In some embodiment, a prepared surface means a surface that is provided with a paint layer, e.g., a commercially available exterior paint, such as James Hardie ColorPlus® technology exterior paint, e.g., in Artic White color. In some embodiments, the paint may be provided on a raw surface, or a surface comprising one or more of a sealer and primer.

In a second aspect, the present disclosure provides a substrate, for example, a cementitious building substrate such as a fiber cement article or an autoclave aerated concrete article for external use, and having a surface decoration disposed thereon, the surface decoration comprising:
at least one inkjet printed surface decoration ink layer in the form of a cured tie coat comprising a crosslinked ink embedded-polymer matrix covalently bonded to an adjacent prepared supporting surface of the substrate,
wherein the crosslinked ink embedded-polymer matrix comprises an arrangement of one or more of: a plurality of cured ink droplets and cured ink domains having interstitial ink-free spaces that access the surface bearing the surface decoration ink layer, the cured ink droplets and cured ink domains embedded in the crosslinked ink embedded-polymer matrix, wherein at least some of the interstitial ink-free spaces are occupied by a crosslinked polymer of the crosslinked ink embedded-polymer matrix.

The crosslinked ink embedded-polymer matrix can embed the ink droplets and/or domains in situ within the crosslinked polymer matrix while preserving the surface decoration.

The substrate may be selected from a wide variety of materials such as, for example, paper, wood, concrete, metal, glass, gypsum, ceramic, plastic, plaster, and roofing substrates such as asphaltic coatings, roofing felts, foamed polyurethane insulation; or to previously painted, primed, undercoated, worn, or weathered substrates. In some embodiments, the surface may be a surface of a building material including composite materials such as cementitious materials, gypsum or other inorganic composite materials, though fiber cement composite materials or autoclave aerated concrete materials are preferred, especially those designed for exterior use. Fiber cement building materials or autoclave aerated concrete building materials may be a porous material comprising one or more different materials such as a gypsum composite, cement composite, geopolymer composite or other composites having an inorganic binder.

The raw (uncoated) surface of the substrate may be sanded, machined, extruded, molded or otherwise formed into any desired shape by various processes known in the art. The fiber cement or autoclave aerated concrete building materials may be fully cured, partially cured or in the uncured “green” state. Fiber cement building materials may further include gypsum board, fiber cement board, fiber cement board reinforced by a mesh or continuous fibers, gypsum board reinforced by short fibers, a mesh or continuous fibers, inorganic bonded wood and fiber composite materials, geopolymer bonded wood and fiber boards, concrete roofing tile material, and fiber-plastic composite material. Preferred fibers include various forms of cellulose fibers, such as treated or untreated, bleached or unbleached Kraft pulp. In addition, other forms of fibers may be used. Suitable examples are those from ceramic, glass, mineral wool, steel, and synthetic polymers (e.g., polyamides, polyester, polypropylene, polymethylpentene, polyacrylonitrile, polyacrylamide, viscose, nylon, PVC, PVA, rayon, glass ceramic, carbon, any mixtures thereof).

In some implementations, the substrate comprises at least one surface decorated ink layer provided on a prepared surface of the substrate, which is, for example, a cementitious building substrate such as a fiber cement article or an autoclave aerated concrete article for external use. The substrate can be a surface of a fiber cement composite material building product. The surface of the substrate can comprise one or more areas of surface decoration, e.g., a printed ink surface decoration such as a digitally printed image or effect, e.g., an image of a natural material such as a wood grain image.

In some embodiments, a prepared surface refers to a raw (untreated) surface of the substate, or a raw (untreated) surface of the substrate with one or more coating layers disposed thereon, for example, a sealer, primer and/or paint coating layer prior to applying the surface decoration over a desired coating layer. Each of the coating layers of the prepared surface when present may have a dry film thickness (DFT) of 1.75 to 2 mils. In one embodiment, a prepared surface is a surface of the substrate that has a sealer coating layer. In another embodiment, a prepared surface of the substrate is a surface that has a primer coating layer. In a further embodiment, a prepared surface of the substrate is a surface that has a combined sealer/primer coating layer as a single coating layer. In a further alternate embodiment, a prepared surface is a surface of the substrate that has distinct sealer and primer coating layers. In some embodiments, a prepared surface is a surface of the substrate that has a paint layer, e.g., a commercially available exterior paint, such as James Hardie ColorPlus® technology exterior paint, e.g., in Artic White color. In some embodiments, the prepared surface of the substrate is a surface that is provided with a sealer coating layer, which is overcoated with a primer coating layer, which is itself overcoated with a paint coating layer, and where the surface decorated ink layer is provided over the paint coating layer. In some embodiments, the paint coating layer may be directly provided on a raw surface of the substrate (without a primer coating layer and sealer coating layer), or a prepared surface having one or more of a sealer and primer coating layers disposed thereon.

In certain embodiments, the ink is one suitable for digital printing, such as an inkjet ink, e.g., a UV curable inks such as those manufactured by TIGER Coatings and by DS.

In one embodiment of the second aspect, there is provided a substrate, for example, a cementitious building substrate such as a fiber cement article or an autoclave aerated concrete article for external use, and having a surface decoration disposed thereon, the surface decoration comprising:
an inkjet printed surface decoration ink layer in the form of a cured tie coat comprising a crosslinked ink embedded-polymer matrix covalently bonded to an adjacent prepared supporting surface,
wherein the crosslinked ink embedded-polymer matrix comprises an arrangement of one or more of: a plurality of cured ink droplets and cured ink domains having interstitial ink-free spaces that access the surface bearing the surface decoration ink layer, the cured ink droplets and cured ink domains embedded in the crosslinked ink embedded-polymer matrix, wherein at least some of the interstitial ink-free spaces are occupied by a crosslinked polymer of the crosslinked ink embedded-polymer matrix.

The crosslinked ink embedded-polymer matrix can embed the ink droplets and/or domains in situ within the crosslinked polymer matrix while preserving the article's surface decoration.

In some implementations, the ink droplets and/or ink domains are provided to the basecoat at an ink droplet density that results in interstitial ink-free spaces being located between the ink droplets and/or ink domains as shown by the arrows in the schematic. The ink droplets and/or ink domains density can be determined by the particular surface decoration of interest. For example, a wood grain effect is a good example of an image that uses an ink density that results in interstitial spaces that allow access to the underlying supporting surface bearing the ink layer.

In some implementations, the crosslinked polymer of the crosslinked ink embedded-polymer matrix is derived from a tie coat formulation that consists essentially of the monomers and/or oligomers, and optionally components described above, but which is substantially free of or contains no detectable amount of polymer resin components, or substantially free of or contains no detectable amount of latex polymer resin components, such as acrylic or acrylic copolymer latex polymer resin.

In some implementations, the adjacent coated supporting surface to which the crosslinked ink embedded-polymer matrix is covalently bonded is a surface provided with one or more of: a cured sealer coating, a cured primer coating, a cured paint coating, and a first cured tie coating.

In some implementations, the tie coating formulation forms a crosslinked ink embedded-polymer matrix having a coating dry film thickness (DFT) of 0.1 mil or higher. In some embodiments, the crosslinked ink embedded-polymer matrix having may have a coating dry film thickness (DFT) of at least 0.1 mil, from 0.1 mil to 0.4 mil, or 0.3 mil.

In some implementations, the cured crosslinked ink embedded-polymer matrix is provided with an overcoat of a second cured tie coating.

In some implementations, the first cured tie coating and the second cured tie coating both comprise the crosslinked polymer of the crosslinked ink embedded-polymer matrix.

In some implementations, the surface decorated cementitious building article (e.g. fiber cement or autoclave aerated concrete building article) further comprises a clear topcoating, optionally comprising UV stabilizers and/or UV filters.

In some implementations, the surface decorated cementitious building article (e.g. fiber cement or autoclave aerated concrete building article) further comprises a clear topcoating formed from a waterborne thermally cured coating system, optionally comprising UV stabilizers and/or UV filters.

In some implementations, the surface decorated cementitious building article (e.g. fiber cement or autoclave aerated concrete building article) further comprises a clear topcoating formed from a UV cured coating system, optionally comprising UV stabilizers and/or UV filters.

In another aspect, a surface decorated cementitious building article (e.g. fiber cement or autoclave aerated concrete building article) includes a discontinuous printed ink layer disposed on a surface of the article substrate, the ink layer comprising a plurality of cured ink droplets and/or cured ink domains arranged with interstitial ink-free spaces therebetween, and a crosslinked polymer matrix disposed over the discontinuous printed ink layer and extending at least partially into the interstitial ink-free spaces. At least a portion of the crosslinked polymer matrix extends through the interstitial ink-free spaces to contact the surface of the article substrate and the cured ink droplets and/or cured ink domains. The crosslinked polymer matrix is formed by polymerization of a curable composition comprising monomers and/or oligomers within at least some of the interstitial ink-free spaces, the crosslinked polymer matrix securing the ink layer to the surface of the substrate.

In some implementations, the cementitious building article (e.g. fiber cement or autoclave aerated concrete building article) substrate comprises one or more coating layers, and the discontinuous printed ink layer is disposed over the one or more coating layers. The one or more coating layers comprises a sealer layer, a primer layer, a paint layer, or a combination thereof.

### BRIEF DESCRIPTION OF THE DRAWINGS

FIG. 1A is a schematic cross-section of an inkjet printed surface decoration on a white colored paint coating as background.

FIG. 1B shows a magnified view of an inkjet-printed woodgrain surface on a painted fiber cement substrate.

FIG. 2A illustrates a schematic cross-sectional view of an embodiment of a digitally printed fiber cement product, in which an ink layer is embedded within a tie coat comprising a crosslinked polymer matrix.

FIG. 2B illustrates a schematic cross-sectional view of another embodiment of a digitally printed fiber cement product, in which an ink layer is embedded within a tie coat comprising a crosslinked polymer matrix.

FIG. 2C illustrates a schematic cross-sectional view of another embodiment of a digitally printed fiber cement product, in which an ink layer is embedded within a tie coat comprising a crosslinked polymer matrix.

FIG. 3A shows blistering on a UV-curable fiber cement product after water immersion.

FIG. 3B shows ink cohesive picking on UV-curable inkjet printed fiber cement products with a waterborne clear coating.

FIG. 4 shows results of wet paint adhesion testing of coated UV-curable inkjet printed fiber cement products.

FIG. 5 shows results of wet paint adhesion in terms of total picking.

FIG. 6 shows the results of wet paint adhesion tests on UV cure clear coatings on UV-curable inkjet printed fiber cement products in terms of ink cohesive picking results.

FIG. 7 shows results of paint adhesion of UV cure clear coatings on UV-curable inkjet printed fiber cement products tested under freeze thaw conditions in terms of total picking.

FIG. 8 shows the results of paint adhesion testing of UV cured clear coatings on UV-curable inkjet fiber cement products under freeze thaw conditions.

FIG. 9 shows the surface energy of UV-curable inkjet printed fiber cement products with and without surface treatment.

FIG. 10 shows significant blistering that observed on a coated UV-curable inkjet printed fiber cement product.

FIG. 11 shows visual results of wet paint adhesion testing of UV-curable inkjet printed fiber cement products with and without a coating layer provided between the ink layer and a clear coat.

FIG. 12 shows visual results of paint adhesion testing of inkjet printed fiber cement products including a coating layer provided between the ink layer and a clear topcoat.

FIG. 13 shows the effect of coating thickness on paint adhesion under wet and freeze thaw conditions.

FIG. 14 shows the effect of an example tie coat formulation on delta E (dE) in QUVB exposure tests where the tie coating formulation is provided between the ink surface layer and the clear topcoat.

FIG. 15 shows the effect of an example tie coat formulation dosage on total picking under wet/freeze thaw adhesion testing of fiber cement products.

FIG. 16 shows the effect of an example tie coat formulation dosage on ink cohesive picking under wet/freeze thaw adhesion testing of fiber cement products.

FIG. 17 shows the effect of an example tie coat formulation on dE in QUVA exposure tests where the tie coating formulation is provided between the ink surface layer and the clear topcoat.

FIG. 18 shows the effect of an example tie coat formulation on dE in QUVA exposure tests where the tie coating formulation is provided between the ink surface layer and the clear topcoat.

FIG. 19 shows the effect of coating thickness of isocyanate tie coating formulations on total picking under wet and freeze thaw adhesion testing.

FIG. 20 shows the effect of coating thickness of isocyanate tie coating formulations on ink cohesive picking under wet and freeze thaw adhesion testing.

FIG. 21 shows visual results of paint adhesion testing of UV-cured inkjet printed fiber cement products including an example tie coating formulation provided over an surface decoration ink layer and an waterborne clear coat.

FIG. 22 shows results of wet adhesion picking tests for configurations with an example tie coating formulation applied before or after ink printed layer.

FIG. 23 shows results of wet ink cohesive picking tests for configurations with an example tie coating formulation applied before or after ink layer.

FIG. 24 shows results of freeze-thaw ink cohesive picking tests with an example tie coating formulation before and after ink printing including sandwich configuration.

### DETAILED DESCRIPTION

Although making and using various embodiments are discussed in detail below, it should be appreciated that the embodiments described provide inventive concepts that may be embodied in a variety of contexts. The embodiments discussed herein are merely illustrative of ways to make and use the disclosed articles, systems and methods and do not limit the scope of the disclosure.

In the description which follows, like parts may be marked throughout the specification and drawings with the same reference numerals. The drawing figures are not necessarily to scale and certain features may be shown exaggerated in scale or in somewhat generalized or schematic form in the interest of clarity and conciseness.

Key components of printable inks include dyes or pigments which provide color to the ink; resin/polymer binder component(s) that aid in substrate adherence; and a carrier to dissolve the resin and dye/pigment to form a printable ink mixture, whereby the carrier is usually water, solvent or resin based. Colorants in inks can be organic dyes, organic pigments or inorganic pigments. Inks made from dyes and organic pigments on their own typically do not have sufficient UV resistance or overall durability for most external fiber cement product applications. Inorganic pigments while more durable than organic pigments, tend to show better UV durability than organic pigment ink and other types of inks, but have a tendency towards poor water resistance. In addition to UV damage, exterior building products will often be wet and will experience freeze thaw cycling in the field. Some ink types have poor UV and/or water resistance. Typically, a CYMK (Cyan, Yellow, Magenta, & Black) ink color system is used to provide a range of color inks to the print heads of a commercially available large format printer.

Where mentioned herein, the viscosity may be measured by Brookfield viscometry, preferably using AST D2193, for example using a BROOKFIELD Digital Viscometer, spindle standard LV (61-64). An average of three measurements may be taken to get the true value. As explained above, inkjet ink is commonly used for interior applications but unfortunately is normally not durable enough for the exterior applications due to issues such as adhesion and/or color fade under weathering conditions.

n The inventors have found that (as shown herein) when inorganic based pigments, such as those used in certain TIGITAL® Inks, are printed on fiber cement products with a waterborne clear topcoating, significant blistering and ink cohesive picking may occur in paint adhesion tests, particularly under wet and freeze thaw conditions. This suggests that waterborne clear coatings alone over inkjet ink surface decorations on fiber cement products are not sufficient to weatherproof inkjet printed surface decorations on painted surfaces of fiber cement boards. Furthermore, UV clear coatings alone are not a good alternative as cracking and color change issues were found to arise with UV clear coatings when used over UV-curable inkjet printed fiber cement products.

Aspects of the present disclosure relate to a method of enhancing the durability and/or adhesion of an inkjet ink surface decoration provided on surfaces of building products for exterior applications, such as exterior fiber cement boards or exterior autoclave cured concrete panels. As demonstrated herein, the method of the disclosure makes inkjet printed surface decorations, e.g., UV curable inorganic pigment based inks, water resistant in tests under harsh wetting conditions where coating blistering and/delamination, peeling or other damage is avoided or substantially reduced. The method of the disclosure provides top coated ink printed products that are much more resistant to wet adhesion tests involving tape peeling studies.

### Adhesion of Surface Decoration to Supporting Surface

The surface decoration ink layer can comprise an arrangement of one or more of: a plurality of cured ink droplets and/or cured ink domains, having interstitial ink-free spaces between the droplets/domains that provide access to the surface bearing the surface decoration ink layer. Access is possible because there is an absence of the ink component over these areas of the underlying surface (e.g., the basecoat surface). A first step of a method of this disclosure involves applying a curable tie coating formulation to an inkjet printed surface decoration ink layer disposed on a surface of a fiber cement building article. In some embodiments, the curable tie coating formulation comprises or consists essentially of: polymerizable monomer(s) and/or oligomer(s) with polymerizable functional groups that form a binder polymer on curing; and optionally, at least a first curing agent comprising amine hydrogen functional groups and, in some embodiments, further comprises oxyalkylene, and further optionally comprises a second curing agent comprising amine hydrogen functional groups, in some embodiments, comprising a polyamine of ammoniated oxirane. In certain embodiments, the tie coating formulation consists essentially of: one or more of monomer(s) and oligomer(s) with polymerizable functional groups, and optionally, at least a first curing agent comprising amine hydrogen functional groups and in certain embodiments further comprises oxyalkylene, and further optionally comprises a second curing agent comprising amine hydrogen functional groups, in certain embodiments, comprising a polyamine of ammoniated oxirane.

The method involves allowing the monomer(s) and/or oligomer(s) of the curable tie formulation to bridge the surface decorated ink layer and the surface bearing the surface decoration ink layer via the ink-free spaces of the surface decorated ink layer. Thereafter, curing the curable tie formulation inducing polymerization of the monomer(s) and/or oligomer(s) of the tie coating formulation to form crosslinked ink embedded-binder polymer matrix that covalently bonds to the surface bearing the surface decorated ink layer. The method may also comprise the optional step of providing a curable clear topcoating composition over at least a portion of the crosslinked ink embedded-binder polymer matrix, and curing the curable clear topcoating to form a clear topcoat that provides additional protection and durability the surface decorated ink layer and the substrate itself.

It will be understood that a monomer is a molecule that can combine with other molecules to form an oligomer or polymer. An oligomer is a molecular complex comprised of a few monomer units. These are very different to the much higher molecular weight polymer components (MN) in hundreds of thousands) of a polymer resin component used as a binder in coating or paint systems, e.g., acrylic latex polymer, which comprises an emulsion of acrylic polymeric particles in water. The acrylic polymer particles may comprise crosslinkable groups (that can crosslink with curing agents), for most acrylic latex emulsions, coalescence (where the polymeric particles coalesce to form a film involving inter-particle diffusion of polymer chain to form a film network) is the main mechanism that gives rise to a coating formed from a latex polymer system. The latex polymer may be a polydisperse copolymer made up of a distribution of different molecular weights of different distinct polymer component units that can be repeated and can be present in different amounts of repeating units, e.g., characterized by number average molecular weights (MN), weight average molecular weight (Mw) or the degree of polymerisation (DP).

The monomer(s) and/or oligomer(s) (and other optional curing agent components when present) of the curable tie coating formulation are formulated such that the uncured monomers and/or uncured oligomers units can access the surface bearing the surface decoration ink layer via the ink-free spaces in the surface decoration ink layer. The components of the tie formulation occupy many, if not most of the ink-free spaces in the surface decoration ink layer and in doing so, directly contact the underlying surface bearing the surface decoration ink layers. Enough of the curable tie formulation to flood the surface ink decoration layer with a uniform layer of the tie formulation should be used. On curing, the monomer(s) and/or oligomer(s) (and other optional components when present) polymerize to form a polymer binder, and during the polymerization process, embed the cured ink droplet and/or cured ink domains within crosslinked binder polymer matrix. The access to the ink-free spaces allows strong covalent bonds to form between the polymerized binder polymer matrix and the surface bearing the surface decoration ink layer which comprises functional groups suitable for crosslinking with the monomer(s) and/or oligomer(s) of curable tie coating formulation. Advantageously, the cured ink droplet/ink domain shapes and locations are not disturbed and so the quality and color of the surface decoration is preserved during the embedding process. A major advantage is the protection the crosslinked ink embedded-binder polymer matrix provides and the strong adhesion of the surface decoration ink layer to the surface on which it is printed. The crosslinked ink embedded-binder polymer matrix has been found to enhance the surface decoration ink layer's ability to resist water as exhibited by a marked reduction in blistering and/or likelihood to adhesion failure, even in wet adhesion testing.

### Ink and Application Method

The ink can be applied onto the surface via a variety of methods including hand application, offset printing or digital printing technology. In some examples of digital printing, the printing method for producing images is an inkjet printing method. During inkjet printing, a stream of droplets of ink is jetted onto a recording substrate such as a surface or media to form the desired printed image, e.g., typically in the form of a surface decoration. The ink composition may be established on the recording substate media via any suitable inkjet printing technique. Examples of inkjet methods include methods such as a charge control method that uses electrostatic attraction to eject ink, a drop-on-demand method which uses vibration pressure of a Piezo element, an acoustic inkjet method in which an electric signal is transformed into an acoustic beam, and a thermal inkjet method that uses pressure caused by bubbles formed by heating ink. Non-limitative examples of such inkjet printing techniques include thermal, acoustic and piezoelectric inkjet printing. In some examples, the ink composition is applied onto the recording media using inkjet nozzles. In some other examples, the ink composition is applied onto the recording method using thermal inkjet printheads.

The cured ink can be an inkjet ink, in some embodiments a UV-curable inkjet ink that forms the ink droplet(s) and/or ink domain(s) on the surface by an inkjet printer head. UV-curable inkjet ink can include a colorant (e.g. organic dyes, organic pigments or inorganic pigments), a photo initiator, and a reactive resin binder component such as monomers or reactive polymers that can polymerize or cross-link upon exposure to radiation curing such as by UV radiation through UV light exposure to aid in substrate adherence and a carrier to dissolve the resin and dye/pigment to form a printable ink mixture, whereby the carrier is usually water, solvent or resin based. In some embodiments, the cured ink is based on inorganic pigments. In in certain embodiments, the ink is a UV curable inorganic pigment-based inkjet ink such as those supplied by TIGER Coatings and by DS. Such inks may be cured by exposure to radiation doses from a UV emitting LED lamp at a dose rate of less than 5 mJ/sq. cm to fully cure ink layer, or lower doses of approximately half that can be used to partially cure the ink layer.

### Tie Coating Formulation

As explained above, the monomers and/or oligomers (and other curable optional components when present) of the tie coating formulation may be low molecular weight monomers and oligomers having a molecular weight of less than about 50,000 g/mol or less, 40,000 g/mol or less, 30,000 g/mol or less, or 20,000 g/mol or less. In some embodiments, the tie coat formulation, when precured, may be substantially free of polymer components, in some embodiments, substantially free of latex polymer components. Such components may be relatively large and therefore may not effectively bridge the surface decorated ink layer and access the fiber cement article surface bearing the surface decoration ink layer via the ink-free spaces of the surface decorated ink layer. This is demonstrated by the results herein with the epoxy polymer (EP5) coating system which did not significantly improve the ink layer adhesion compared to the low molecular weight crosslinkable epoxy based, isocyanate based or aminosilane based tie coating formulations of the examples described herein. The form of delivery of the tie coating components can be important in some embodiments. For example, in some embodiments, the monomer(s) and/or oligomer(s) of the tie coating formulation can be emulsified in a liquid medium, an aqueous medium, or water or a water and polar solvent mixture. In certain embodiments, the monomers and/or oligomers of the tie coating formulation may be emulsified in a liquid medium, wherein the emulsion comprises monomers and/or oligomers having a particle size of about 0.1 to about 50 microns.

Furthermore, in some embodiments, at least some or all of the components of the tie coating formulation are themselves liquid at room temperature (e.g., 20° C.). The tie component formulation may be a single component which can be a pure liquid, such as the isocyanate tie coating formulation or the aminosilane tie coating formulation described herein. However, in some embodiments, at least some or all of the components of the tie coating formulation may be solid at room temperature (e.g., 20° C.) so long as they have a melting point temperature that lies in a range of curing for the system in question.

Embodiments involving emulsions and/or dispersions of the components of the tie coating formulation as particles in an aqueous carrier system are advantageous as upon contacting the ink layer the emulsion breaks down and delivers a concentrated load of the reactive components to the ink layer. In some embodiments, at least a portion of the monomer(s) and/or oligomer(s) of the tie coating formulation are emulsified in a liquid medium, and wherein the emulsion breaks down on contact with the surface decoration ink layer to deliver the monomers and/or oligomers to fiber cement article surface bearing the surface decoration ink layer via the interstitial ink-free spaces of the surface decorated ink layer.

In some embodiments, the chemistry of the monomer(s) and/or oligomer(s) of the curable tie coating formulation have one or more polymerizable and/or crosslinkable functional groups selected from the group consisting of: oxirane (epoxy), amino, hydroxy, alkene (e.g., vinyl), alkenyl, cyanate, aminosilane, and carboxy. In certain embodiments, the one or more polymerizable and/or crosslinkable functional groups include epoxy groups. In some embodiments, the epoxy groups can include various chemical constituents, for example, one or more of an aromatic epoxy, a BPA epoxy, a non-BPA aromatic epoxy, a hydrogenated bisphenol A epoxy, an aliphatic epoxy, a cyclic aliphatic epoxy, an oligomeric aliphatic epoxy, a polymeric aliphatic epoxy, an oligomeric aromatic epoxy, a polymeric aromatic epoxy, or a combination thereof. The epoxy resin can further include one or more functional groups, for example, a glycidol ether, a diglycidyl, a cycloalkyl, a cyclohexyl, a phenyl glycidyl ether, or a combination thereof. In further embodiments, the epoxy resin can include a hydrogenated diglycidyl ether of bisphenol A. In certain embodiments, the epoxy groups include aliphatic epoxy groups as aliphatic epoxy groups are less likely to yellow on outdoor exposure.

More specifically, suitable polymerizable functional groups of the monomer(s) and/or oligomer(s) may comprise acrylic functionality, e.g., one or more of: acrylic, styrene acrylic, fluoropolymer acrylic, urethane acrylic, vinyl acrylic and acrylated ethylene vinyl acetate copolymer. Typically, the one or more monomer(s) units may be selected from the group consisting of: polyvinylidine fluoride, styrene, alpha-methyl styrene, vinyl chloride, acrylonitrile, methacrylonitrile, ureido methacrylate, vinyl acetate, vinyl esters of branched tertiary monocarboxylic acids, itaconic acid, crotonic acid, maleic acid, fumaric acid, ethylene, and C₄-C₈ conjugated dienes. The one or more oligomers may be comprises of several of the aforementioned monomers units. The other optional components may comprise functional groups that crosslink with the polymerizable groups of the monomer(s) and/or oligomer(s), for example, such functional groups include amine groups, carboxylate group, and hydroxy groups. In certain embodiments, such functional groups include amines and amine hydrogen groups. Aliphatic chemistries involving these functionalities may be used as they are less likely to yellow on outdoor exposure.

All or some of the components of the tie coating formulation can be 100% solid (with a melting point within the temperature range of curing), waterborne, or organic solvent borne. The tie coating formulation can be one that is curable by radiation, e.g., radiation curable, e.g., UV curable, and/or may be one that is thermally curable. For the solid components, the components may melt into a liquid at the curing temperature. In some embodiments, the tie coating formulation comprises one or more, or all of the components as an emulsion of oil particles in a water emulsion.

In one embodiment the tie coating formulation comprises: an emulsion comprising the aliphatic epoxy resin, wherein the aliphatic epoxy resin comprises a monomer including a cycloalkyl group, wherein the aliphatic epoxy resin further comprises epoxide functional groups, and wherein the emulsion is characterized by an emulsion particle size of about 0.1 to about 50 microns; a first amine curing agent and a second amine curing agent, wherein each of the first amine curing agent and the second amine curing agent comprise amine hydrogen functional groups; wherein the first amine curing agent comprises an oxyalkylene; and wherein the second amine curing agent comprises a polyamine, and wherein the second amine curing agent has a higher viscosity than the first amine curing agent; and wherein the first amine curing agent has amine hydrogen functional groups in about 0.25 to about 2 equivalents, and the second amine curing agent has amine hydrogen functional groups in about 0.05 to about 0.5 equivalents, relative to one equivalent of epoxide functional groups in the aliphatic epoxy resin.

In certain embodiments, the tie coating formulation is an emulsion comprising an aliphatic epoxy resin, wherein the aliphatic epoxy resin comprises epoxide functional groups, and the aliphatic epoxy resin comprises a monomer:

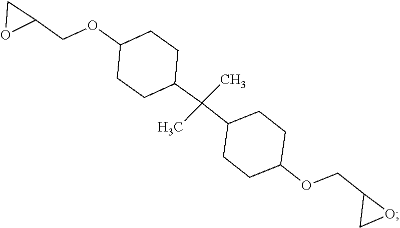 [SMILES: CC(C)(C1CCC(OCC2CO2)CC1)C1CCC(OCC2CO2)CC1]

wherein the emulsion is characterized by an emulsion particle size of about 0.1 to about 50 microns; and
a first curing agent and a second curing agent, wherein each of the first curing agent and the second curing agent comprise amine hydrogen functional groups; wherein the first curing agent has a viscosity of about 100 to 1,000 cP and comprises compounds having the formula

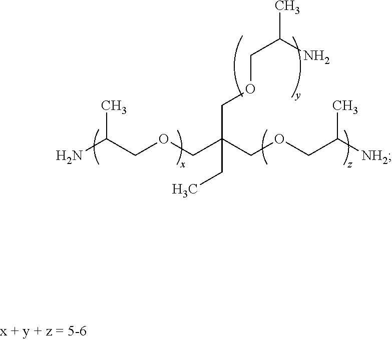

wherein the second curing agent has a viscosity of 25,000 to 50,000 cP, and comprises a polyamine of ammoniated oxirane; and wherein the first curing agent has amine hydrogen functional groups in about 0.25 to about 2 equivalents, and the second curing agent has amine hydrogen functional groups in about 0.05 to about 0.5 equivalents, relative to one equivalent of epoxide functional groups in the aliphatic epoxy resin.

Implementing the method of this disclosure can produce a surface decorated cementitious building article for external use, the article comprising: an inkjet printed surface decoration ink layer in the form of a tie coat comprising crosslinked ink embedded-polymer matrix covalently bonded to an adjacent coated supporting surface, wherein the crosslinked ink embedded-polymer matrix comprises an arrangement of one or more of: a plurality of cured ink droplets and cured ink domains having interstitial ink-free spaces that access the surface bearing the surface decoration ink layer, the cured ink droplets and cured ink domains embedded in the crosslinked ink embedded-polymer matrix, wherein at least some of the interstitial ink-free spaces are occupied by a crosslinked polymer of the crosslinked ink embedded-polymer matrix. The crosslinked ink embedded-polymer matrix embeds the ink droplets and/or domains in situ within the crosslinked polymer matrix while preserving article's surface decoration.

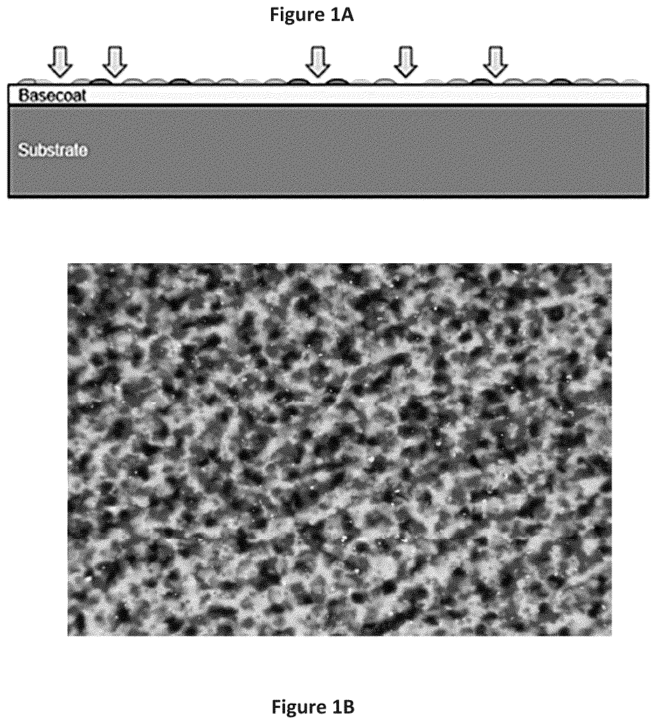

The ink of the surface decorated ink layer is disposed on the article surface bearing the surface decoration ink layer (e.g., a surface other than raw fiber cement or raw autoclave aerated concrete, e.g., it can be a cured paint, cured primer or a cured first tie coat surface onto which the surface decorated ink layer is provided) in the form of a plurality of cured ink droplets and cured ink domains having interstitial ink-free spaces that provide access to the surface that bears the surface decoration ink layer (which is the basecoat in this case). The ink droplets are provided to the basecoat at an ink droplet density that results in interstitial ink-free spaces being located between the ink droplets and/or ink domains as illustrated by the arrows shown in FIG. 1A. It will be understood that the ink droplets and/or ink domains density will be determined by the particular surface decoration of interest. For example, a wood grain effect is a good example of an image that uses an ink density that results in interstitial spaces that allow access to the underlying supporting surface bearing the ink layer. Suitability of other images can be determined by viewing under a microscope where a suitable density is indicated by observation of portions of the ink free basecoat, for example, the white color of the paint coating reported herein (e.g., see FIG. 1B). The interstitial spaces provide access and/or a pathway for the monomers and/or oligomers of the tie formulation to bridge the ink decoration layer and to contact the surface of the underlying surface, e.g., a paint base coat. As explained herein, the monomers and or oligomers are sized/formulated to fill these interstitial spaces and to contact the underlying surface so that on polymerization of the monomers and/or oligomers of the tie coating formulation, a crosslinked ink embedded-polymer matrix that covalently bonds to the surface bearing the surface decorated ink layer is formed that strongly adheres the ink layer to the underlying surface. Advantageously, the crosslinked ink embedded-polymer matrix embeds the ink droplets and/or domains in situ within the crosslinked polymer matrix while preserving article's surface decoration.

As explained above, the tie coating formulation is specifically formulated to avoid uncured components in polymer form (e.g., as are found in the epoxy latex polymer resin (EP) formulation used in the examples). Uncured polymers have a much larger molecular size than the monomer and oligomers used herein and as such as not capable of bridging the surface decorated ink layer and the article surface bearing the surface decoration ink layer via the ink-free spaces of the surface decorated ink layer to any useful extent.

Surprisingly, the tie coat formulations described herein embed the ink droplets and/or ink domains in situ in the crosslinked polymer matrix, while preserving the surface decoration, e.g., the image integrity (in terms of ink droplet/domain position, size and color quality. At the same time, the crosslinked ink embedded-polymer matrix formed strongly adheres to the supporting coating and reinforces and protects the ink against ink cohesive picking that would otherwise occur on exposure to water, for example, during the wet and freeze-thaw adhesion tests described herein. Forming the crosslinked ink embedded-polymer matrix in this manner has been demonstrated to dramatically improves the water resistance and paint adhesion of the surface decoration ink layer to the painted article surface under wet adhesion conditions. Indeed, as shown herein, the formation of the crosslinked ink embedded-polymer matrix reduces ink cohesive picking from 100% to 0% under water saturation conditions. The technology is effective enough that it is believed that it enables use of surface decorated ink layer that are suitable for external application and will have good resistance to weathering. By contrast, based on the results described herein, tie coat technology based on formulations of polymer resin systems where the polymer used (e.g., latex polymers) have very high molecular weights (e.g., at the hundreds of thousands to millions of g/mol level) with particle sizes from tens to hundreds of nanometers are believed to be unable to penetration the ink layer to any significant degree and are not suitable for forming the crosslinked ink embedded-polymer matrix which is a focus of the present technology.

In some embodiments, during manufacture the low molecular weight crosslinkable coating system may be provided above and/or under the ink surface decoration in amount that forms a dry film thickness of at least 0.01 mil, or at least 0.1 mil.

It has been found that improved adhesion and/or improved water resistance of inkjet inks, particularly UV-curable inkjet inks (or other inorganic based inks that otherwise have poor water resistance) to a sealed, primed and/or painted article surface can be achieved via application of crosslinkable low molecular weight compounds to the ink layer (e.g., under and/or over the ink layers so that the provided crosslinkable compounds penetrate the ink layer and fill pores in the ink layer). The crosslinked ink embedded-polymer matrix formed upon curing is substantially water resistant and/or that improves adhesion of the ink to the article surface, while retaining the printed image in substantially unchanged format despite the addition of the crosslinkable compound chemistry to the ink. The improvement as a result of the formation of the crosslinked ink embedded-polymer matrix is demonstrated by resistance to picking/delamination of the ink and/or ink and ink supporting base layer that supports the ink on the article surface. When coated with a clear topcoating, products with the crosslinked ink embedded-polymer matrix as tie coat shows much reduced and indeed in most cases zero ink picking, and in certain embodiments, at least <50%, at least <40%, at least <30%, at least <20%, at least <10%, at least <5%, or 0% ink/ink supporting base layer picking (termed “total picking” herein) as assessed by a coating adhesion tape test in wet adhesion and/or free-thaw adhesion testing, wherein the % value represents the amount of the coating that is pulled off the surface onto the adhesive side of the tape. The tie coating formulation is applied above the ink layer to facilitate the crosslinker component penetration necessary to ensure sufficient protection from water resistance and/or ink adhesion upon curing. Alternatively, the tie coating formulation can be sandwiched between a cured layer of a tie coating and a wet coating of the tie coat formulation which is subsequently cured on the sufficient traversal of the ink layer to the cured tie coat supporting surface has occurred. Without the tie coating of the disclosure, the examples described herein demonstrate that ink picking after wetting is greater than 50% and in many cases is 100% piking confirming the poor adhesion without the tie coating formulation of the disclosure. Indeed, it has been found that the use of a tie coating formulation according to the disclosure reduces inorganic ink cohesive picking from 100% to 0% for fiber cement products that are subjected to water saturation conditions, and this was still the case even when the digitally printed fiber cement product was subjected to freeze thaw conditions.

The polymerizable monomer(s) and/oligomer(s) and the optionally crosslinkable components (first and second curing agents when present) are not limited, provided that they can readily access the surface bearing the surface decorated ink layer, fill the voids therein, while maintaining the ink quality and fidelity of the image and/or ink and image stability is not substantially disturbed before or after curing. The component chemistries have been discussed above.

The crosslinkable compounds may be provided to the ink layers(s) in solid, waterborne, or solvent borne form. For example, conventional methods such as spraying, flood coating, painting, can be used to apply the wet tie coating formulation to the supporting surface bearing the surface decorated ink layer.

The components of the tie coating formulation polymerize/crosslinked upon curing, wherein the curing can involve one or more of: radiation curing and/or thermal curing. It will be understood that curing causes polymerizing reactions between crosslinkable bonds of the crosslinkable compounds/components of the formulation to form a crosslinked polymer binder matrix that scaffolds or locks the ink droplets and/or domains in position while covalently bonding to the supporting surface through bond formation between the crosslinkable functional groups and suitable functional groups on the supporting surface, e.g., a sealer, primer, paint coating, or a paint coating.

In some embodiments, the dry film thickness (DFT) of the crosslinked ink embedded-polymer matrix can range from about 0.01 mil and greater, or 0.1 mils and greater.

### Example Tie Coating Formulations

James Hardie has developed a coating technology that improves coating adherence to raw and machined raw surfaces of cementitious articles that is described in detail in U.S. Pat. No. 10,604,453 B1, the entire contents of which are incorporated herein by reference. Particularly relevant details of the coating formulation relevant to this disclosure are provided in the published patent in columns 2 to 16, including the examples of aliphatic epoxides in Table 1, the examples of curing agents in Table 2, and the worked examples of tie coating formulations in Example 1 including Table 3, as well as the compositions of granted claims 1 to 9, all of which are incorporated by reference. The coating technology described in U.S. Pat. No. 10,604,453 B1 can be used a tie coating formulation in the method of the present disclosure. In some embodiments, the tie coating formulation therefore can comprise a waterborne emulsion of an aliphatic epoxy resin having a small and controlled emulsion particle size of between about 0.1 to about 50 microns, a first curing agent having amine functional groups (e.g., aliphatic amine) and a second curing agent having amine functional groups (e.g. polyamine) that can react with the aliphatic epoxy resin to set and cure the resin. The second curing agent may have a higher viscosity than the first curing agent. The curing agents together provide penetrating capability to the tie coating formulation, and stabilize the emulsion.

In some embodiments, a tie coating formulation suitable for use with the present technology, comprises: an emulsion comprising an aliphatic epoxy resin, wherein the aliphatic epoxy resin comprises epoxide functional groups, and the aliphatic epoxy resin has a monomer:

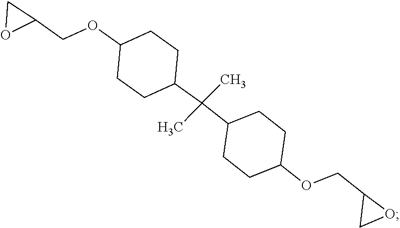 [SMILES: CC(C)(C1CCC(OCC2CO2)CC1)C1CCC(OCC2CO2)CC1]

wherein the emulsion is characterized by an emulsion particle size of about 0.1 to about 50 microns;
a first curing agent and a second curing agent, wherein each of the first curing agent and the second curing agent comprise amine hydrogen functional groups;
wherein the first curing agent has a viscosity of about 100 to 1,000 cP and comprises compounds having the formula

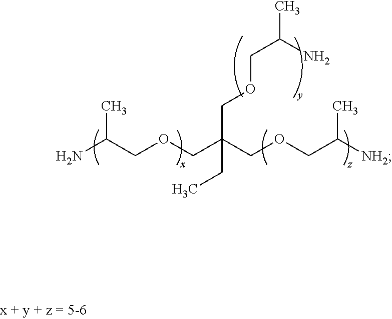

wherein the second curing agent has a viscosity of 25,000 to 50,000 cP, and comprises a polyamine of ammoniated oxirane; and
wherein the first curing agent has amine hydrogen functional groups in about 0.25 to about 2 equivalents, and the second curing agent has amine hydrogen functional groups in about 0.05 to about 0.5 equivalents, relative to one equivalent of epoxide functional groups in the aliphatic epoxy resin.

The first curing agent may be of low viscosity to provide wettability to the tie coating formulation, and the second curing agent may aid in stabilizing the emulsion. The first curing agent may have a viscosity of less than about 1000 cP, for example, about 100 to about 1,000 cP, e.g., as determined by Brookfield viscometry. The equivalent ratios of reactive functional groups in the two curing agents may provide functional characteristics to the tie coating formulation. In some embodiments, the tie coating formulation may include reactive functional groups of the first curing agent in about 0.25 to about 2 equivalents, and reactive functional groups of the second curing agent in about 0.05 to about 0.5 equivalents, relative to one equivalent of epoxide groups in the aliphatic epoxy resin.

The tie coating formulation may include a ratio of about 1 equivalent of total epoxide functional groups to 0.1 to 4 total equivalents of reactive curing functional groups. For example, when the curing agent includes one or more amines, the curing agent can be characterized by an equivalent mass per amine hydrogen. In some embodiments, the tie coating formulation can have a ratio of about 1 equivalent of total epoxide groups to 0.1 to 4 total equivalents of reactive curing functional groups such as an amine hydrogen; or about 1 equivalent of total epoxide groups to 0.2 to 2 total equivalents of reactive curing functional groups, or about 1 equivalent of total epoxide groups to 1 to 1.8 total equivalents of reactive curing functional groups.

The tie coating formulation may further comprise one or more additives which can be one or more of a solvent, one or more pigments, a defoamer, fillers, an emulsifier, or a combination thereof. The tie coating formulation also generally comprises water. Each component of the tie coating formulation may be suspended, dispersed, emulsified or form a colloid in the water. In some embodiments, the tie coating formulation includes water to provide a selected solid content, e.g., total solid content about 5-100%, about 5-90%, about 5-70%, about 5-50%, about 10-40%, about 15-55%, about 20-50%, about 15-40%, about 10-30%, about 20-40%, or a value in a range defined by any of these values.

The tie coating formulation used may comprises 20% to 85% by weight of aliphatic epoxy resin, 10% to 70% by weight of curing agent, 0 to 30% by weight of pigment and filler, 0 to 80% by weight of water, 0 to 5% of an emulsifier, and 0 to 5% of a defoamer, wherein the total weight of epoxy, curing agent, pigment and filler, water, emulsifier, and defoamer does not exceed 100%.

In further embodiments, the tie coating formulation used comprises solids (exclusive of water) in about 34 to 76% by weight of at least one aliphatic epoxy resin, about 24 to 66% by weight of curing agent, 0 to 20% by weight of pigment and filler, 0 to 3% by weight of an emulsifier, and 0 to 3% by weight of a defoamer, wherein the total weight of epoxy, curing agent, pigment and filler, emulsifier, and defoamer does not exceed 100%.

In further embodiments, the tie coating formulation used comprises solids (exclusive of water) in about 34 to 76% by weight of at least one aliphatic epoxy resin, about 5 to 20% by weight of a high viscosity curing agent, about 10 to 25% by weight of a low viscosity curing agent, 0 to about 20% by weight of pigment and filler, 0 to about 3% by weight of an emulsifier, and 0 to 3% by weight of a defoamer, wherein the total weight of epoxy, curing agents, pigment and filler, emulsifier, and defoamer does not exceed 100%.

In some embodiments, the tie coating formulation comprises 20% to 85% by weight of aliphatic epoxy resin, 10% to 70% by weight of curing agent, 0 to 30% by weight of pigment and filler, 0 to 80% by weight of water, 0 to 5% of an emulsifier, and 0 to 5% of a defoamer, wherein the total weight of epoxy, curing agent, pigment and filler, water, emulsifier, and defoamer does not exceed 100%.

In further embodiments, the tie coating formulation comprises solids (exclusive of water) in about 34 to 76% by weight of at least one aliphatic epoxy resin, about 24 to 66% by weight of curing agent, 0 to 20% by weight of pigment and filler, 0 to 3% by weight of an emulsifier, and 0 to 3% by weight of a defoamer, wherein the total weight of epoxy, curing agent, pigment and filler, emulsifier, and defoamer does not exceed 100%.

In further embodiments, the tie coating formulation comprises solids (exclusive of water) in about 34 to 76% by weight of at least one aliphatic epoxy resin, about 5 to 20% by weight of a high viscosity curing agent, about 10 to 25% by weight of a low viscosity curing agent, 0 to about 20% by weight of pigment and filler, 0 to about 3% by weight of an emulsifier, and 0 to 3% by weight of a defoamer, wherein the total weight of epoxy, curing agents, pigment and filler, emulsifier, and defoamer does not exceed 100%.

The aliphatic epoxy resin particle size in the emulsion can be reduced during a high shear mixing process to the desired particle size. In some embodiments, the aliphatic epoxy resin particle size in the emulsion can be reduced to about 0.01 to 50 microns. In further embodiments, the aliphatic epoxy resin average particle size can be reduced to about 50 microns, about 25 microns, about 10 microns, about 5 microns, about 1 micron, about 0.5 microns, about 0.4 microns, about 0.3 microns, about 0.2 microns, about 0.1 microns, or a range of sizes therebetween.

The epoxy resin can be a liquid, a semi-solid or a solid at ambient temperature. in certain embodiments, the epoxy resin is liquid or is melted into a liquid upon heat curing of the substrate, with curing temperatures up to about 200 F. In certain embodiments, the viscosity of liquid epoxy resin can be less than about 50,000 cP, less than about 25,000 cP, less than about 10,000 cP, less than about 5,000 cP, less than about 500 cP, less than about 100 cP, or values therebetween.

The epoxy resin can have an average molecular weight of about 50,000 g/mol, 40,000 g/mol, about 20,000 g/mol, about 10,000 g/mol, about 5,000 g/mol, about 3,000 g/mol, about 2,000 g/mol, below about 1,000 g/mol, about 500 g/mol, about 300 g/mol, about 100 g/mol, or a range of values therebetween. The epoxy resin may further be characterized by an equivalent weight per epoxide (EEW). The EEW is generally measured in grams of resin per molar equivalent of epoxide (g/eq).

In some embodiments, the epoxy resin can include various chemical constituents, for example, one or more of an aromatic epoxy, a BPA epoxy, a non-BPA aromatic epoxy, a hydrogenated bisphenol A epoxy, an aliphatic epoxy, a cyclic aliphatic epoxy, an oligomeric aliphatic epoxy, a polymeric aliphatic epoxy, an oligomeric aromatic epoxy, a polymeric aromatic epoxy, or a combination thereof. The epoxy resin can further include one or more functional groups, for example, a glycidol ether, a diglycidyl, a cycloalkyl, a cyclohexyl, a phenyl glycidyl ether, or a combination thereof. In further embodiments, the epoxy resin can include a hydrogenated diglycidyl ether of bisphenol A.

The epoxy resin can comprise a monomer and/or oligomer, or a monomer residue and/or oligomer residue, that includes one or more chemical constituents and/or groups described herein. The monomer residue or oligomer residue may arise from reaction of a monomer molecule with one or more of a curing agent, an additive, a cementitious substrate, or another monomer molecule. The monomer residue or oligomer residue may be a repeating unit arising from reaction of a monomer with a curing agent, with another monomer molecule, or with a functional group on the substrate. An epoxy resin monomer or monomer residue or oligomer or oligomer residue can include one or more cyclic aliphatic group, such as, for example, a cyclohexyl group. Generally, an aliphatic epoxy resin includes aliphatic monomers or oligomers. In various embodiments, the monomer or monomer residue can include zero, one or two cyclic aliphatic groups or a quaternary carbon center, or a combination of zero, one, or two cyclic aliphatic functional groups along with a quaternary carbon center. In further embodiments, the monomer or monomer residue can comprise an acyclic aliphatic functional group. A low viscosity epoxy component (generally, one having <100 cP viscosity at 25° C.) can in some instances be classified as a diluent.

The tie coating formulation may include an epoxy resin having a monomer including a cycloalkyl group. The tie coating formulation may also include a first curing agent comprising an oxyalkylene for providing wettability to the composition, and a second curing agent comprising a polyamine. The second curing agent may have a higher viscosity than the first curing agent. The first curing agent may have amine hydrogen functional groups in about 0.25 to about 2 equivalents, and the second curing agent may have amine hydrogen functional groups in about 0.05 to about 0.5 equivalents, relative to one equivalent of epoxide functional groups in the epoxy resin.

In additional implementations, the chemical structures of the epoxy resin, first curing agent, and second curing agent may be further defined. In some embodiments, the monomer of the epoxy resin includes a quaternary carbon center. In some embodiments, the epoxy resin may include a monomer having the structure shown in paragraph [0140], and may be a hydrogenated bisphenol A. In some embodiments, the first curing agent may comprise primary amines and/or a branched oxyalkylene, and may comprise compounds having the formula shown in paragraph [0140], and may have a viscosity of about 100 to 1,000 cP, e.g., as determined by Brookfield viscometery.

In further embodiments, the second curing agent may comprise a polyamine of ammoniated oxirane.

In some embodiments, the tie coating formulation includes an emulsion comprising an aliphatic epoxy resin, wherein the aliphatic epoxy resin comprises a monomer including a cycloalkyl group. The emulsion has an emulsion particle size of about 0.1 to about 50 microns. The tie coating formulation further includes a first amine curing agent comprising an oxyalkylene for providing wettability to the composition, and a second amine curing agent comprising a polyamine for stabilizing the emulsion. The second amine curing agent has a higher viscosity than the first amine curing agent. The first amine curing agent has amine hydrogen functional groups in about 0.25 to about 2 equivalents, and the second amine curing agent has amine hydrogen functional groups in about 0.05 to about 0.5 equivalents, relative to one equivalent of epoxide functional groups in the aliphatic epoxy resin.

The emulsion may have a particle size of about 0.1 to about 50 microns. In further embodiments, the average emulsion particle size can be about 50 microns, about 25 microns, about 10 microns, about 5 microns, about 2 microns, about 1 micron, about 0.5 microns, about 0.1 micron, or a range of values therebetween.

In certain embodiments, the tie coating formulation further includes a first curing agent and a second curing agent, with each curing agent having amine hydrogen functional groups.

The second curing agent may have a viscosity of 25,000 to 50,000 cP, and may comprise a polyamine of ammoniated oxirane. The ratio of amine hydrogen functional groups in the first curing agent may be about 0.25 to about 2 equivalents relative to one equivalent of epoxide functional groups in the aliphatic epoxy resin, while the ratio of amine hydrogen functional groups in the second curing agent may be about 0.05 to about 0.5 equivalents relative to one equivalent of epoxide functional groups in the aliphatic epoxy resin.

In additional implementations, the tie coating formulation includes water up to a predetermined solid content, which may be 10 to 30% total solids. In some embodiments, the tie coating formulation further comprises an emulsifier, a defoamer, and/or a pigment such as titanium dioxide.

In certain embodiments, the tie coating formulation comprises a waterborne emulsion of an aliphatic epoxy resin, and at least one curing agent with reactive curing functional groups. The aliphatic epoxy resin includes an epoxide functional group, which interacts with the reactive curing functional groups to form a film. Additionally, the epoxide functional groups and/or the reactive curing functional groups may interact with each other and with functional groups in a cementitious substrate to create a film that resists ingress of water to the underlying substrate. In one embodiment, the tie coating formulation may include a ratio of about 1 equivalent of total epoxide functional groups to 0.1 to 4 total equivalents of reactive curing functional groups. The aliphatic epoxy resin can be characterized by an equivalent mass per epoxide functional group, while the curing agent can be characterized by an equivalent mass per reactive hydrogen. For example, when the curing agent includes one or more amines, the curing agent can be characterized by an equivalent mass per amine hydrogen. In some embodiments, the tie coating formulations can have a ratio of about 1 equivalent of total epoxide groups to 0.1 to 4 total equivalents of reactive curing functional groups such as an amine hydrogen; or about 1 equivalent of total epoxide groups to 0.2 to 2 total equivalents of reactive curing functional groups, or about 1 equivalent of total epoxide groups to 1 to 1.8 total equivalents of reactive curing functional groups.

As noted above, the tie coating formulation may include two different curing agents, in certain embodiments, both of which can be amine curing agents. The two curing agents may perform complementary functions. The first curing agent may be of low viscosity to provide wettability to the tie coating formulation, and the second curing agent may aid in stabilizing the emulsion. The first curing agent may have a viscosity of less than about 1000 cP, for example, about 100 to about 1,000 cP. The equivalent ratios of reactive functional groups in the two curing agents may provide functional characteristics to the tie coating formulation. In some embodiments, the tie coating formulation may include reactive functional groups of the first curing agent in about 0.25 to about 2 equivalents, and reactive functional groups of the second curing agent in about 0.05 to about 0.5 equivalents, relative to one equivalent of epoxide groups in the aliphatic epoxy resin.

In certain embodiments, the tie coating formulation can further comprise one or more additives. The additives can include a solvent, one or more pigments, a defoamer, fillers, an emulsifier, or a combination thereof. The composition also generally comprises water. Each component of the tie coating formulation may be suspended, dispersed, emulsified or form a colloid in the water. In some embodiments, the tie coating formulation includes water to provide a selected solid content. In further embodiments, water is added such that the total solid content of the tie coating formulation is about 5-100%, about 5-90%, about 5-70%, about 5-50%, about 10-40%, about 15-55%, about 20-50%, about 15-40%, about 10-30%, about 20-40%, or a value in a range defined by any of these values.

In some embodiments, the tie coating formulation comprises 20% to 85% by weight of aliphatic epoxy resin, 10% to 70% by weight of curing agent, 0 to 30% by weight of pigment and filler, 0 to 80% by weight of water, 0 to 5% of an emulsifier, and 0 to 5% of a defoamer, wherein the total weight of epoxy, curing agent, pigment and filler, water, emulsifier, and defoamer does not exceed 100%.

In further embodiments, the tie coating formulation comprises solids (exclusive of water) in about 34 to 76% by weight of at least one aliphatic epoxy resin, about 24 to 66% by weight of curing agent, 0 to 20% by weight of pigment and filler, 0 to 3% by weight of an emulsifier, and 0 to 3% by weight of a defoamer, wherein the total weight of epoxy, curing agent, pigment and filler, emulsifier, and defoamer does not exceed 100%.

In further embodiments, the tie coating formulation comprises solids (exclusive of water) in about 34 to 76% by weight of at least one aliphatic epoxy resin, about 5 to 20% by weight of a high viscosity curing agent, about 10 to 25% by weight of a low viscosity curing agent, 0 to about 20% by weight of pigment and filler, 0 to about 3% by weight of an emulsifier, and 0 to 3% by weight of a defoamer, wherein the total weight of epoxy, curing agents, pigment and filler, emulsifier, and defoamer does not exceed 100%.

The epoxy resins used in the tie coating formulation of various embodiments can be 100% solid, water-based resin, and solvent based resin. The chemistry of the resins can include aromatic epoxy or aliphatic epoxy with 100% solid, water based aromatic epoxy or aliphatic epoxy, UV cure epoxy, and their combinations. In some embodiments, the epoxy resin can include one or more of bisphenol A, bisphenol F, epoxy phenol novolac, epoxy cresol novolac, naphthalene epoxy, or tertiary butyl catechol epoxy, and cycloaliphatic epoxies. In some embodiments, the epoxy resin can be a solid epoxy resin, a liquid epoxy resin, or a combination thereof. The epoxy resin may be an aliphatic epoxy resin including saturated functional groups. In some embodiments, the epoxy resin can comprise a two-component waterborne epoxy. Two component waterborne epoxy systems generally include an epoxy resin as one component and a curing agent, or hardener, as a second component. The epoxy resin can include a regular epoxy, waterborne resin dispersion, or water reducible epoxy resin. The regular epoxy can be emulsified by addition of a separate or discrete emulsifier. In further embodiments, the tie coating formulation can include only a single aliphatic epoxy resin.

In various embodiments, the epoxy resin(s) used in the tie coating formulation can be selected from those listed in Table 1 below:

TABLE 1
Resins

| | Viscosity | EEW | |
|---|---|---|---|
| Resin | (cP, 25 °C) | (g/eq) | Chemical constituent(s) |
| A | Unk | Unk | Aromatic and arylene epoxies |
| B | 5,000-10,000 | Unk | Non-BPA Aromatic epoxy; |
| | | | 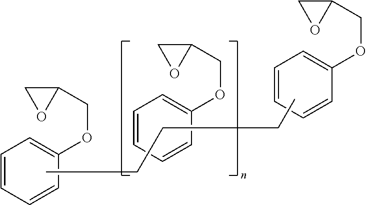 |
| C | 5,000-10,000 | 190-205 g/eq | Aromatic epoxy; |
| | | | 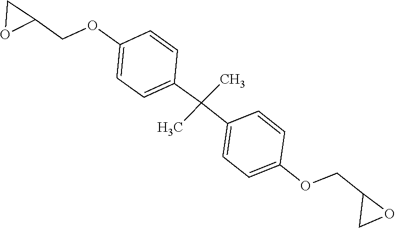 [SMILES: CC(C)(c1ccc(OCC2CO2)cc1)c1ccc(OCC2CO2)cc1] |
| D | 1,000-5,000 | 210-220 g/eq | Cyclic aliphatic epoxy; |
| | | | hydrogenated bisphenol A epoxy |
| | | | 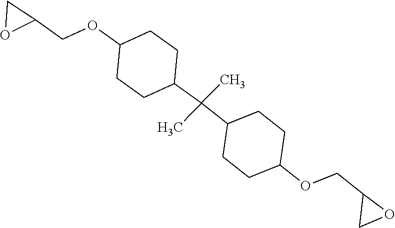 [SMILES: CC(C)(C1CCC(OCC2CO2)CC1)C1CCC(OCC2CO2)CC1] |
| E | <100 | 155-165 g/eq | Cyclic aliphatic epoxy; |
| | | | 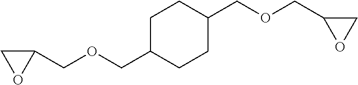 [SMILES: C1CC(COCC2CO2)CCC1COCC1CO1] |
| F | 100-500 | 135-155 g/eq | Aliphatic epoxy |
| G | 10,000-25,000 | 185-200 g/eq | Oligomeric aromatic epoxy; |
| | | | polymeric aromatic epoxy |
| H | <100 | 130-145 g/eq | Branched chain aliphatic epoxy; |
| | | | 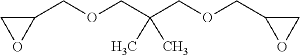 |
| I | <100 | 125-135 g/eq | Straight chain aliphatic epoxy; |
| | | | 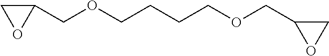 [SMILES: C(CCOCC1CO1)COCC1CO1] |
| J | <100 | 115-125 g/eq | Straight chain aliphatic epoxy; |
| | | | 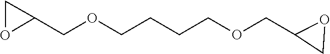 [SMILES: C(CCOCC1CO1)COCC1CO1] |
| K | <100 | 125-145 g/eq | Branched chain aliphatic epoxy; |
| | | | neopentyl alcohol diglycidyl ether |

In certain embodiments, the epoxy resin can be free of aromatic functional groups.

As explained earlier, the tie coating formulation may be substantially free of polymer binder resin components that are too large to fill the voids/space in the ink layer and to access the surface supporting the surface decoration ink layer.

### Curing Agents Used in Tie Coating Formulation

The tie coating formulation described herein may comprise at least one curing agent selected to promote adhesion and cross-linking of the epoxy resin. The curing agent includes at least one reactive functional group. The curing agent may include an acid such as novolacs, dibasic carboxylic acids, carboxyl phthalocyanines, and dimer and trimer fatty acids; anhydrides of aliphatic and aromatic polycarboxylic acids; acrylics, such as polyacrylates, polymethacrylates, styrene acrylate and polyacrylamides; and amides and miscellaneous nitrogen compounds, such as dicyandiamide, hydrazides, amidoamines and polyamides. The at least one curing agent may include an amine hydrogen functional group, and may be, for example, an amine curing agent. In some embodiments, the curing agent can include as a functional group a primary amine, a secondary amine, a tertiary amine, a quaternary ammonium, or a combination thereof. The curing agent can be an aliphatic amine, an aromatic amine, or a combination thereof. The curing agent may be a polyetheramine, which may be a branched polyetheramine. The curing agent can include one or more of a polyoxyalkylene polyamine, an arylene polyamine, an aliphatic oligoamine, an aliphatic polyamine, a cyclo-aliphatic amine, a cyclo-aliphatic polyamine, an aliphatic oxyalkylene amine, for example, oxypropylene, an aromatic tertiary amine, an aromatic polyamine a Mannich base, or a combination thereof. The aliphatic amine may be, for example, a branched aliphatic amine, a branched aliphatic oxyalkylene amine. The aliphatic amine can include a cyclic aliphatic functional group, such as, for example, a cyclohexyl functional group. The curing agent may include a branched aliphatic oxyalkylene amine including a primary amine. In some embodiments, the curing agent can comprise trimethylolpropane poly(oxypropylene)triamine.

In further embodiments, the curing agent can comprise a polyamine, such as, for example, a water-soluble polyamine. In some embodiments, the water-soluble polyamine can act to stabilize an emulsion of an aliphatic epoxy resin in a formulation. The polyamine can be derived from reaction of an electrophilic moiety, such as formaldehyde, nitriles, or epoxides such as epichlorohydrin, with an amine, such as ammonia or an alkylamine. The polyamine may include a solubilizing unit, for example, an oligo- or poly-oxyalkylene unit. The polyamine may comprise ammoniated oxirane. The ammoniated oxirane may be, for example, an N-benzyl derivative of reaction products of oxirane with ammonia.

The curing agent can advantageously be characterized by a low viscosity value. In some embodiments, the curing agent can have a selected viscosity value, or range of values. In certain embodiments, the curing agent can have an absolute viscosity of, or less than, about 50,000 cP, about 25,000 cP, about 10,000 cP, about 5,000 cP, about 1,000 cP, about 500 cP, or a range of values therebetween. Absolute viscosity is generally measured by a prepared curing agent, for example, a commercial curing agent as it is provided (for example, including any solvent or water), and at a temperature of about 25° C. In certain embodiments, the tie coating formulation including at least one water soluble curing agent has a low viscosity. The curing agent may be selected for adhesion to a cementitious substrate.

In some embodiments of the tie coating formulation that include a plurality of curing agents, it may be advantageous to include a low viscosity curing agent and a high viscosity curing agent. The ratios of low viscosity curing agent and high viscosity curing agent may aid in providing a tie coating formulation with adhesion and wettability of a machined substrate while maintaining film strength. Advantageously, a curing agent will aid emulsification of the aliphatic epoxy resin. In some embodiments, the tie coating formulation can include at least one curing agent having an absolute viscosity of about 5,000-10,000 cP, about 1,000-5,000 cP, about 100-1,000 cP, less than about 1000 cP, or less than about 500 cP, and at least one curing agent having an absolute viscosity of about 100-1,000 cP, about 1,000-5,000 cP, about 5,000-10,000 cP, about 10,000-25,000 cP, about 25,000-50,000 cP, or a value in a range defined by any of these values.

In various embodiments, the tie coating formulation provided herein can include a ratio of about 1 equivalent of total epoxide groups to 0.1 to 2 equivalents of amine hydrogens in the low viscosity curing agent, about 1 equivalent of total epoxide groups to 0.2 to 1.5 equivalents of amine hydrogens in the low viscosity curing agent, about 1 equivalent of total epoxide groups to 0.25 to 2 equivalents of amine hydrogens in the low viscosity curing agent, or about 1 equivalent of total epoxide groups to 0.5 to 1.5 equivalents of amine hydrogens in the low viscosity curing agent. In further embodiments, tie coating formulations provided herein can include a ratio of about 1 equivalent of total epoxide groups to 0.05 to 0.5 equivalents of amine hydrogens in the high viscosity curing agent, or about 1 equivalent of total epoxide groups to 0.1 to 0.3 equivalents of amine hydrogens in the high viscosity curing agent. In some embodiments, the tie coating formulation can include specified amounts of both a low viscosity curing agent and a high viscosity curing agent. Thus, the ratio of equivalents of amine hydrogens between two or more curing agents in a tie coating formulation according to various embodiments of the present disclosure can advantageously be selected. In some embodiments, the ratio of amine hydrogen equivalents in the first curing agent to the amine hydrogen equivalents in the second curing agent is about 1 equivalent of amine hydrogens in the high viscosity curing agent to 1 to 11 equivalents of amine hydrogens in the low viscosity curing agent, or about 1 equivalent of amine hydrogens in the high viscosity curing agent to 3 to 8 equivalents of amine hydrogens in the low viscosity curing agent.

The curing agent in the tie coating formulation can be characterized by an amine value. In some embodiments, the curing agent can have an amine value of about 10-500 mg KOH/g, about 50-300 mg KOH/g, or about 150-200 mg KOH/g. Alternatively, or in addition, the curing agent can be characterized by an amine hydrogen equivalent weight (AHEW), generally having the units of grams of curing agent per molar equivalent of amine hydrogen (g/eq). In various embodiments, the curing agent can have an AHEW of 50 to 500 AHEW, about 50 to about 300, about 75 to about 300, about 75 to about 100, or about 200 to about 300. The tie coating formulation provided herein may comprise one or more curing agents having selected amine values and/or AHEW.

In various embodiments, a curing agent, or total curing agents, can be present in the tie coating formulation in about 5% to 70% by weight, about 10% to 60% by weight, or about 10% to 30% of the total solids in the composition.

In various embodiments, the curing agent(s) used in the tie coating formulation can be selected from those listed in Table 2 below:

TABLE 2
Curing Agents

| Curing | Viscosity | Amine value/ | |
|---|---|---|---|
| Agent | (cP, 25 °C) | AHEW (g/eq) | Chemical constituent(s) |
| A | <1,000 | 155-175 mg KOH/g | Aromatic tertiaryl amines; |
| | | | 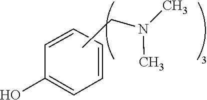 |
| B | 1,000-5,000 | Unk | Mannich base aliphatic amine |
| C | 25,000-50,000 | 200 AHEW | Oligomeric aliphatic amines; |
| | | | polyoxyalkylene polyamine; |
| | | | polymeric aliphatic amines, |
| | | | 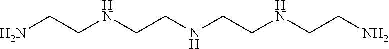 [SMILES: NCCNCCNCCNCCN] |
| D | 25,000-50,000 | 150-190 mg KOH/g; | Polyoxyalkylene polyamines; |
| | | 275 AHEW | N-benzyl derivatives of ammoniated oxirane |
| E | Unk | Unk | Aromatic and cyclic aliphatic amines; |
| | | | aliphatic polyamines; |
| | | | primary amines; |
| | | | 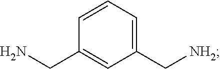 |
| | | | 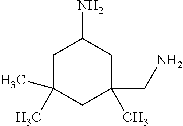 |
| F | 10,000-25,000 | 195-220 mg KOH/g | Aromatic and cyclic aliphatic amines; |
| | | | aliphatic polyamines; |
| | | | 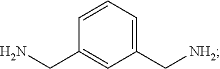 |
| | | | 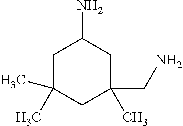 |
| G | Unk | Unk | Aromatic and cyclic aliphatic amines; |
| | | | aliphatic polyamines; |
| | | | primary amines; |
| | | | 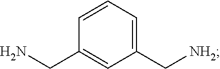 |
| | | | 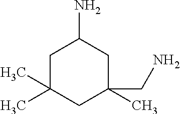 |
| H | 10,000-25,000 | 150-190 mg KOH/g; | Aromatic and aliphatic polyamines; |
| | | 300 AHEW | polymer of |
| | | | 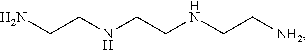 |
| | | | 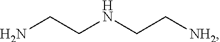 |
| | | | epichlorohydrin, ethylene oxide; primary amines |
| I | 1,000-5,000 | 165-195 mg KOH/g; | Polyamine adducts |
| | | 300 AHEW | |
| J | 100-1,000 | 80 AHEW | Branched aliphatic oxyalkylene amines; |
| | | | primary amines; |
| | | | 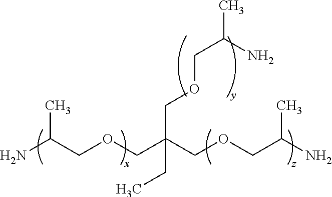 |
| | | | x + y + z = 5-6 |
| K | 10,000-25,000 | 190-230 AHEW | Aromatic polyepoxies; aliphatic oxyalkylene amines |

In certain further embodiments, the curing agent can be free of aromatic functional groups.

### Additives for Tie Coating Formulation

In some embodiments, an additive can be a diluent. A diluent can reduce the viscosity of the tie coating formulation without reducing the coating film strength. Advantageously, a diluent can include one or more reactive functional groups, such as, for example, an epoxide group. A diluent can be water soluble, and can include, for example, one or more ether functionalities. In some embodiments, the ethers can be aliphatic ethers, for example, a glycol ether, an ether of propane diol, an ether of butane diol, or a glycerol ether. In further embodiments, a diluent can include one or more glycidyl ethers.

In certain embodiments, the diluent can have an absolute viscosity of about 1,000-5,000 cP, about 500-1,000 cP, about 100-500 cP, or less than about 100 cP, e.g., as determined by Brookfield viscometry.

In some embodiments, the tie coating formulation can comprise an emulsifier. The emulsifier can be present in a tie coating formulation in 0 to 20% by weight relative to the epoxy resin. In further embodiments, the emulsifier can be 0 to 3% by weight, or 0 to 1% by weight of the tie coating formulation. The emulsifier can be, for example, a cationic surfactant, an anionic surfactant, a zwitterionic surfactant, or a non-ionic surfactant. The emulsifier can be one or more of a copolymer of polyoxyethylene and polyoxypropylene, polyoxyethylene, polyoctylphenyl ether, and sodium dodecylbenzenesulfide. The copolymer can be a block or a graft copolymer. The emulsifier can further include a styrenated phenol, a distyrenated phenol, a tristyrenated phenol, a trystyryl ethoxylate, or an oleyl alcohol. In further embodiments, the emulsifier can comprise a polyoxyethylene (POE) and/or disaturated phospholipid (DSP). In further embodiments, the emulsifier can be free of aromatic functional groups.

The tie coating formulation can be diluted with a solvent and/or water. In certain implementations, an amount of solvent and/or water is added to provide a tie coating formulation with a selected solid content. The solid content of a tie coating formulation can be about 5-100%, about 5-90%, about 5-70%, about 5-50%, about 10-40%, about 20-50%, about 15-40%, about 10-30%, about 20-40%, or a value in a range defined by any of these values.

In some embodiments, the tie coating formulation provided herein includes a filler and/or a pigment. The filler and/or pigment can include typical fillers and pigments, such as, for example, titanium dioxide, inorganic pigments such as iron oxides, organic pigments, clays, talc, calcium silicate, and silica.

In some embodiments, the tie coating formulation can be free from particulates. In further embodiments, the tie coating formulation can be free from inorganic particulates. The tie coating formulation can be applied to a substrate to form a coated substrate. The tie coating formulations may be compounded using manufacturing methods such as dispersion, grinding, mixing, stirring, shaking, agitating, inverting, by any other suitable method, or by a combination of methods. The mixed tie coating formulation may be applied to a substrate using methods such as flood coating, spraying, rolling or wiping. In some embodiments, a single coat of the tie coating formulation is applied. In further embodiments, only a single coat is needed to achieve an advantage stated herein. Following application to a substrate, the tie coating formulation can be cured by heating or other methods. The coated, cured substrate can have a dry film thickness (DFT) of about 0.05 to 5 mils, for example, about 0.1 to 3 mil, about 0.2 to 2 mil, about 0.3 to 1.5 mil, about 0.5 to 1.5 mil, about 0.5 to 1 mil, or a value in a range defined by any of these values. A coated substrate can, in turn, be coated with suitable additional coatings, for example, a top coat such as a clear topcoating.

A number of sample tie coating formulations were formulated, as indicated in the table below. Each formulation was diluted with water to provide a tie coating formulation having the indicated % weight of total combined solids (“Total Solids”).

TABLE 3
Exemplary Tie Coat Formulations based on WP coating systems

| | | | Amine 1 (amine | Amine 2 (amine | |
|---|---|---|---|---|---|
| | Total Solids | Epoxy | hydrogen equiv. or | hydrogen equiv. or | Other (equiv. or % |
| No. | (wt %) | (equiv. or wt %) | wt %) | wt %) | weight) |
| 1 | 20% | Typical epoxy | Curing Agent A, 2.0 | None | phosphate, 50% wt |
| | | 50% wt | wt % | | |
| 2 | 40% | Resin I, 1 equiv | Curing Agent K, 1 | None | None |
| | | | equiv | | |
| 3 | 40% | Resin I, 1 equiv | Curing Agent K, 2 | None | None |
| | | | equivs | | |
| 4 | 25% | Resin H, 1 equiv | Curing Agent K, 1 | None | None |
| | | | equiv | | |
| 5 | 40% | Resin H, 1 equiv | Curing Agent K, 1 | None | None |
| | | | equiv | | |
| 6 | 40% | Resin I, 1 equiv | Curing Agent I, 0.5 | None | Typical epoxy, 0.035 |
| | | | equivs | | equivs |
| 7 | 40% | Resin I, 1 equiv | Curing Agent I, 1 equiv | None | None |
| 8 | 25% | Resin C, 1 equiv | Curing Agent I, 0.5 | None | None |
| | | | equivs | | |
| 9 | 40% | Resin C, 1 equiv | Curing Agent I, 0.5 | None | None |
| | | | equivs | | |
| 10 | 40% | Resin H, 1 equiv | Curing Agent I, 1 equiv | None | None |
| 11 | 40% | Resin I, 1 equiv | Curing Agent H, 1 | None | None |
| | | | equiv | | |
| 12 | 40% | Resin H, 1 equiv | Curing Agent H, 1 | None | None |
| | | | equiv | | |
| 13 | 30% | Resin H, 1 equiv | Curing Agent H, 1 | None | None |
| | | | equiv | | |
| 14 | 40% | Resin I, 1 equiv | Curing Agent I, 1.5 | None | None |
| | | | equivs | | |
| 15 | 40% | Resin I, 1 equiv | Curing Agent H, 1.5 | None | None |
| | | | equivs | | |
| 16 | 30% | Resin I, 1 equiv | Curing Agent H, 1.5 | None | None |
| | | | equivs | | |
| 17 | 50% | Resin C, 1 equiv | Curing Agent J, 1 equiv | None | None |
| 18 | 35% | Resin C, 1 equiv | Curing Agent J, 1 equiv | None | None |
| 19 | 40% | Resin H, 1 equiv | Curing Agent K, 1 | None | phosphate, 10% wt |
| | | | equiv | | |
| 20 | 30% | Resin H, 1 equiv | Curing Agent K, 1 | None | phosphate, 10% wt |
| | | | equiv | | |
| 21 | 40% | Resin H, 1 equiv | Curing Agent K, 1 | None | phosphate, 25% wt |
| | | | equiv | | |
| 22 | 50% | Resin H, 1 equiv | Curing Agent K, 0.75 | Curing Agent J, 0.25 | None |
| | | | equivs | equivs | |
| 23 | 50% | Resin C, 1 equiv | Curing Agent D, 0.2 | Curing Agent J, 0.8 | None |
| | | | equivs | equivs | |
| 24 | 35% | Resin C, 1 equiv | Curing Agent D, 0.2 | Curing Agent J, 0.8 | None |
| | | | equivs | equivs | |
| 25 | 50% | Resin C, 1 equiv | Curing Agent C, 0.2 | Curing Agent J, 0.8 | None |
| | | | equivs | equivs | |
| 26 | 35% | Resin C, 1 equiv | Curing Agent C, 0.2 | Curing Agent J, 0.8 | None |
| | | | equivs | equivs | |
| 27 | 50% | Resin D, 1 equiv | Curing Agent D, 0.25 | Curing Agent J, 0.75 | None |
| | | | equivs | equivs | |
| 28 | 40% | Resin D, 1 equiv | Curing Agent D, 0.25 | Curing Agent J, 1.25 | None |
| | | | equivs | equivs | |
| 29 | 40% | Resin D, 1 equiv | Curing Agent D, 0.25 | Curing Agent J, 1.0 | None |
| | | | equivs | equivs | |
| 30 | 40% | Resin D, 1 equiv | Curing Agent D, 0.25 | Curing Agent J, 0.75 | None |
| | | | equivs | equivs | |
| 31 | 40% | Resin D, 1 equiv | Curing Agent D, 0.25 | Curing Agent J, 0.6 | None |
| | | | equivs | equivs | |
| 32 | 40% | Resin D, 1 equiv | Curing Agent D, 0.25 | Curing Agent J, 1 | None |
| | | | equivs | equiv | |
| 33 | 40% | Resin D, 1 equiv | Curing Agent B, 0.25 | Curing Agent J, 1 | None |
| | | | equivs | equiv | |
| 34 | 50% | Resin D, 1 equiv | Curing Agent C, 0.25 | Curing Agent J, 1 | None |
| | | | equivs | equiv | |
| 35 | 40% | Resin D, 1 equiv | Curing Agent C, 0.15 | Curing Agent J, 0.95 | Curing Agent D, 0.15 |
| | | | equivs | equivs | equivs |
| 36 | 40% | Resin D, 1 equiv | Curing Agent K, 0.15 | Curing Agent J, 1.1 | None |
| | | | equivs | equivs | |
| 37 | 40% | Resin D, 1 equiv | Curing Agent C, 0.1 | Curing Agent J, 0.95 | emulsifier, 6% wt |
| | | | equivs | equivs | |
| 38 | 40% | Resin D, 1 equiv | Curing Agent C, 0.2 | Curing Agent J, 0.85 | emulsifier, 6% wt |
| | | | equivs | equivs | |
| 39 | 40% | Resin D, 1 equiv | Curing Agent C, 0.1 | Curing Agent J, 0.95 | emulsifier, 6% wt |
| | | | equivs | equivs | |
| 40 | 35% | Resin D, 1 equiv | Curing Agent D, 0.25 | Curing Agent J, 0.95 | emulsifier, 5% wt |
| | | | equivs | equivs | |
| 41 | 35% | Resin D, 1 equiv | Curing Agent D, 0.25 | Curing Agent J, 0.95 | emulsifier, 3% wt |
| | | | equivs | equivs | |
| 42 | 35% | Resin D, 1 equiv | Curing Agent D, 0.25 | Curing Agent J, 0.95 | emulsifier, 1% wt |
| | | | equivs | equivs | |
| 43 | 35% | Resin D, 1 equiv | Curing Agent D, 0.25 | Curing Agent J, 0.5 | emulsifier, 5% wt |
| | | | equivs | equivs | |
| 44 | 35% | Resin D, 1 equiv | Curing Agent D, 0.25 | Curing Agent J, 0.5 | emulsifier, 3% wt |
| | | | equivs | equivs | |
| 45 | 29% | Resin D, 1 equiv | Curing Agent D, 0.25 | Curing Agent J, 0.95 | emulsifier, 3% wt |
| | | | equivs | equivs | |
| 46 | 29% | Resin D, 1 equiv | Curing Agent D, 0.25 | Curing Agent J, 0.95 | emulsifier, 3% wt |
| | | | equivs | equivs | |
| 47 | 29% | Resin D, 1 equiv | Curing Agent D, 0.2 | Curing Agent J, 1 | None |
| | | | equivs | equiv | |
| 48 | 29% | Resin D, 1 equiv | Curing Agent D, 0.2 | Curing Agent J, 1 | emulsifier, 3% wt |
| | | | equivs | equiv | |
| 49 | 29% | Resin D, 1 equiv | Curing Agent D, 0.15 | Curing Agent J, 1.05 | None |
| | | | equivs | equivs | |
| 50 | 29% | Resin D, 1 equiv | Curing Agent D, 0.15 | Curing Agent J, 1.05 | emulsifier, 3% wt |
| | | | equivs | equivs | |
| 51 | 29% | Resin D, 1 equiv | Curing Agent D, 0.1 | Curing Agent J, 1.1 | None |
| | | | equivs | equivs | |
| 52 | 29% | Resin D, 1 equiv | Curing Agent C, 0.2 | Curing Agent J, 1 | emulsifier, 3% wt |
| | | | equivs | equiv | |
| 53 | 29% | Resin D, 1 equiv | Curing Agent C, 0.2 | Curing Agent J, 0.9 | emulsifier, 3% wt |
| | | | equivs | equivs | |
| 54 | 35% | Resin D, 1 equiv | Curing Agent D, 0.15 | Curing Agent J, 1.05 | emulsifier, 1% wt |
| | | | equivs | equivs | |
| 55 | 35% | Resin D, 1 equiv | Curing Agent D, 0.15 | Curing Agent J, 0.9 | emulsifier, 1% wt |
| | | | equivs | equivs | |
| 56 | 35% | Resin D, 1 equiv | Curing Agent C, 0.25 | Curing Agent J, 0.95 | emulsifier, 1% wt |
| | | | equivs | equivs | |
| 57 | 30% | Resin D, 1 equiv | Curing Agent D, 0.18 | Curing Agent J, 1.15 | defoamer, 0.03% wt; |
| | | | equivs | equivs | emulsifier, 1% wt; |
| | | | | | pigment, 5.5% wt |

In certain embodiments, the tie coat formulations based on WP coating systems for use herein include formulations 23 to 26 from the above table. The WP5 example tested herein is a derivative of these tie coating formulations.

Where an emulsifier appears, the wt % given is relative to the weight of epoxy resin.

### Clear Topcoating

As explained above, the crosslinked ink embedded-polymer matrix may serve as a tie between the surface bearing the surface decorated ink layer, the surface bearing the ink layer, and the optional clear topcoating when present. The clear topcoating provides a chemical barrier to damage from UV radiation in sunlight and so on. Top coating compositions may be waterborne, solvent borne or radiation curable (100% non-volatiles). In some embodiments, a radiation curable composition is UV curable and is used at an application rate of 10 gsm to 25 gsm. Such clear topcoating compositions, as with all other radiation versions of the curable compositions mentioned above, are based on a mix of, e.g., acrylic monomers, oligomers, acrylic co-polymer resins such as epoxy acrylates, or on acrylate esters such as diol acrylates. In certain embodiments, a radiation curable top coating composition may be fully cured by exposing the layer to UV radiation at a dose rate of 200 mJ/sq. cm.

In some embodiments of this disclosure, the method and product of the present disclosure comprises application of a clear topcoating composition over the cured crosslinked ink embedded-polymer matrix which serves as a tie between the surface bearing the surface decorated ink layer, the ink layer and the clear topcoating. The clear topcoating may be a waterborne coating such as an acrylic latex resin emulsion composition or alternatively can be a clear UV curable topcoating to impart further longevity and weather durability to the surface decoration and indeed the product itself.

### Waterborne Curable Clear Topcoating

In some embodiments, where a clear topcoating is used to protect the cured crosslinked ink embedded-polymer matrix, the clear topcoating generally does not impact the color(s) and quality of the surface decoration.

The waterborne curable clear topcoating resin emulsion composition is not particularly limited as long as it is a waterborne topcoating curable resin formulation comprising a waterborne binder resin comprising a binding polymer or mixture of binder polymers capable of coalescence on removal of water to form a durable clear film that is resistant to weathering conditions, e.g., outdoor use where exposure to UV, and water from rain or freeze-thaw conditions occurs. Suitable binder polymers of the waterborne curable resin emulsion composition may include polydisperse copolymers formed from acrylic, styrene acrylic, fluoropolymer acrylic, urethane acrylic, vinyl acrylic and an acrylated ethylene vinyl acetate based copolymers. Typically, the copolymers of the binding polymer are derived from one or more monomers, examples of which include polyvinylidine fluoride, styrene, alpha-methyl styrene, vinyl chloride, acrylonitrile, methacrylonitrile, ureido methacrylate, vinyl acetate, vinyl esters of branched tertiary monocarboxylic acids, itaconic acid, crotonic acid, maleic acid, fumaric acid, ethylene, and C₄-C₈ conjugated dienes. In certain embodiments, the waterborne curable clear topcoating resin emulsion is an acrylic latex polymer emulsion in water.

When the waterborne curable clear topcoating resin composition is initially applied, it may exist as an aqueous emulsion or an aqueous dispersion of discrete polymer spheres/particles containing multiple polymer chains that begin to pack as the bulk of the water evaporates. Continuing evaporation causes the particles to closely pack and deform; however, film coalescence may only be achieved when inter-particle diffusion of polymer chains occurs. In some embodiments, the waterborne curable clear topcoating resin composition used in this disclosure includes polymer latexes that can exist as both emulsions and dispersions and, while their mechanisms of film formation are similar, their physical characteristics are different. A polymer emulsion exists as stabilized liquid droplets in water and, as a result, has a glass transition temperature (Tg) below room temperature. Polymers with Tg values below application temperature can form fully closed films because the polymer molecules can diffuse between neighboring droplets. Even then, film formation and flow can benefit from small amounts of a coalescing agent—often also referred to as a coalescent. Polymer dispersions, on the other hand, have T_{g} values greater than room temperature and may need coalescing agents to film form unless curing at a temperature above the T_{g} of the polymer shell is possible. Higher coalescing agent levels may typically be used for polymer dispersions than are needed for polymer emulsions. More complex polymer systems such as gradient and core-shell polymer dispersions are common as well, and these polymer particles can vary in properties from surface to center. Since coalescence typically occurs at the particle surface, the coalescent may only need to soften the shell to achieve good film formation.

Desirably, the waterborne curable clear topcoating resin composition of this disclosure can being the form of an emulsion comprising polymer resin particles as described above. In certain embodiments, the curable clear topcoating composition of the disclosure can be a waterborne curable clear topcoating polymer resin emulsion comprising one or more latex polymers. Alternatively, the waterborne curable clear topcoating resin composition may comprise polymerizable monomer and/or oligomer resin particles which are emulsified or dispersed in an aqueous based carrier, e.g., water or a solution of water and a polar solvent. Where the waterborne curable clear topcoating resin emulsion composition comprises polymerizable monomer and/or oligomer resin particles, the binding polymer formed on curing the waterborne curable resin emulsion may be derived from at least one acrylic monomer present in the emulsion, such as acrylic acid, acrylic acid ester, methacrylic acid, and methacrylic acid ester. Thus, waterborne curable resin emulsion composition may comprise monomers and/or oligomers that comprises an acrylic acid, acrylic acid ester, methacrylic acid, and methacrylic acid ester functional groups.

In addition to the above, the curable clear topcoating resin composition may include one or more additives included for properties, such as regulating flow and leveling, sheen, foaming, yellowing, resistance to stains/cleaner/burnish/block/mildew/dirt/corrosion, and for retaining gloss. Optionally and in some embodiments, formulations herein include additives as coalescing agents, dispersants, anti-blistering agents, surfactants, rheology modifiers, defoamers, thickeners, biocides/anti-fungal/anti-mildew agents, colorants, waxes, perfumes and co-solvents.

The curable clear topcoating resin composition described herein may be applied to a surface of the substrate of interest using a brush, blade, roller, sprayer (e.g., air-assisted or airless, electrostatic), vacuum coater, curtain coater, flood coater or any suitable device that promotes an even distribution of the topcoating composition over the surface, even if the surface is damaged, worn, or cracked. The topcoating composition may be applied to provide a smooth surface or textured surface. A portion or an entire surface of the substrate may be coated at one time. In addition, or as an alternative, all or a portion of the surface may be coated more than one time to achieve the desired thickness, gloss, and/or surface effect. The amount of coverage obtained by a quantity of the topcoating composition will vary depending on the desire and/or condition of the surface to be covered and the thickness of the coating applied.

Typically, “curing” (e.g., coalescence) of the curable clear topcoating polymer resin emulsion composition may be thermally achieved by drying the sample coated with the composition by heating to a substrate surface temperature of about 160-180° F. (about 71° C. to 82° C.), e.g., on exiting a track convection oven. For embodiments using clear UV curable topcoatings, curing is accomplished by upon exposure to UV radiation through UV light exposure.

It should be noted that in the experiments described herein, the samples remain in the oven until the sample surface is at a temperature in the range of from 160° F. to 180° F. (about 71° C. to 82° C.) which corresponds to the temperature at which the resin emulsion, in this case, an 100% acrylic latex binder resin, RHOPLEX™ EI-6000 is known to be cured. It will be appreciated for other coating emulsion chemistries, the surface temperature signifying cure may vary. For any given sample, it can be observed that sufficient curing has occurred through the formation of a top skin film which is a substantially intact/continuous film and is indicative that sufficient flashing has occurred (a visual cue that film formation has completed).

### Suitable Surfaces for Surface Decoration

A suitable surface to be printed with the surface decoration may be a surface of a wide variety of materials such as, for example, paper, wood, concrete, metal, glass, gypsum, ceramic, plastic, plaster, and roofing substrates such as asphaltic coatings, roofing felts, foamed polyurethane insulation; or to previously painted, primed, undercoated, worn, or weathered substrates. In some embodiments, the surface may be a surface of a building material including composite materials such as cementitious materials, gypsum or other inorganic composite materials, for example, fiber cement composite materials, especially those design for exterior use. In certain embodiments, fiber cement building materials may be a porous material comprising one or more different materials such as a gypsum composite, cement composite, geopolymer composite or other composites having an inorganic binder.

The surface of the material may be sanded, machined, extruded, molded or otherwise formed into any desired shape by various processes known in the art. The fiber cement building materials may be fully cured, partially cured or in the uncured “green” state. Fiber cement building materials may further include gypsum board, fiber cement board, fiber cement board reinforced by a mesh or continuous fibers, gypsum board reinforced by short fibers, a mesh or continuous fibers, inorganic bonded wood and fiber composite materials, geopolymer bonded wood and fiber boards, concrete roofing tile material, and fiber-plastic composite material. In some embodiments, fibers include various forms of cellulose fibers, such as treated or untreated, bleached or unbleached Kraft pulp. In addition, other forms of fibers may be used. Suitable examples are those from ceramic, glass, mineral wool, steel, and synthetic polymers (e.g., polyamides, polyester, polypropylene, polymethylpentene, polyacrylonitrile, polyacrylamide, viscose, nylon, PVC, PVA, rayon, glass ceramic, carbon, or mixtures thereof).

The dry film thickness (DFT) of a clear topcoating provided over the crosslinked ink embedded-polymer matrix can range between about 0.01 mil upwards, and in some embodiment is about 0.1-0.3 mil, for example, about 0.2 mil.

The clear topcoating composition can be finished in gloss, satin or dull finishes, with or without tints. Suitable clear coating chemistries include acrylic, polyurethane, fluorinated polymer, polyethylene, polypropylene, polyester, nylon or other polymers and their combinations.

The clear topcoating composition can be applied on to the fiber cement product surface by printer or coater including flooding, spray, roller and others.

Commercially available clear topcoatings with varied chemistries were tested, including polyacrylic, polyurethane-acrylic, spar urethane, polyurethane, aliphatic polyurethane and fluorinated polymer chemistries.

In some embodiments, the clear topcoating composition may be formulated to block and/or to absorb UV and/or radicals formed under action of UV. Minimizing the effect of UV will reduce ink color fade on the article surface and thereby enhances color stability. For example, UV inhibitors and/or UV stabilizers can be included in the clear coating to prevent or at least reduce UV from reaching the ink and cause color instability and fade issues. In some embodiments, UV inhibitors are effective against short wave UV of 400 nm or below which is particularly responsible for polymer/resin degradation. Examples of UV inhibitors/stabilizes include ultraviolet light absorbers (ULAs) which block UV light, while examples of UV light stabilizers include hindered-amine light stabilizers (HALs) which trap free radicals to maintain surface properties such as gloss and prevent cracking and chalking of paints. In some embodiments, the clear coating described herein includes both ULAs and HALs, which are believed to act synergistically and offer simpler formulations/manufacturing steps. Ultraviolet Light Absorbers such as from the Tinuvin® range made by BASF are liquid UV absorbers of the hydroxyphenyl benzotriazole class specifically developed for industrial coating applications and are thought to block up to 90% of UV. Other Tinuvin® products made by BASF are liquid hindered amine light stabilizers especially developed for coatings.

### Coating Application

The coatings herein described (one or more of sealer, primer, paint, tie coating formulation and/or top coating composition) can be applied to the cementitious article using any of the known means such as gravure coating, calendering, rod coating, flexo coating, screen coating, spray coating, roll coating, reverse roll coating, gap coating, slot die coating, immersion coating, curtain coating, air knife coating, flood coating, lithography, inkjet printing or a combination thereof.

The embodiments will now be described more particularly with reference to the accompanying drawings.

FIG. 1A is a schematic cross-section of an inkjet printed surface decoration on a white colored paint coating (basecoat) as background for the inkjet printed surface decoration. The ink is disposed on the basecoat in the form of a plurality of cured ink droplets and cured ink domains having interstitial ink-free spaces that provide access to the basecoat surface bearing the surface decoration ink layer. The ink droplets are provided to the basecoat at an ink droplet density that results in interstitial ink-free spaces being located between the ink droplets and/or ink domains as shown by the arrows in the schematic. It will be understood that the ink droplets and/or ink domains density will be determined by the particular surface decoration of interest. For example, a wood grain effect is a good example of an image that uses an ink density that results in interstitial spaces that allow access to the underlying supporting surface bearing the ink layer. The interstitial spaces provide access and/or pathway for the monomers and/or oligomers of the tie formulation to bridge the ink decoration layer and to contact the surface of the underlying paint base coat. As explained herein, the monomers and/or oligomers are sized/formulated to fill these interstitial spaces and to contact the underlying surface so that on polymerization of the monomers and/or oligomers of the tie coating formulation, a crosslinked ink embedded-polymer matrix that covalently bonds to the surface bearing the surface decorated ink layer is formed that strongly adheres the ink layer to the underlying surface.

FIG. 1B is a microscope picture of an inkjet ink printed woodgrain image/surface decoration printed on a fiber cement ColorPlus® product in Artic White (‘AW’) color, where the white paint serves a useful background for the printed image.

FIG. 1B shows a magnified view of an inkjet printed wood grain surface decoration image provided on a fiber cement product (Hardie® Plank siding with ColorPlus® technology, in Artic White color “AW”). The image confirms that the inkjet printing process recreates a digital image of the wood grain on the ColorPlus® painted fiber cement substrate surface by propelling droplets of ink onto the painted surface. The image shows that process leaves spaces/ink free areas which are free of ink between the droplets, where it is apparent that the background white color from the basecoat of Arctic white ColorPlus® paint is visible.

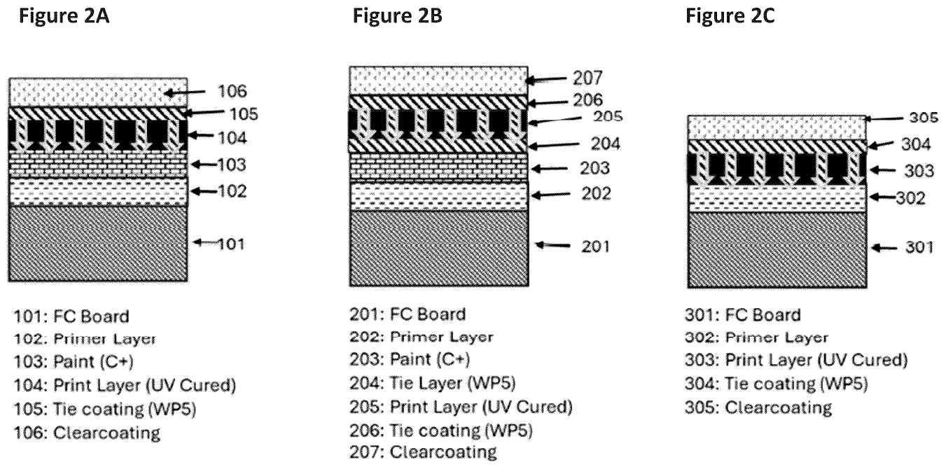

Turning now to FIGS. 2A to 2C, which show three schematic cross-sectional views of the digitally printed fiber cement product of the current disclosure. The fiber cement product (e.g., a Hardie® Plank siding with ColorPlus® technology. In Artic White color) is provided with a primer layer 102 disposed directly on the plank raw surface 101. On top of this primer layer is disposed a layer of paint (e.g., Artic white color) 103. The digital print surface decoration is applied on top of the paint layer 103. In some embodiments, a tie layer in accordance with the crosslinking function can be disposed below the digitally printed ink and, in some embodiments, it can be disposed on top of the digital print 102. On the top is a clear topcoat 101. FIGS. 2A to 2C illustrate cross-sectional views of three embodiments of the present technology (a) to (c) involving a digitally printed fiber cement product of the current disclosure wherein the ink layer protected by embedding it in a tie coat comprising a crosslinked ink embedded-polymer matrix form. FIG. 2A is a first embodiment where a fiber cement board is coated with a primer layer 102, over which is coated a paint layer (e.g., in Artic White) 103, over which is coated the crosslinked ink embedded-polymer matrix 104, and a portion of tie coat without any embedded ink 105, wherein the crosslinked ink embedded-polymer matrix comprises an arrangement of cured ink droplets and cured ink domains having interstitial ink-free spaces that access the surface bearing the surface decoration ink layer (in this case the paint layer 103) all of which ink (104 in black) embedded in the crosslinked ink embedded-polymer matrix, wherein at least some of the interstitial ink-free spaces are occupied by a crosslinked polymer (see crosshatch arrows) of the crosslinked ink embedded-polymer matrix (104, 105). As a result of the bridging of the ink layer to the underlying surface (through ink free gaps) which is the paint layer 103 in this embodiment, the embedded ink is effectively covalently bonded to the paint layer 103. In this schematic the tie coat formulation is provided at a dry film thickness that is greater than the ink decoration layer thickness, so the upper portion of the tie coating is polymerized polymer without embedded ink 105. In this embodiment, clear coating 106 is provided over the tie coating. FIG. 2B is similar, except the crosslinked ink embedded-polymer matrix 205 comprising the embedded surface decoration ink layer is printed onto a precured layer of the tie coating 204, which can be the same or different chemistry to the crosslinked polymer of tie coating layer 206. FIG. 2C is similar except the crosslinked ink embedded-polymer matrix 303 is provided directly onto a primed layer 303 instead of a paint coating layer. It will be apparent that variations of these configurations are possible.

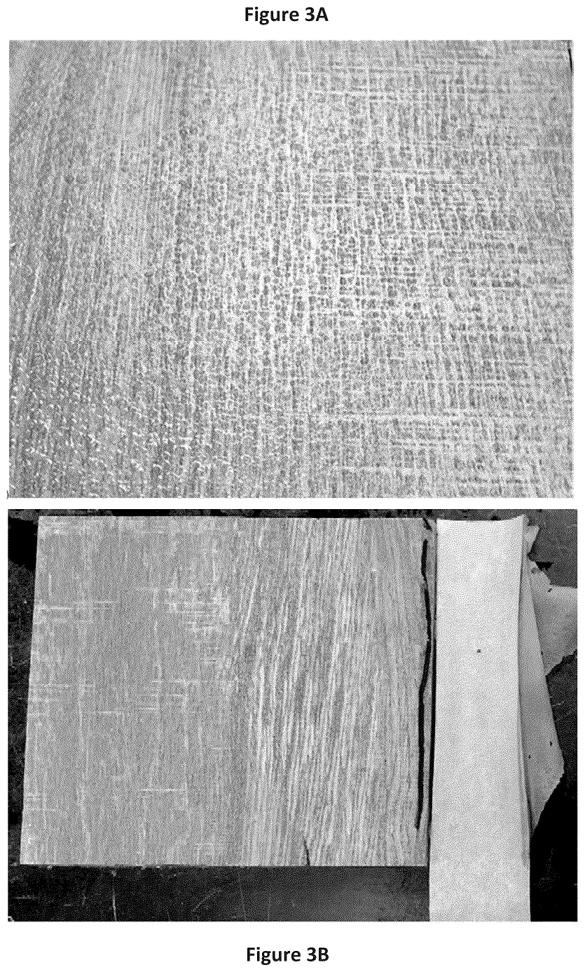

FIG. 3A shows the results of a water resistance test carried out on a smooth fiber cement product (e.g., a Hardie® Plank siding with ColorPlus® technology, in Artic White color “AW”) provided with a UV-curable inkjet printed ink (e.g., TIGITAL® inks) surface decoration over which is provided a waterborne clear coating over the printed ink surface decoration. The test examples described herein all use a clear topcoat formed from an acrylic polymer latex emulsion that may further comprise light stabilizers for UV resistance, e.g., hindered amine light stabilizers (HALs) and/or UV absorbers (UVAs).), e.g., from the Tinuvan® range. The exemplary acrylic polymer latex resin used herein is commercially available as RHOPLEX™ EI-6000 from Dow Chemicals, however, other similar acrylic polymer latex emulsions or polyurethane polymer emulsions could be used as suitable alterative resin systems, which may also include light stabilizers, e.g., HALs and/or UVAs, for UV resistance. The resulting clear topcoating formed from RHOPLEX™ EI-6000 has a minimum film formation temperature (MFFT) of from 12-16° C. and a glass transition temperature (T_{g}) of about 22 to 25° C. Test results for EVOQUE1180 from Dow Chemicals are also shown below. FIG. 3A shows that significant blistering occurs after water immersion and there is significant loss in quality of the topcoat due to the ink cohesive picking that occurs on the UV-curable inkjet printed fiber cement product provided with a waterborne clear coating only as a result of drenching that occurs on immersion in water. This result shows that the waterborne clear coating/UV-curable inkjet ink combination has poor overall water resistance given the severe degree of blistering that occurs. The right portion of FIG. 3B shows the pulled off tape results of coating/ink adhesion testing (tape pull testing) carried out under wet conditions. The image shows a significant amount of the printed ink is removed onto the tape sticky surface. This test also shows the lack of durability of the waterborne clear coating/TIGITAL® ink combination under conditions encountered after water immersion.

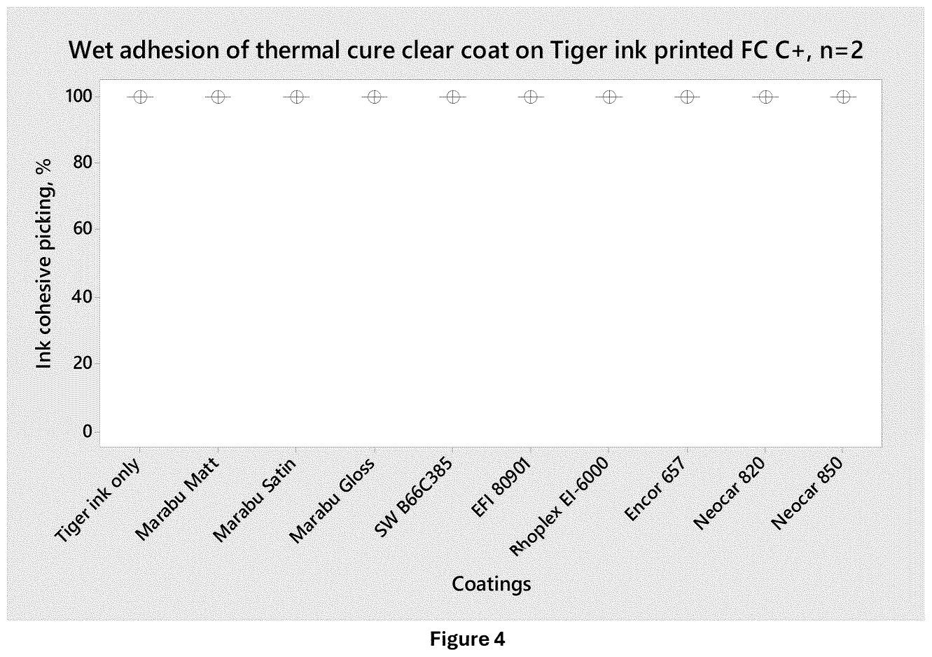

FIG. 4 shows a comparison of ink cohesive picking test results from a series of wet adhesion tests involving a UV-curable inkjet printed surface decoration provided on a printed smooth fiber cement product (Hardie® Plank siding with ColorPlus® technology, in Artic White color “AW”) without any topcoating layer (ink only) as control versus a series of test samples involving a UV-curable inkjet printed surface decoration on a smooth fiber cement product coated with a range of thermally cured waterborne clear top coats (as labelled on the x-axis of FIGS. 2A to 2C). The ink cohesive picking (%) was 100% for the control sample (ink only) and was 100% for each of the tested waterborne clear coatings. It is clear from these results that for at least the tested waterborne clear coating technologies, waterborne clear coatings alone are not suitable for protecting UV-curable inkjet ink printed surface decorations on surfaces of smooth fiber cement product from water damage under conditions that mimic product exposed to wet conditions.

The adhesion tests may be carried out as follows. Wet adhesion test method: First the printed article is immersed in water and soaked for 24 hours ensuring that at least two edges/ends do not have any coating on them or the backface is uncoated. Afterwards the article is removed, tapped dry with a paper towel and allowed to further dry another 5-10 minutes under ambient room conditions. Then a piece of 75 mm-100 mm long 3M 250 brand adhesive tape is affixed to the surface of the board at least 12.5 mm away from the edge of the board. Then the tape is smoothed with five passes of a small brush after which a 10 lb (2.2 kg) roller is rolled 10 times across the tape. The area of the tape is then outlined in marker. After this the tape is pulled vertically upwards quickly. The resulting tape and board are then compared to a “picking reference chart” to estimate the percentage removal of print. Freeze thaw adhesion test method: First the printed article is immersed in water and soaked for 24 hours ensuring that at least two edges/ends do not have any coating on them or the backface is uncoated. Afterwards the article is removed, tapped dry with a paper towel and allowed to further dry another 5-10 minutes under ambient room conditions. Following this the pieces are placed in a container with the painted/printed side down and sufficient water is added to cover the samples. The samples are then subjected to a series of freeze-thaw cycles. After the target number of freeze-thaw cycles the boards are removed on a thaw cycle. They are allowed to sit in the room for 4 hours to achieve complete thawing. Then a piece of 75 mm-100 mm long 3M 250 brand adhesive tape is affixed to the surface of the article at least 12.5 mm away from the edge of the article. Then the tape is smoothed with five passes of a small brush after which a 10 lb (2.2 kg) roller is rolled 10 times across the tape. The area of the tape is then outlined in marker. After this the tape is pulled vertically upwards quickly. The resulting tape and board are then compared to a “picking reference chart” to estimate the percentage removal of print.

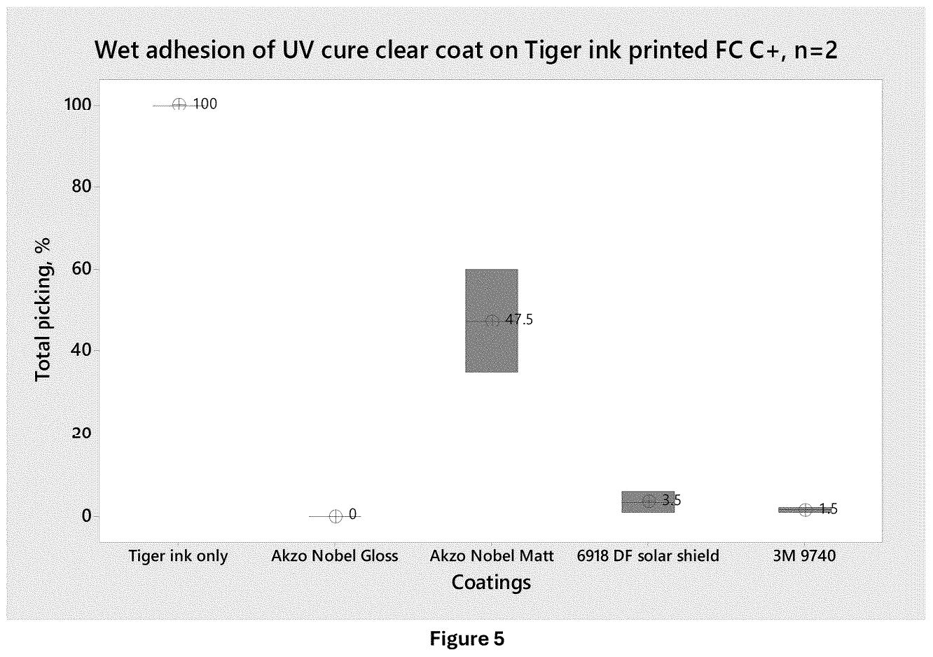

FIG. 5 shows a comparison of the results of wet adhesion testing of a UV-curable inkjet printed surface decoration provided on a printed smooth fiber cement product (Hardie® Plank siding with ColorPlus® technology, in Artic White color “AW”) without any topcoating layer (ink only) as control versus a series of test samples involving a UV-curable inkjet printed surface decoration on a smooth fiber cement product coated with a range of UV cured clear topcoatings (as labelled on the x-axis of FIG. 5). As before, the total picking (%) was 100% for the control sample (ink only without any topcoating). A total picking (%) result of 47.5% was achieved for the sample involving the Akzo Nobel Matt UV cured clear topcoating. An excellent total picking (%) result of 0% was achieved for the Akzo Noble Gloss UV cured clear topcoating, and a good result of 3.5% and 1.5% was achieved for the 6918 DF Solida Sheild and 3M 9740 clear topcoatings respectively. These tests show that certain UV-curable coatings are capable of providing good to excellent water resistance to a UV-curable inkjet printed surface decoration provided on a surface of a fiber cement product.

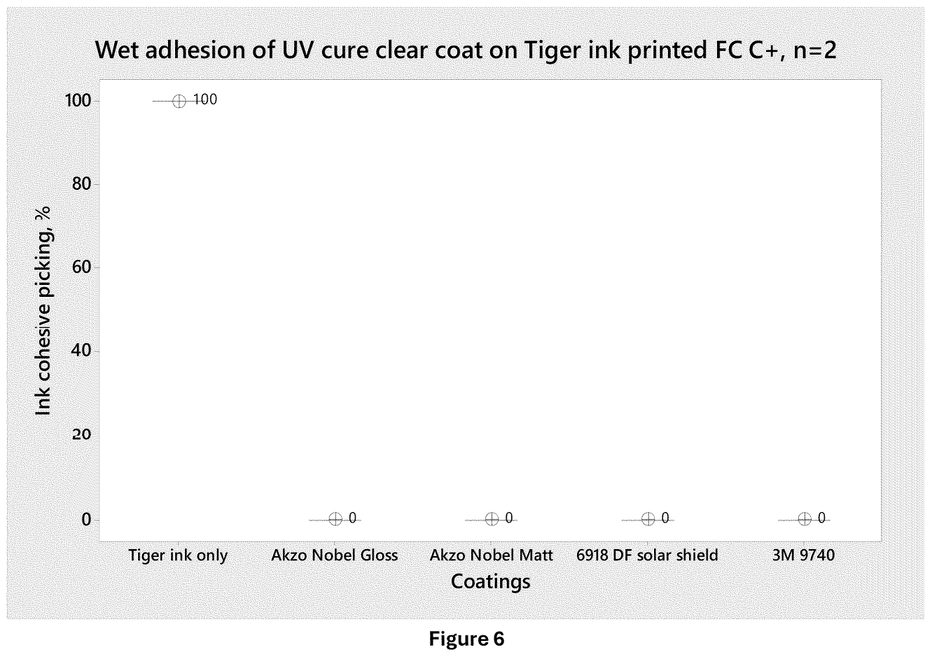

FIG. 6 shows a comparison of the results of wet adhesion testing of a UV-curable inkjet printed surface decoration provided on a fiber cement product (Hardie® Plank siding with ColorPlus® technology, in Artic White color “AW”) without any topcoating layer (ink only) as control versus a series of test samples involving a printed surface decoration using TIGITAL® inks on a smooth fiber cement product coated with a range of UV cured clear topcoatings (as labelled on the x-axis of FIG. 4). The ink cohesive picking (%) was 100% for the control sample without any topcoat and was 0% for all of the UV curable clear coatings as tested. An excellent ink picking (%) result of 0% was achieved for all of the tested UV curable clear topcoatings. These tests show that all of the UV coatings also are more water resistant than the waterborne coats.

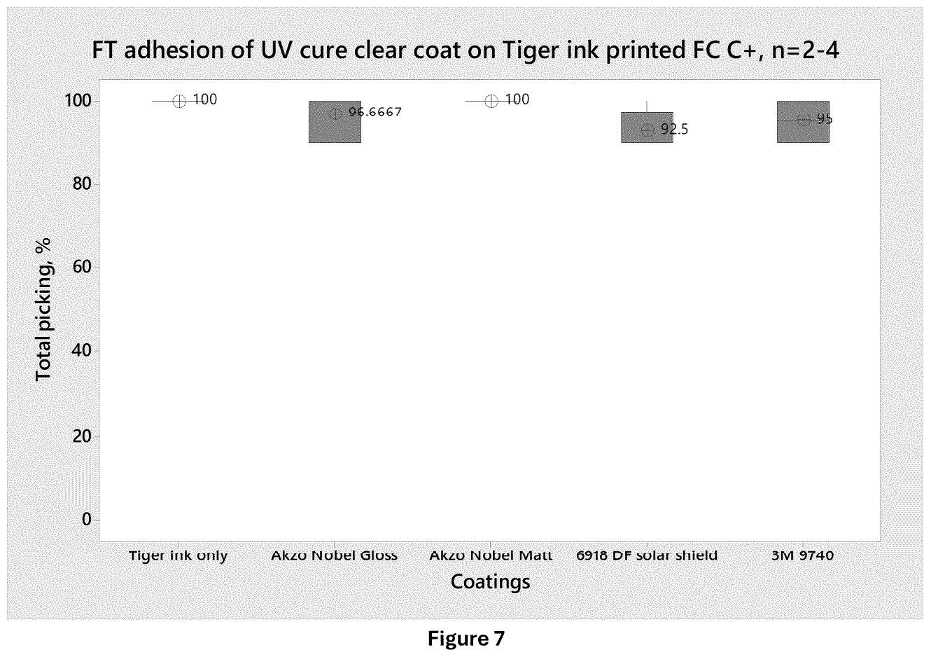

FIG. 7 shows a comparison of the results of wet adhesion testing under freeze thaw conditions of a UV-curable inkjet printed surface decoration provided on a printed smooth fiber cement product (Hardie® Plank siding with ColorPlus® technology, in Artic White color “AW”) without any topcoating layer (ink only) as control versus a series of test samples involving a printed surface decoration using TIGITAL® inks on a smooth fiber cement product coated with a range of UV cured top clear coatings (as labelled on the x-axis of FIG. 5). The total picking (%) was 100% for the control sample without any topcoat and was close to 100% for all of the UV clear coatings as tested. These results show that the tested UV clear topcoatings alone are not sufficient to protect the UV-curable inkjet ink surface decoration on the fiber cement product under freeze-thaw (FT) conditions.

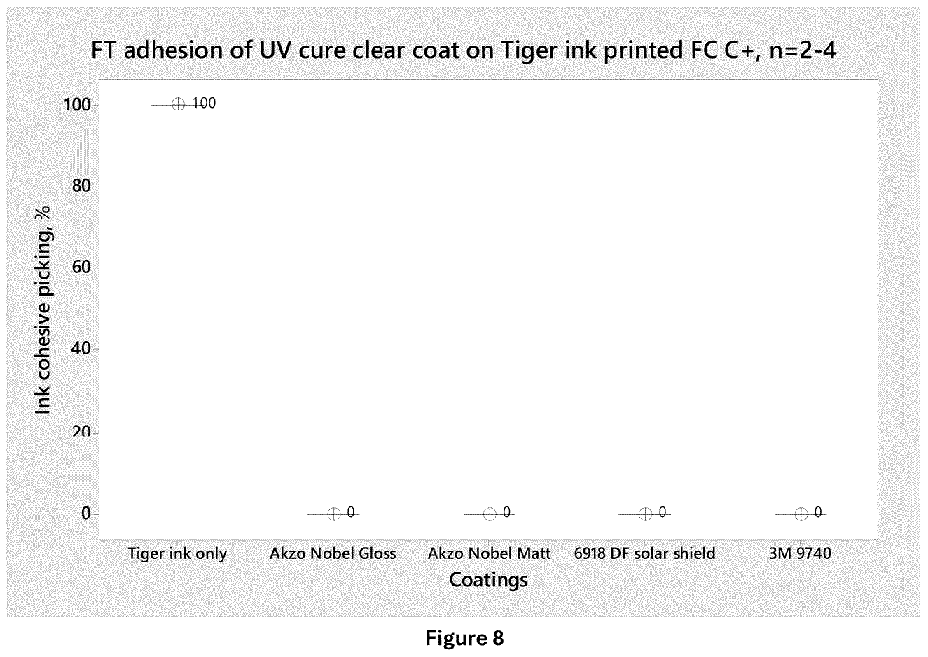

FIG. 8 shows a comparison of the results of wet adhesion testing under freeze thaw conditions of a UV-curable inkjet printed surface decoration provided on a printed smooth fiber cement product (Hardie® Plank siding with ColorPlus® technology, in Artic White color “AW”) without any topcoating layer (ink only) as control versus a series of test samples involving a printed surface decoration using TIGITAL® inks on a smooth fiber cement product coated with a range of UV cured clear topcoatings (as labelled on the x-axis of FIG. 6). The ink cohesive picking (%) was 100% for the control sample without any topcoat and was an excellent 0% for all of the UV clear coatings as tested. These results show that the tested UV clear topcoatings alone are sufficient to protect the UV-cured inkjet printed ink on the fiber cement product from ink picking under freeze-thaw (FT) conditions.

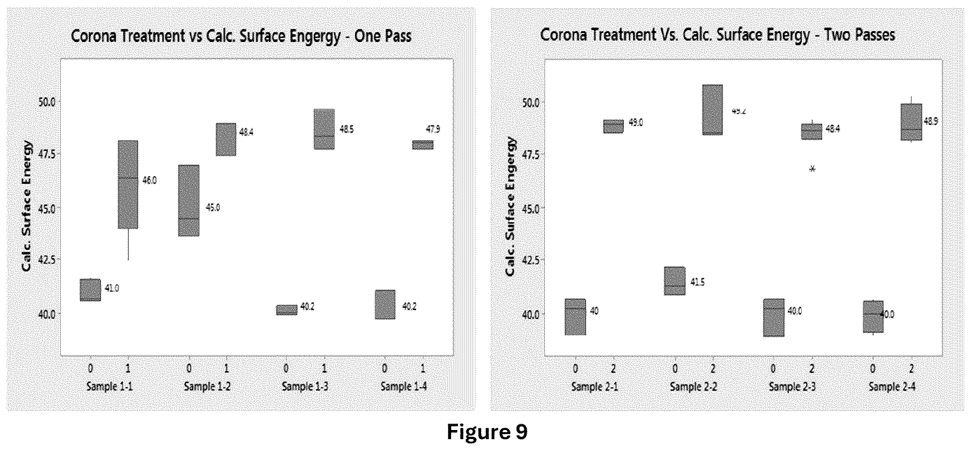

FIG. 9 shows the differences in surface energy of surfaces of a series of UV-curable inkjet printed surfaces of fiber cement ColorPlus® products with and without one or two passes of Corona treatment. As shown, successive rounds of Corona treatment increase the surface energy of the products. Surface energy was measured by means of a dyne pen. In this test there are a series of pens filled with fluid of different surface energy fluids (as measured in dynes/cm). Samples are first clean and free of obvious damage. A dyne pen is chosen and three parallel marks are made with it on the surface of the painted/printed article. The third line is read as to whether it wets the surface or not. Additional dyne pens are chosen of different surface energies until there is no significant beading of the pen fluid on the surface after sitting for 3 seconds.

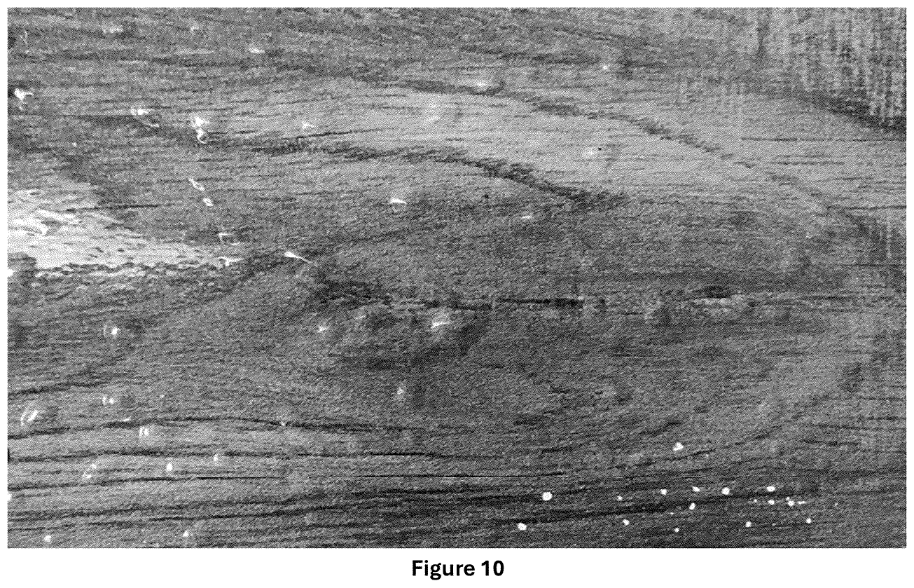

FIG. 10 shows blistering that occurs after 24 cycles of freeze thaw testing on the sample involving a UV-cured inkjet printed onto a smooth fiber cement ColorPlus® product (Hardie® Plank siding with ColorPlus® technology, in Artic White color “AW”) provided with a 3M 9740 UV cure clear topcoating. These results show the UV topcoating alone is not sufficient to protect the printed surface decoration under freeze thaw conditions.

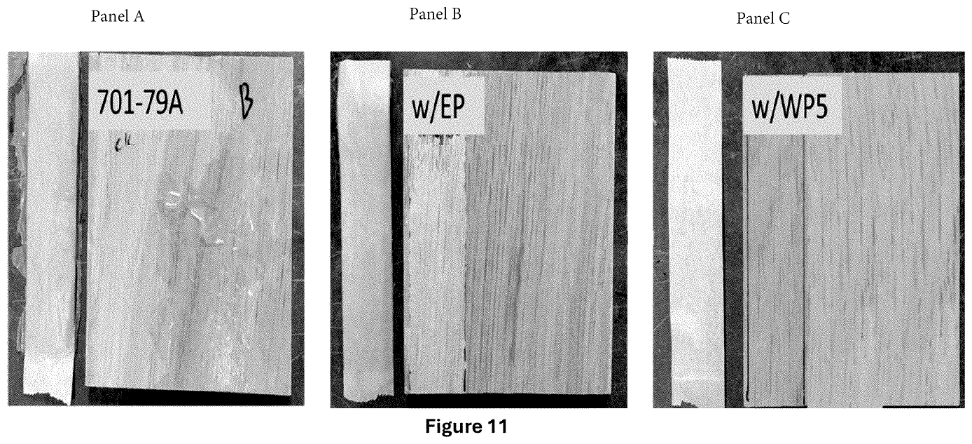

FIG. 11 shows visual results of wet paint adhesion testing of a series of UV-curable inkjet printed fiber cement ColorPlus® products with and without 0.1 mil of EP or WP coating provided during manufacture between ink and waterborne clear coat, which in this instance was JH 701-79A. Only the WP5 coating led to 0% picking. FIG. 11 compares the appearance of three samples of a UV-cured inkjet ink surface decoration printed onto a smooth fiber cement ColorPlus® product (Hardie® Plank siding with ColorPlus® technology, in Artic White color “AW”) after wet paint adhesion picking test wherein the samples shown are: in Panel A: —a waterborne clear coat (JH 701-79A) only (control) over the ink surface decoration; Panel B: —0.1 mil DFT layer of EP (epoxy polymer) primer sandwiched between the ink surface decoration and a topcoat of waterborne clear coat (JH 701-79A) (test sample 1); and in Panel C: —an ink penetrating, 0.1 mil DFT WP5 crosslinked layer that penetrates and crosslinks with particles of the ink matrix of the ink surface decoration and under a topcoat of waterborne clear coat (JH 701-79A) (test sample 2). The results for material adhesion to the tape is shown to the left of the image in each panel. It is evident that the Panel C sample shows excellent performance in terms of least material bound to the tape after the adhesion test. By contrast, the tape of the control and test sample 1 panels (A and B) have significant amounts of the coating material stuck to the tape. Furthermore, the sample surfaces shown in Panels A and B have a large degree of obvious picking and surface decoration damage as a result of the removal of the tape during the adhesive test.

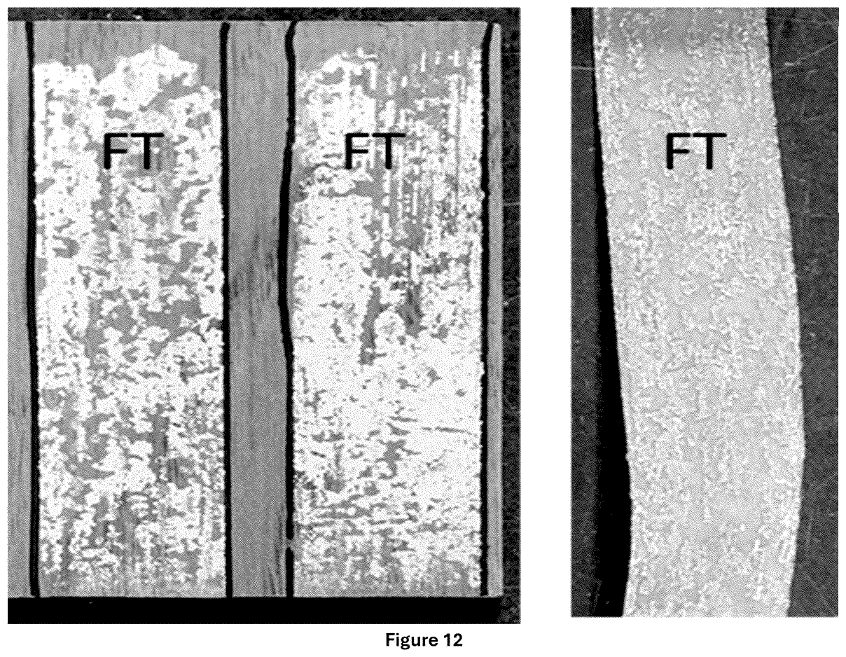

FIG. 12 shows visual results of paint adhesion tests of inkjet printed fiber cement ColorPlus® products with 0.1 mil WP in between ink and waterborne clear coat JH 701-79A. The picking mode was on ColorPlus® paint cohesive, none on ink cohesive. WP5 was able to improve both wet and FT paint adhesion of the inkjet ink.

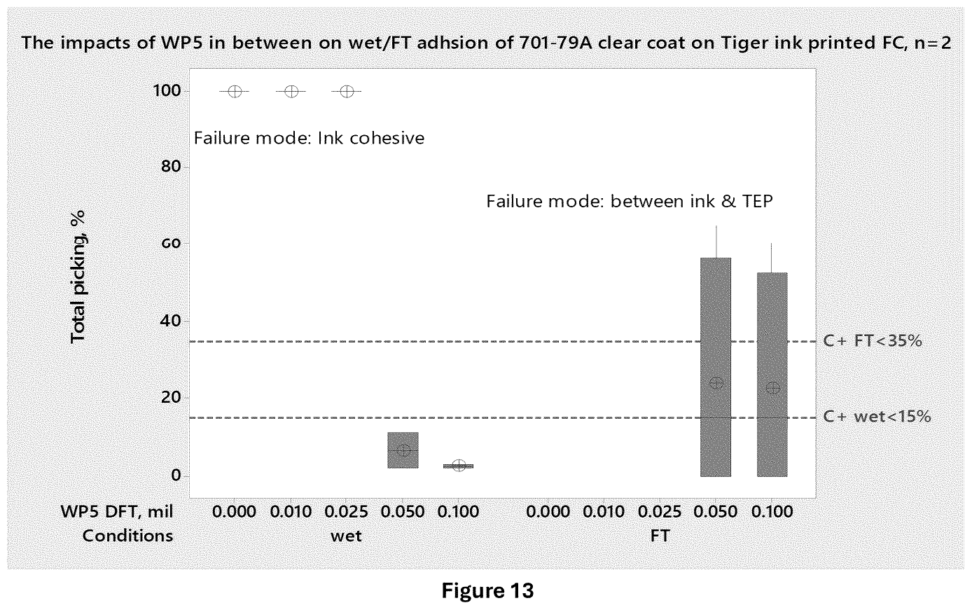

FIG. 13 shows the beneficial effect on total picking (%) under wet and freeze thaw conditions of production of a WP5-ink crosslinked matrix layer of a dry film thickness of from 0 to 0.1 mil under a topcoat of waterborne clear coat (JH 701-79A). The results show that a dry film thickness of the WP5-ink crosslinked matrix layer should be greater than 0.025 mil, and in some embodiments, at least 0.050 mil, reduces the total picking % from 100 to <15% under wet testing conditions and to <35% under freeze thaw test conditions.

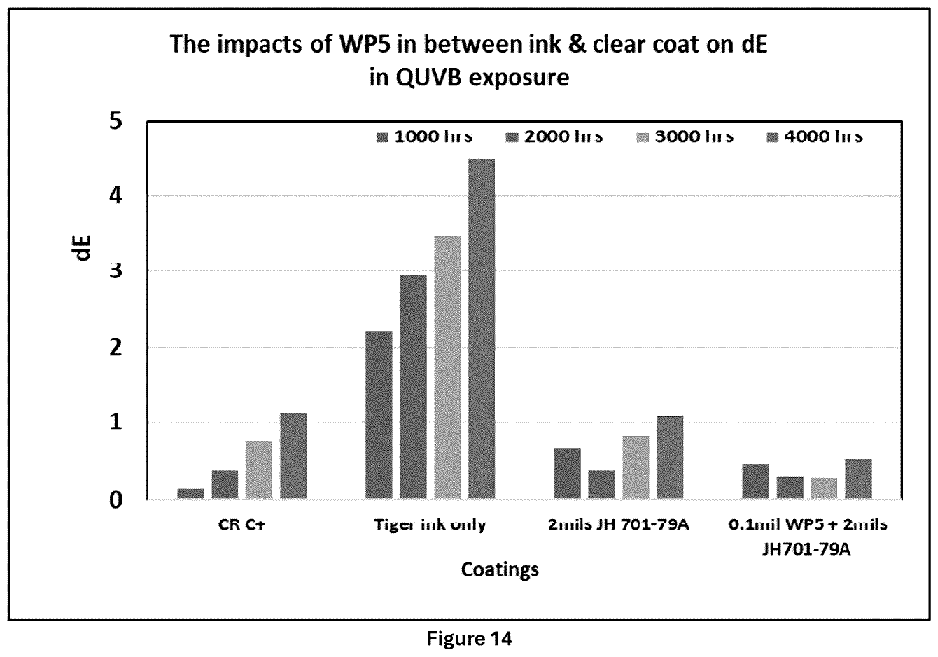

FIG. 14 shows the effect on dE in QUVB exposure testing of up to 4000 hours including a series of control samples using different dry film thicknesses of WP5 without topcoat, versus a series of test samples involving a first set with the ink surface decoration protected by 2 mil film of waterborne clear coat (JH 701-79A), and a second with the ink surface decoration protected by a 0.1 mil WP5 film under a 2 mil film of waterborne clear coat (JH 701-79A). These results show that while some UV protection is attributable to the waterborne clear coat (JH 701-79A), the UV resistance of is further improved when 0.1 mil of WP5 is included under the waterborne clear coat (JH 701-79A). Inclusion of the WP5 provides significant benefit in terms of reduced picking, total picking and the best UV resistance even at 4000 hours under QUVB exposure test conditions. These tests can be carried out in accordance with one or more of: Accelerated Weathering (QUV) ASTM G154, ASTM D4329, ASTM D4587, ISO 4892 tests. In summary, QUV weathering was performed in an accelerated weathering chamber with UVB bulbs that allowed a flexible mix of UV light, temperature and moisture conditions. The chamber is used to accelerate damage caused by sunlight, rain and condensed surface moisture or dew. Briefly, samples were prepared as described herein and then subjected to alternating cycles of light and moisture at controlled elevated temperatures.

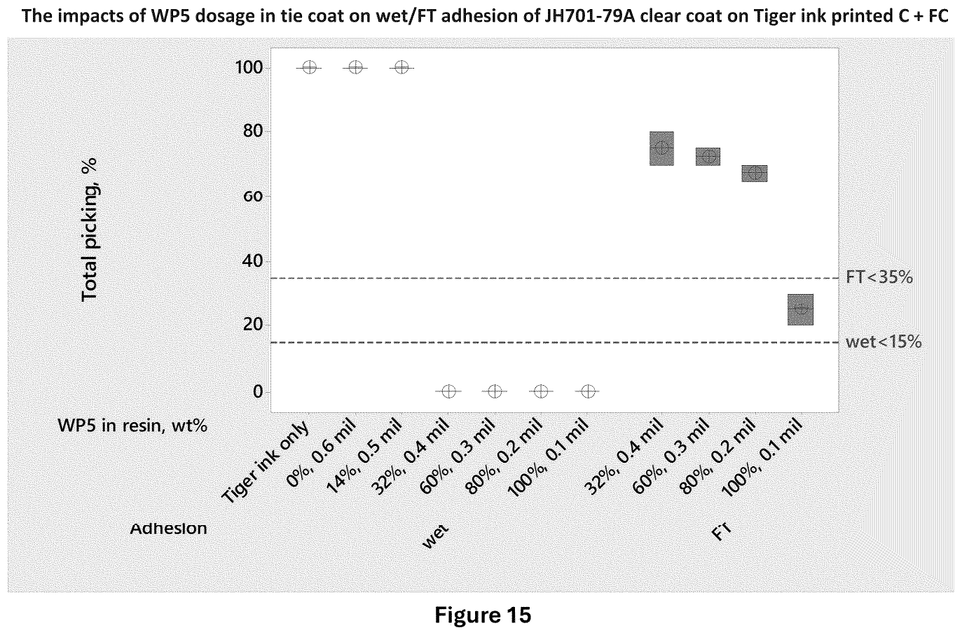

FIG. 15 shows the effect of WP5 dosage in JH701-79A resin carrier and DFT (0-100%, 0.6-0.1 mil DFT) in tie coat on adhesion of a UV-cured inkjet printed onto a smooth fiber cement ColorPlus® product (Hardie® Plank siding with ColorPlus® technology, in Artic White color “AW”) provided with waterborne clear coating (JH 701-79A) under wet and freeze thaw conditions. The minimal requirements for total picking % was 32 wt % WP in the JH701-79A resin carrier at a 0.4 mil DFT.

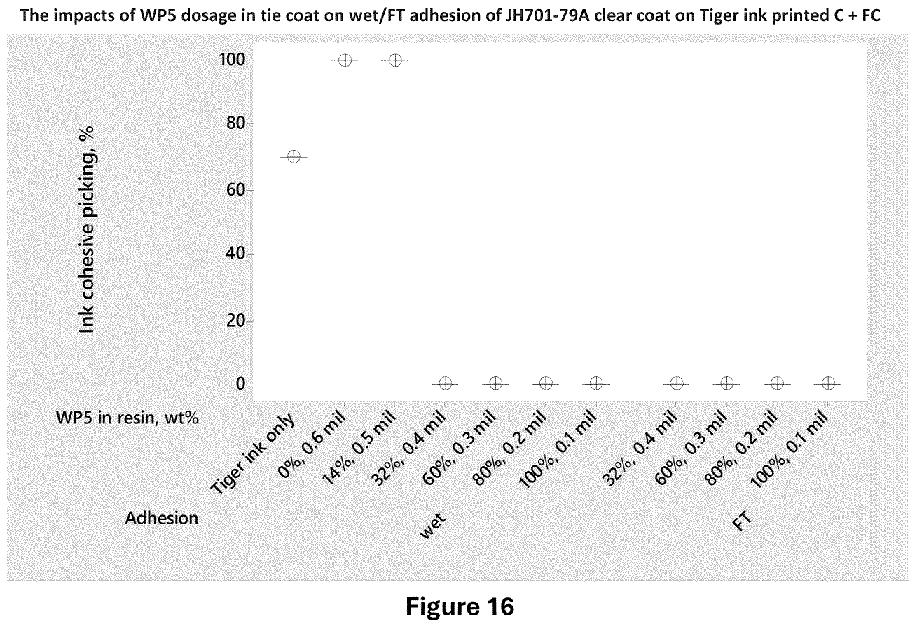

FIG. 16 shows the effect of WP dosage in JH701-79A resin carrier and DFT (0-100%, 0.6-0.1 mil DFT) of the tie coat on adhesion of a UV-cured inkjet printed onto a smooth fiber cement ColorPlus® product (Hardie® Plank siding with ColorPlus® technology, in Artic White color “AW”) provided with waterborne clear topcoating JH 701-79A under wet and freeze thaw conditions. The minimal requirements for 0% ink cohesive picking % was 32 wt % WP in the JH701-79A resin carrier at a 0.4 mil DFT.

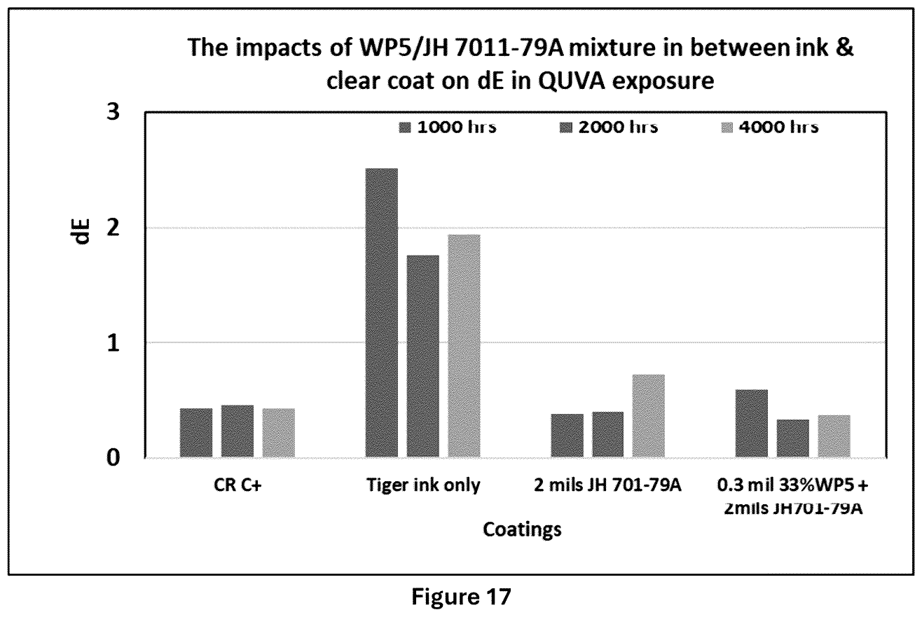

FIG. 17 shows the effect of the WP tie coat formulation provided in JH701-79A as a carrier (0.3 mil film of 33 wt % WP5) medium on DE in QUVA exposure tests where the tie coating formulation in the carrier is provided between the ink surface layer and the clear topcoat.

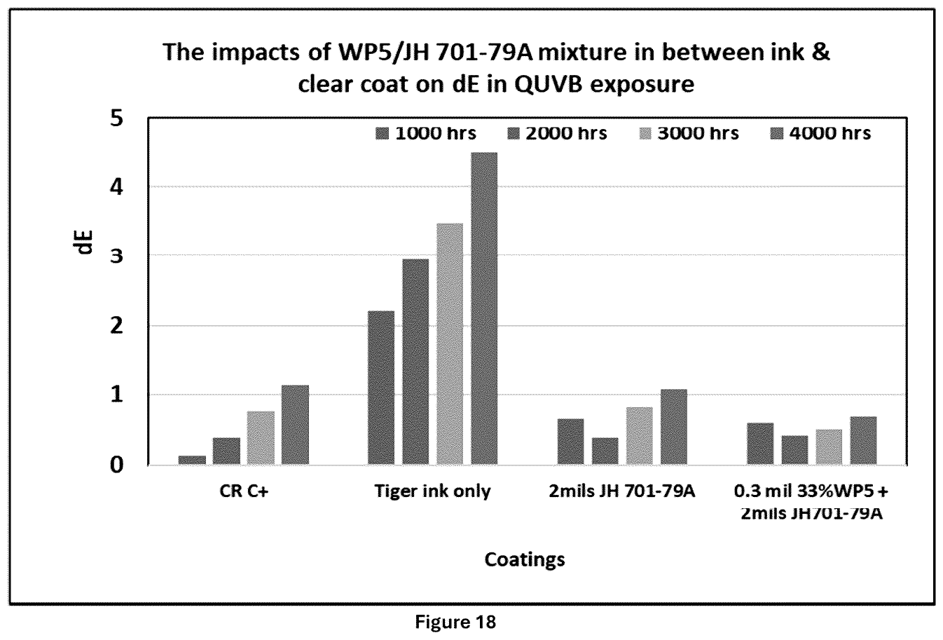

FIG. 18 shows the effect of the WP tie coat formulation provided in JH701-79A as a carrier (0.3 mil film of 33 wt % WP5) medium on DE in QUVA exposure tests where the tie coating formulation in the carrier is provided between the ink surface layer and the clear topcoat.

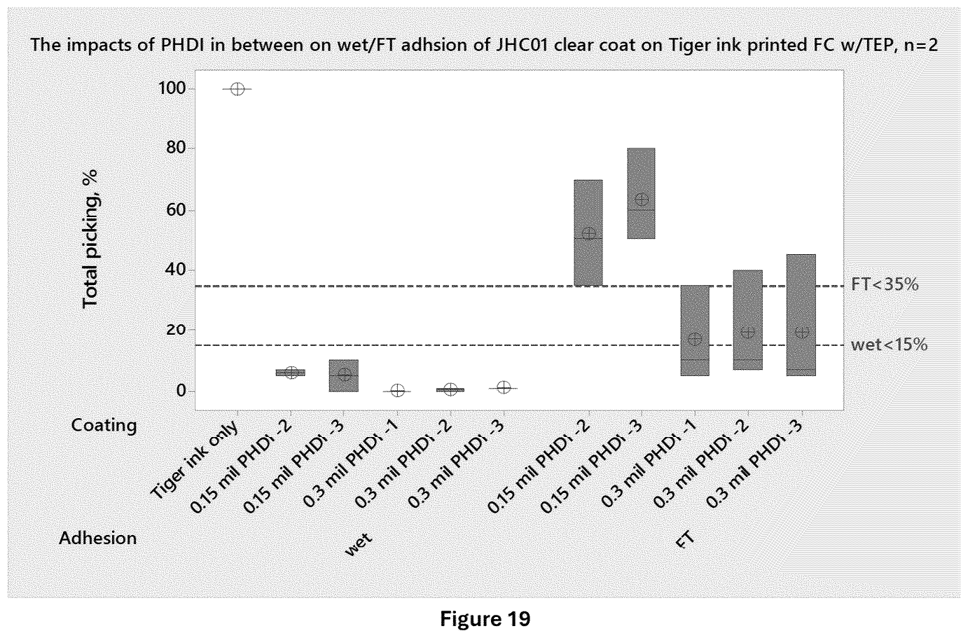

FIG. 19 shows the effect of a series of coating thickness of isocyanate tie coating formulations on total picking under wet and freeze thaw adhesion testing of a UV-cured inkjet printed fiber cement ColorPlus® products with waterborne clear coating JH 701-79A.

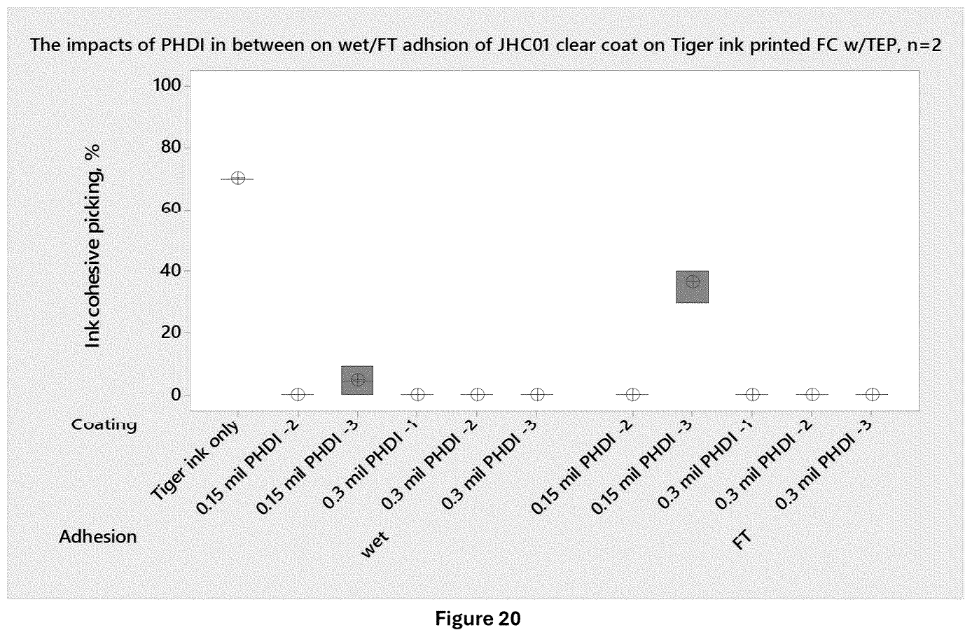

FIG. 20 shows the effect of a series of coating thickness of an isocyanate tie coating formulations on ink cohesive picking under wet and freeze thaw adhesion testing of a UV-cured inkjet printed fiber cement ColorPlus® products with waterborne clear coating JH 701-79A.

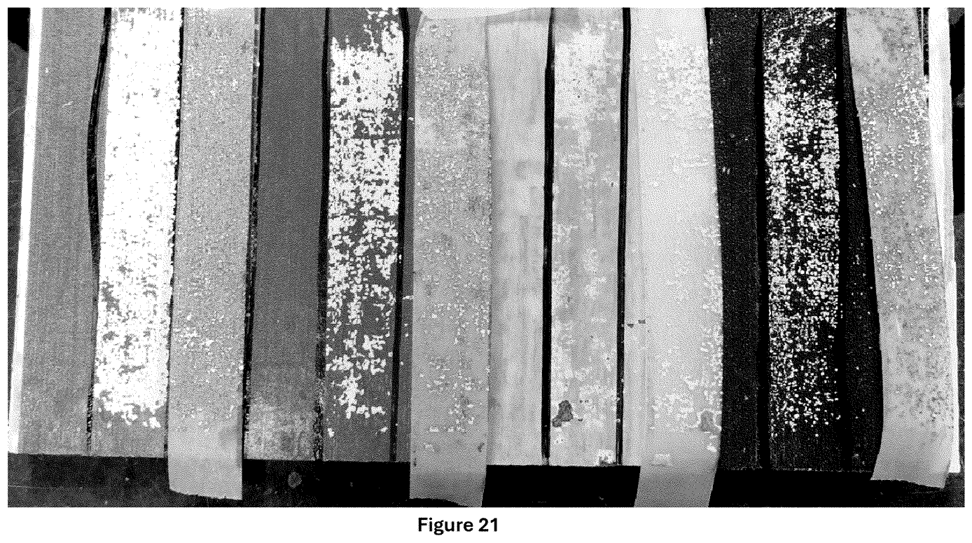

FIG. 21 shows visual results of a series of paint adhesion tests involving UV-cured inkjet printed fiber cement ColorPlus® products with a 0.3 mil thick aminosilane tie coating formulation (Silquest A600) provided over the surface decoration ink layer and the waterborne clear coat JH 701-79A.

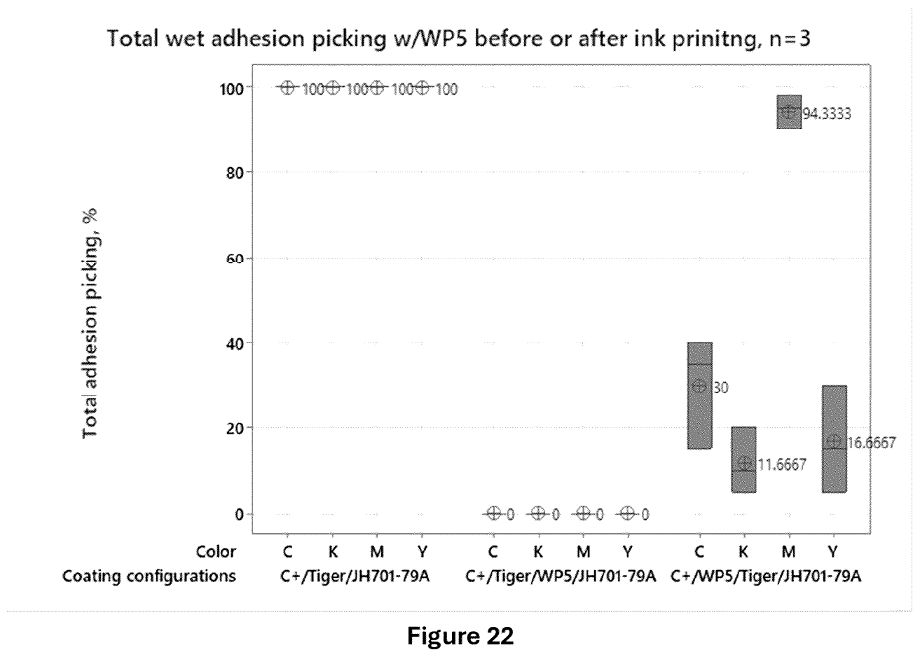

FIG. 22 shows results of wet adhesion picking tests for configurations with WP5 applied before or after ink printed layer;

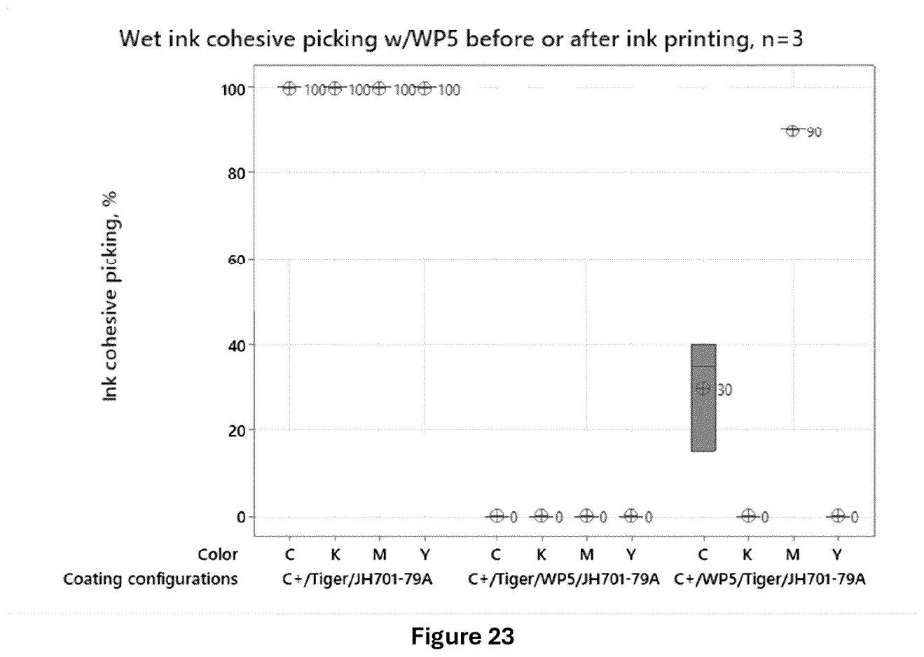

FIG. 23 shows results of wet ink cohesive picking tests for configurations with WP5 applied before or after ink layer; and

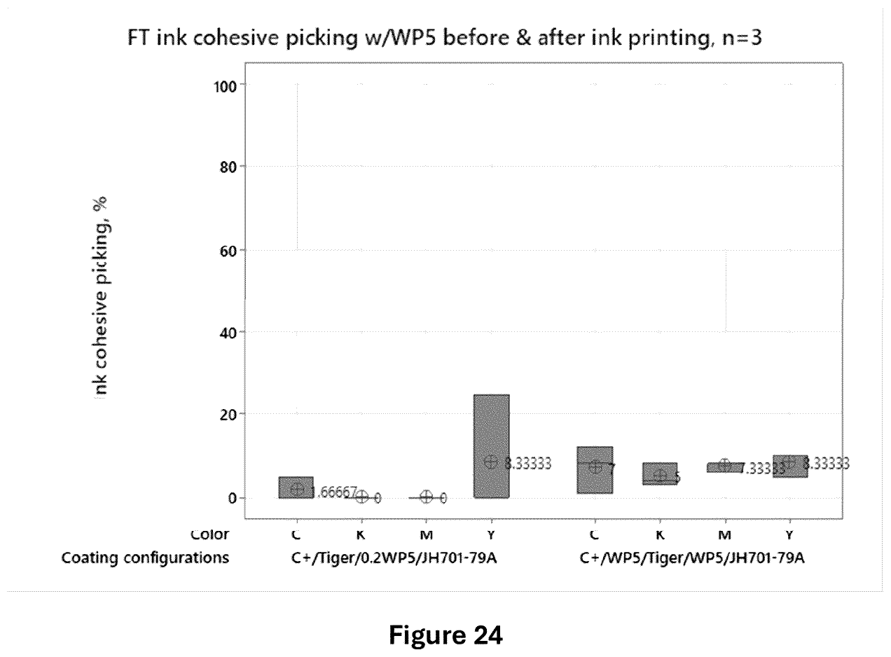

FIG. 24 shows results of freeze-thaw ink cohesive picking tests with WP5 before and after ink printing including sandwich configuration.

### EXAMPLES

### Example 1—Preparation of Inkjet Printed Surface Decorated Hardie® Fiber Cement Products ColorPlus® Technology

A Hardie® Plank siding with ColorPlus® technology, in Artic White color “AW” was provided and which had a primer coating of 0.5 mil thick overlayed by a 1.8 mil thick coating of ColorPlus® paint before inkjet printing. A woodgrain image or CMYK strips image was then digitally printed directly on the ColorPlus® plank using a Kerajet inkjet UV printer equipped with Xaar 2001 GS12 dual drop weight piezoelectric printheads using TIGITAL® inks. Samples of the inkjet printed product were then subject to a paint adhesion test.

For some samples, curable clear top coating was applied over the inkjet printed surface decorations provided on ColorPlus® painted surfaces of Hardie® ColorPlus® fiber cement products in Artic White color by means of a brushcoating technique. The samples were dried and then weighed to get the dry film thickness estimates (DFT). Samples of the inkjet printed product were then subject to a paint adhesion test. Various curing chemistries were used and the curing methods include air cure, thermal cure and UV cure. The thermal cure topcoatings were cured by heating the plank to a surface temperature to 160 to 180° F. in an oven. The UV cure coatings were cured using the UV dosage based on manufacturer's recommendations, and were cured in a Fusion UV system.

The clear topcoated inkjet printed fiber cement specimens were stored in the lab for 24 hrs after curing. Prior to the paint adhesion testing, they were soaked for about 24 hours in water as part of the wet paint adhesion test or they were placed in a freeze thaw chamber after 24 hrs in water immersion, before the freeze thaw paint adhesion testing was carried out.

Table 1 lists the commercially available thermal or UV cured clear topcoatings used. Table 4 lists a series of JH in house prepared formulations used as clear topcoatings in addition to the commercially available coatings.

TABLE 4
Commercial waterborne clear topcoatings

| | Coating | Curing | |
|---|---|---|---|
| Clear coating | Chemistry | Method | Manufacturer |
| Marabu Clear shield | Polyurethane | Thermal | Marabu |
| Classic lite high gloss | | | |
| Marabu Clear shield | Polyurethane | Thermal | Marabu |
| Wall Armor satin | | | |
| Marabu Clear shield Matt | Polyurethane | Thermal | Marabu |
| SW B66C385 | Polyacrylics | Thermal | Sherwin William |
| EFI 80901 | Unknown | Thermal | EFI polymers |
| Aquavue KV630 | Polyacrylics | Thermal | ICD high performance |
| | | | coatings & chemistry |
| PS100 | Polyfluoride | Thermal | ICD high performance |
| | | | coatings & chemistry |
| CPUV clear coat | Polyacrylics | UV | INX International |
| 60039 | Polyacrylics | UV | Inks system |
| Akzo Nobel 860233 | Polyacrylics | UV | Akzo Nobel |
| Gloss | | | |
| Akzo Nobel 860098 Matt | Polyacrylics | UV | Akzo Nobel |
| 3M 9740 | Polyacrylics | UV | 3M |
| 6918 DF solar shield | Polyacrylics | UV | Polymeric group |

TABLE 5
Resins used in JH formulated clear coatings

| | | Curing | |
|---|---|---|---|
| Binder/Resin | Coating Chemistry | Method | Manufacturer |
| Neorez R2180 | Polyurethane | Thermal | DSM Coating |
| | | | Resins, LLC |
| Silres BS32A | Silicone | Thermal | Wacker |
| Silres BS34A | Silicone | Thermal | Wacker |
| Encor 631 | Polyacrylics | Thermal | Arkema |
| Encor 657 | Polyacrylics | Thermal | Arkema |
| Encor 2722 | Polyacrylics | Thermal | Arkema |
| Neocar 820 | Polyacrylics | Thermal | Arkema |
| Neocar 850 | Polyacrylics | Thermal | Arkema |
| Kynar FMA-12 | Polyfluoride acrylics | Thermal | Arkema |
| Kynar ARC | Polyfluoride acrylics | Thermal | Arkema |
| Hydbridur 870 | Polyurethane acrylics | Thermal | Evonik |
| Rhoplex EL-6000 | Polyacrylics | Thermal | Dow Chemicals |
| Rhoplex HG-98B | Polyacrylics | Thermal | Dow Chemicals |
| Neopack R-9699 | Polyurethane acrylics | Thermal | DSM Coating |
| | | | Resins, LLC |
| Neorez R9257 | Polyurethane acrylics | Thermal | DSM Coating |
| | | | Resins, LLC |
| Setaqua 6716 | Polyacrylics | Thermal | Allnex |
| Setaqua 6717 | Polyacrylics | Thermal | Allnex |
| Setaqua 6766 | Polyacrylics | Thermal | Allnex |
| Ucecryl B3033 | Polyacrylics | Thermal | Allnex |
| Ucecryl B3055 | Polyacrylics | Thermal | Allnex |
| Setaqua 37-6498 | Polyacrylics | Thermal | Allnex |
| Pliotec SC 203 | Polyacrylics | Thermal | Allnex |
| Witcobond 386-03 | Polyacrylics | Thermal | Lanxess |

Coatings used in these studies included minor amounts of UV actives were added into the thermal cure topcoating resins of Table 3 and were provided over the UV-curable inkjet printed fiber cement surfaces prior to the paint adhesion test. The crosslinkers and resins were cured to provide a 2 mil dry film thickness on top of the UV-cured inkjet printed woodgrain image on the ColorPlus® product to be subjected to paint adhesion testing.

Where thermal cure clear topcoatings are used over the surface decoration, they were applied to provide a 1 mil dry film thickness on top of the UV-curable inkjet printed woodgrain image printed on the ColorPlus® product to be subjected to paint adhesion testing. The thermal cure clear topcoating was cured by heating the surface temperature of the plank to 160 to 180° F. in an oven. A 2 mil dry film thickness was then achieved by application of a second coating which was cured in the same manner. Results for ink cohesive picking after the wet adhesion test for samples involving the thermal curable clear topcoat experiments (without crosslinker technology) are shown in FIG. 4, The control without a topcoat had no resistance to ink cohesive picking during adhesive testing and gave an ink cohesion picking result of 100%. None of the tested thermally curable waterborne coatings were sufficient to prevent ink cohesive picking occurring during the adhesion test and all tested thermally cure waterborne topcoatings gave an ink cohesion picking result of 100%.

Where UV cure clear topcoatings are used, the UV cure coatings were applied in one coat to provide a 2 mil dry film thickness and were cured using the UV dosage according to the manufacturer's recommendations, and cured in Fusion UV system. Results for total picking after the adhesion test for the UV curable clear topcoat experiments (without crosslinker technology) under wet conditions are shown in FIG. 5. The control without a topcoat had no resistance to total picking during adhesive testing and gave a total picking result of 100%. Most of the tested UV curable waterborne coatings (without crosslinker technology) under wet conditions) were sufficient to prevent total picking from 0% (Akzo Nobel Gloss coating) up to 3.5% (6918 DF solar shield). The worst result arose from use of the UV curable Akzo Nobel matt clear topcoat which gave a total picking result of 47.5%. FIG. 6 shows the results for ink cohesive picking for control without a topcoat and the tested UV cure clear topcoats tested under wet conditions. In this case, the ink cohesive picking was 0% for all UV curable clear topcoats tested.

For adhesion testing of the print and coatings a tape peel test was utilized. Two variants of this test were run: dry adhesion (measures adhesion of the ink and/or coatings on a dry as-received sample, and wet adhesion (measures adhesion of the ink and/or coatings after exposure to water and subsequent drying). For this test the printed and/or coated fiber cement product is cut and cleaned with a soft sponge or rag.

The adhesion tests may be carried out as follows. Wet adhesion test method—first the printed article is immersed in water and soaked for 24 hours ensuring that at least two edges/ends do not have any coating on them or the backface is uncoated. Afterwards the article is removed, tapped dry with a paper towel and allowed to further dry another 5-10 minutes under ambient room conditions. Then a piece of 75 mm-100 mm long 3M 250 brand adhesive tape is affixed to the surface of the board at least 12.5 mm away from the edge of the board. Then the tape is smoothed with five passes of a small brush after which a 10 lb (2.2 kg) roller is rolled 10 times across the tape. The area of the tape is then outlined in marker. After this the tape is pulled vertically upwards quickly. The resulting tape and board are then compared to a “picking reference chart” to estimate the percentage removal of print. Freeze thaw adhesion test method-First the printed article is immersed in water and soaked for 24 hours ensuring that at least two edges/ends do not have any coating on them or the backface is uncoated. Afterwards the article is removed, tapped dry with a paper towel and allowed to further dry another 5-10 minutes under ambient room conditions. Following this the pieces are placed in a container with the painted/printed side down and sufficient water is added to cover the samples. The samples are then subjected to a series of freeze-thaw cycles. After the target number of freeze-thaw cycles the boards are removed on a thaw cycle. They are allowed to sit in the room for 4 hours to achieve complete thawing. Then a piece of 75 mm-100 mm long 3M 250 brand adhesive tape is affixed to the surface of the article at least 12.5 mm away from the edge of the article. Then the tape is smoothed with five passes of a small brush after which a 10 lb (2.2 kg) roller is rolled 10 times across the tape. The area of the tape is then outlined in marker. After this the tape is pulled vertically upwards quickly. The samples are then visually inspected and compared to a set of standardized images to get an estimate of the coverage lost and presented as % picking (0% no picking, 100% total removal).

FIG. 7 and FIG. 8 shows the results of freeze-thaw (FT) paint adhesion testing for total picking % and ink cohesive picking % respectively for a UV-curable inkjet printed fiber cement product with provided with various UV cure clear topcoatings. Similar to the wet paint adhesion results, there was almost 100% total picking on ColorPlus® cohesive and ColorPlus® to TEP, under freeze thaw conditions for UV cure clear topcoats (FIG. 7), but 0% ink cohesion picking (FIG. 8) for the tested coatings. Furthermore, severe blistering was observed on 3M 9740 UV cure clear coatings on UV-curable inkjet printed fiber cement ColorPlus® products after 24 cycles FT (FIG. 10) supporting the understanding that long term weather might be problematic for UV curable topcoats. Thus, while some success was found with certain UV curable waterborne coatings, generally speaking, UV curable clear topcoatings alone do not appear to be sufficiently durable for long term weathering conditions experienced in exterior applications.

### Example 2—Impacts of Corona Surface Treatment on Paint Adhesion

Wetting is the ability of a liquid to maintain contact with a solid surface, resulting from intermolecular interactions when the two are brought together. The degree of wetting is determined by a force balance between adhesive forces related to the fluid spreading on the surface and cohesive forces of the wetting liquid's surface tension following the Young Equation. Wetting is important in the bonding or adherence of two materials. The surface tension of UV-curable inkjet printed cement ColorPlus® product without a clear topcoat was determined to be about 40 to 42 dyne/cm. The surface tension of water is around 72 dyne/cm. Water and waterborne coatings struggle to wet a surface with low surface energy, such as wax. To study if increased surface energy of the UV-curable inkjet printed fiber cement ColorPlus® product would improve the paint adhesion of waterborne clear coatings on it, the surface was Corona-treated with one pass (FIG. 9(a)) or two passes (FIG. 9(b)). This increased the surface energy from 40-42 dyne/cm to 48 to 50 dyne/cm. After testing, it became apparent while there was an increase in surface tension, this did not translate to an improvement in the wet adhesion picking which was still found to be almost 100% on ink cohesive.

### Example 3—Adhesion Effect of a Crosslinked Ink Embedded Polymer Matrix

A waterborne clear coating formulated in house by James Hardie (JH 701-79A) and composed of Rhoplex EI-6000 resin/binder formulated with minor amounts of UV active components from the Tinuvin® range (a HAL and a UV absorber was used as clear topcoat (see Table 6 below).

A 2 mil dry film thickness layer of this clear top coating composition was applied directly onto a UV-cured inkjet printed woodgrain image on the painted Artic White surface of Hardie® fiber cement ColorPlus® products by foam brush. As for the commercially available waterborne clear topcoat formulations tested, significant ink cohesive picking was observed during testing under wet paint adhesion tests (FIG. 11 (Panel A)).

In an attempt to improve the paint adhesion, two-part cure waterborne epoxy based coatings (EP & WP5) were employed.

Epoxy polymer (EP) is a two part cure epoxy polymer coating system which is a multicomponent coating system having at least two components, a first component comprising one or more latex polymers and a second component which is an aliphatic epoxy resin system having an oxirane functional component that is distinct from the one or more latex polymers, wherein the oxirane functional component in the aliphatic epoxy resin system has an epoxy equivalent weight less than 1000. The latex polymers have functional groups, that can react with the oxirane groups. These groups can react to cure, polymerize or crosslink the coating system. Examples of EP epoxy resin systems are disclosed in United States Patent Application published as US 2008/0008895, the contents of which are incorporated by reference herein.

WP5 is an example of a WP5 coating system which is also a two-component cure waterborne epoxy based coating and is described in more detail above, but is provided as liquid cycloaliphatic epoxy emulsified in water and which is cured with waterborne aliphatic amines as above. The WP5 coating system differs in at least one respect from epoxy polymer (EP) coating system in that the WP5 comprises monomers and/or oligomer components which are of much lower molecular weights than the epoxy functional latex polymer particles used in the epoxy polymer (EP) coating system.

A 0.1 mil dry film thickness coating of a two-part waterborne clear epoxy polymer (EP) system (from Axalta, WEC0103S for Part A; CEC0143 for Part B) or James Hardie waterborne tie coating formulation WP5 (epoxy monomer based) was applied on top of the inkjet ink and the sample was thermally cured at a surface temperature to 160 to 180° F. (71-82° C.). The EP and WP5 solid content in the respective water based emulsions was 20 wt %.

After the surface temperature was cooled below 100° F. (38° C.), a 2 mil (50.8 micron) dry film thickness of a waterborne clear coating formulation (JH 701-79A) was applied over the epoxy coatings of the samples and cured. The samples were then post cured at 60° C. in an oven overnight, and a paint adhesion test was carried out.

To measure adhesion of the coatings, tape (3M 250 tape) is applied to the coated substrate, and the tape is removed. The percentage of coating removed with the tape is measured in percent, relative to the area covered by the tape. In some embodiments, substrate failure (for example, loss of cohesion within the substrate) predominates over clean removal of the coating from the substrate in an adhesion test. A standard procedure for measuring adhesion picking is given in ASTM D3359 and/or above.

It was found that the epoxy polymer (EP) (epoxy monomer based) coating did not improve the paint adhesion under wet conditions (FIG. 11 (Panel B)).

Interestingly, the 0.1 mil dry film thickness of the James Hardie WP5 (epoxy monomer based) coating was found to improve the adhesion whereby under wet product conditions, picking was reduced from 100% to close to 0% (see FIG. 11 (Panel C)). Furthermore, on freeze thaw paint adhesion testing, around 70% total picking was observed (FIG. 12). The picking mode was on ColorPlus® paint cohesive (FIG. 12), but with none of on the ink cohesive. These results demonstrate that forming a tie layer crosslinked ink embedded-polymer matrix based on the WP5 (epoxy monomer based) tie coating formulation improve both wet and FT paint adhesion of UV-curable pigment inkjet ink onto a ColorPlus® paint coating on a fiber cement product.

It is believed that the low molecular weight and thus small size (monomers and/or oligomers) of components of the WP5 (epoxy monomer based) tie coating formulation mean the reactive components can fill spaces and voids in the ink layer while reaching the surface of the paint coating on the fiber cement board on which the ink sits. Thus, there is no hindrance to formation of a crosslinked ink embedded-polymer matrix in the sample involving the WP5 (epoxy monomer based) tie coating formulation. By contrast, the epoxy polymer (EP) coating system is very different as the large molecular size/weight of the latex polymer components of that system prevents the good pore filing that is readily accomplished by the WP5 (epoxy monomer based) tie coating formulation. Thus, an effective crosslinked ink embedded-polymer matrix cannot be not formed when the EP coating system is used.

To assess the influence of the tested product's ColorPlus® coating on cohesive picking, inkjet ink was printed directed on the surface sealed/primed Hardie® fiber cement plank without ColorPlus® paint. The sealer/primer provided on the raw fiber cement surface was a 0.5 mil DFT of tinted epoxy-polymer primer (TEP, which is a two-part waterborne epoxy sealer/primer from Axalta, similar to EP but with a green tint). A series of samples were prepared using 0 (control), 0.01, 0.025, 0.05 and 0.1 mil DFT of WP5 epoxy coating system which was applied directly over the inkjet printed ink. The WP5 (epoxy monomer based) tie coating formulation was then cured at a surface temperature of 160 to 180° F. to form an crosslinked ink embedded-polymer matrix. After the surface temperature was cooled below 100° F., 2 mil DFT of the JH 701-79A waterborne coating was applied onto the crosslinked ink embedded-polymer matrix of the samples, using 2 coats of 1 mil per coat. Each clear coat was separately cured at a surface temperature of 160 to 180° F. The samples were post cured @60° C. overnight in an oven prior to adhesion testing. The results showed that at least 0.05 mil DFT of the WP5 (epoxy monomer based) tie coating formulation was needed to form a crosslinked ink embedded-polymer matrix that was capable of improving the adhesion of the UV-curable inkjet printed ink on the sealer/primer coated fiber cement products (FIG. 13). Wet and freeze thaw adhesion pickings were still observed, but that occurred between the tinted epoxy-polymer primer (TEP) and the ink. No ink cohesive picking occurred in either adhesion test.

These results were compared to an embodiment where the tie coating (WP5) was initially formed on the ColorPlus® paint surface and cured, before a UV curable inkjet surface decoration was applied onto the cured WP5 layer. After ink curing, a clear topcoating (2 mil JH701-79A) waterborne clear topcoat was added over the ink surface decoration. In contrast to the above example involving formation of a crosslinked ink embedded-polymer matrix that covalently bonds to the surface bearing the surface decorated ink layer, it was found that while the WP5 tie coat strongly adhered to the paint surface bearing the tie coating, failure during adhesion testing was ink cohesive (failure occurred within the ink layer) indicating the ink was the weaker layer and much ink is visible on the tape and remaining on the product confirming ink cohesive failure. For the case without the WP5 tie coating, the adhesion failure was almost 100% ink cohesive picking. While providing ink over the cured WP5 layer did help ink adhesion somewhat (some remained on the product), it was far less effect than the embodiment where the wet WP5 is applied over a cured ink surface decoration layer. As explained elsewhere herein, since the ink layer(s) of the surface decoration layer is not a continues film (rather is a plurality of cured ink droplets and/or cured ink domains injected by a inkjet printer head, and having interstitial ink-free spaces between the cured ink droplets and ink domains that provide access to the surface bearing the surface decoration ink layer), the low molecular weight crosslinkable components of WP5 can fill/penetrate into the ink free spaces between the ink droplets/domains (e.g., see FIG. 1 where white Article White background shows through) which reinforces the ink layer, while covalently bonding it to the paint layer that bears the ink surface decoration. While it was surprising that the ink over WP5 configuration even exhibited some reinforcement from WP5, the results were far less superior to those of WP5 over ink layers. It is believed this is likely because in the ink over WP5 configuration, the ink droplets are not fully wrapped with WP5 as occurs in the WP5 over ink configuration. See FIG. 22 and FIG. 23.

A further variation was considered where the ink layer of the surface decoration was provided over a cured WP5 layer, and then wet WP5 was coated over the cured ink layer. As expected, the low molecular weight crosslinkable components of WP5 can fill/penetrate into the ink free spaces between the ink droplets/domains and bridged the ink to contact the underlying cured WP5 and on curing formed strong covalent bonds to the underlying WP5 layer while embedding the ink through formation of a crosslinked ink embedded-polymer matrix that covalently bonds to the surface bearing the surface decorated ink layer. As a result, the wet adhesion picking was 0%, significantly better than 100% peeled off for a control without WP5 and similar to the WP5 on cured ink configuration. The 24 cycles FT paint adhesion results are shown in FIG. 24. Thus, the sandwich configuration is also effective to in improving adhesion.

Some finished boards were exposed to simulated climatic conditions. Conditions include exposure to UVA or UVB for up to 4000 hours, environmental cycling of 24 cycles, and submersion in water for 24 hours. Following simulation of climatic conditions, coatings were tested for adhesion by tape removal according to ASTM D3359-09 and/or as described in brief above. In particular, QUVA & QUVB exposures tests of up to 4000 hrs were carried out on the samples with 0.1 mil and 3 mil DFT crosslinked ink embedded-polymer matrix based on WP5 crosslinker provided under a 2 mil JH701-79A waterborne clear topcoat. The results showed equal or slightly less color change occurred after UV exposure than for the equivalent sample without the WP5 (FIGS. 14, 16, and 17).

### Example 4—Low Molecular Weight Isocyanate Crosslinkable Coating Formulation

To support the general principle of use of low molecular crosslinking monomer and/or oligomer agents to improve inkjet printed ink to paint adhesion through formation of a crosslinked ink embedded-polymer matrix, low molecular weight isocyanate based crosslinking agents were also tested. Since aromatic isocyanates change color to yellow after UV exposure and given color stability is important for the exterior products, aliphatic isocyanates were tested. Desmodur® N3600 (“PHDI-1”, a trimer of 1,6-diisocyanatohexane, a colorless liquid aliphatic diisocyanate, M_{wt} thought to be about 500-800 g/mol); Bayhydur 304 (PHDI-2, a hydrophilically modified aliphatic HDI-polyisocyanate, a liquid, M_{wt} thought to be about 400-1000 g/mol); Bayhydur 2547 (PHDI-3, liquid, M_{wt} thought to be about 400-800 g/mol) were each used as supplied. Either 0.15 mil or 0.3 mil of dry film thickness of the isocyanate under consideration was applied on inkjet printed surface decoration on fiber cement planks over a with 0.5 mil green tinted epoxy polymer (TEP) sealant. ColorPlus® paint was not used in this example. Then, a 1 mil dry film thickness of JH701-79A clear top coating formulation was applied to the ink decorated surface. Cured surface temperature was 160 to 180 F. The samples were post oven cured at ambient temperature for 7 days, before adhesion test were performed. FIG. 19 and FIG. 20 showed the isocyanates were also suitable to improve the adhesion of the ink to the unpainted, sealed only fiber cement surface. Note in these figures, JH701-79A is abbreviated to “JHC01” due to length of title of the figures.

### Example 5—Low Molecular Weight Aminosilane Crosslinkable Tie Coating Formulation

Another example involved applying 0.3 mil dry film thickness of Silquest A600 (an aminosilane, pure liquid monomer) on UV-cured inkjet printed surface decoration on fiber cement ColorPlus® plank in Artic White printed with CMYK strips as the surface decoration, and thermally curing to induce polymerisation and formation of the crosslinked ink embedded-polymer matrix of the disclosure. Then 1 mil DFT of the JH 701-79A clear topcoat formulation was applied on top of the crosslinked ink embedded-polymer matrix formed from the polymerisation of the aminosilane monomer crosslinker and thermally cured at a surface temperature of from 160 to 180° F. The samples were post cured at ambient temperature for 7 days, prior to being subjected to adhesion testing. Similar to the epoxy and isocyanate based crosslinked ink embedded-polymer matrix, no ink cohesive picking was observed in both wet and freeze thaw conditions (FIG. 21) signifying that the tie bond between the top coating and the ink layer was stronger than the bond of the paint to primed plank surface as a result of formation of the crosslinked ink embedded-polymer matrix of the disclosure.

### Example 6—Inkjet Printed Fiber Cement Products with Waterborne Clear Coatings with UV Stabilizers

Various clear topcoatings were applied over inkjet printed surface decorations on James Hardie ColorPlus® smooth fiber cement (FC) and tested for QUV exposure. The paint was Arctic White color and 1.8 mils of ColorPlus® paint which was cured, before printing. Inkjet ink (e.g., TIGITAL® inks) were used to print CMYK solid patterns on to the fiber cement product. It was found that the clear topcoatings were able to significantly reduce ink fading in both QUVA and QUVB exposures. For example, the waterborne clear coating formulated in house by James Hardie (JH 701-79A) is composed of Rhoplex EI-6000 resin/binder formulated with minor amounts of UV active components from the Tinuvin® range (a HAL and a UV absorber was used as an exemplary clear topcoat that gave good results. Other clear coatings with different chemistries were tested, including polyacrylic, polyurethane, polyurethane-acrylic, silicone, silicone-acrylic, and fluorinated polymer (see Table 7). The curing methods include air cure, thermal cure and UV cure. The thermal cure was heated surface temperature to 160 to 180° F. in oven. UV cure used the UV dosage based on manufacturer's recommendations, and cured in Fusion UV system. Table 6 specifies the UV stabilizers and specific function with respect to UV protection used in the tests. 2 mil DFT of the formulated waterborne clear coatings were applied on UV-curable inkjet printed fiber cement ColorPlus® boards with CMYK solid strips. Dried surface temperature to 160 to 180° F. in oven.

TABLE 6
UV stabilizers/absorbers

| Product name | Function | Manufacturers |
|---|---|---|
| Tinuvin 292 | HALS | BASF |
| Tinuvin 1130 | UVA | BASF |
| Tinuvin 123DW | HALS | BASF |
| Tinuvin 400DW | UVA | BASF |
| Tinuvin 5333 | UVA and HALS blending | BASF |
| Tinuvin 477DW | UVA | BASF |
| Tinuvin 479DW | UVA | BASF |
| Tinuvin 9945DW | UVA | BASF |
| Eversorb AQ1 | UVA and HALS blending | Everlight Chemical |
| | | Industrial Corp |
| Eversorb AQ8 | UVA and HALS blending | Everlight Chemical |
| | | Industrial Corp |

Inclusion of components taken from Table 6 all improved the clear topcoating performance against UV damage. The with lowest color change (dE) that occurred during testing was from the combination of a hindered amine HAL and UV absorber from Table 6. The clear coating with up to 55% UV absorber with and without up to 3 wt % HAL showed parity dE in 1000 hrs QUVB. Including at least a HAL in clear coating helped to reduce color change in long term UV exposure. Note: DPNB=di-propylene glycol normal butyl ether; PNB=propylene glycol normal butyl ether; 1 Mil= 1/1000th Inch. 1 Mil/Thou=25.4 Microns (μm).

TABLE 7
Clear coating formulations
Binder/Resin

Rhoplex EI-6000
Rhoplex EI-6000
Hybridur 870
Hybridur 870
KYNAR Aquatec FMA-12
KYNAR Aquatec FMA-12
KYNAR Aquatec ARC
KYNAR Aquatec ARC
JH-Silres BS32A
JH-Silres BS34A
JH-Neorez R2180
JH-Encor 631
JH-Neocar 820
Encor 657
Encor 657
*HALS & UVA dosage were based on resin

Although the embodiments have been described with reference to specific examples, it will be appreciated by those skilled in the art that the disclosure may be embodied in many other forms.

It is also contemplated that various combinations or sub-combinations of the specific features and aspects of the embodiments may be made and still fall within the scope of the disclosure. Accordingly, it should be understood that various features and aspects of the disclosed embodiments can be combined with or substituted for one another in order to form varying modes of the disclosed embodiment. Thus, it is intended that the scope of the present disclosure herein disclosed should not be limited by the particular disclosed embodiments described above but should be determined only by a fair reading of the claims that follow.

Similarly, this method of disclosure, is not to be interpreted as reflecting an intention that any claim require more features than are expressly recited in that claim. Rather, as the following claims reflect, inventive aspects lie in a combination of fewer than all features of any single foregoing disclosed embodiment. Thus, the claims following the Detailed Description are hereby expressly incorporated into this Detailed Description, with each claim standing on its own as a separate embodiment.

What is claimed is:

1. A method of manufacturing a surface decorated cementitious building article for external use, the method comprising:
contacting an ink printed surface decoration ink layer, provided on a surface of a cementitious building article with a curable tie coating formulation comprising one or more monomers and/or oligomers having polymerizable functional groups,
wherein the surface decoration ink layer comprises an arrangement of one or more of: a plurality of cured ink droplets and/or cured ink domains having interstitial ink-free spaces between the cured ink droplets and/or cured ink domains that provide access to the surface bearing the surface decoration ink layer,
allowing the monomers and/or oligomers of the tie coating formulation to bridge the surface decorated ink layer and the cementitious building article surface bearing the surface decoration ink layer via the ink-free spaces of the surface decorated ink layer; and
inducing polymerization of the monomers and/or oligomers of the tie coating formulation, thereby forming a crosslinked ink embedded-polymer matrix that covalently bonds to the surface bearing the surface decorated ink layer and embeds the ink droplets and/or domains in situ within the crosslinked ink embedded-polymer matrix while preserving the cementitious building article surface decoration.

2. The method of claim 1, wherein the tie coating formulation is formulated with molecular components including the monomers and/or oligomers having a size that permits penetration through at least a portion of ink-free spaces in the surface decoration ink layer to contact the cementitious building article surface.

3. The method of claim 1, wherein the monomers and/or oligomers of the tie coating formulation are low molecular weight monomers and oligomers having a molecular weight of less than 50,000 g/mol.

4. The method of claim 1, wherein the tie coat formulation, when precured, contains no detectable amount of polymer components.

5. The method of claim 1, wherein the monomers and/or oligomers of the tie coating formulation is present in the form of an emulsion in a liquid medium, and wherein the emulsion comprises monomers and/or oligomers having a particle size of 0.1 to 50 microns as determined by laser particle size analysis.

6. The method of claim 5, wherein the emulsion breaks down on contact with the surface decoration ink layer to deliver the monomers and/or oligomers to the cementitious building article surface bearing the surface decoration ink layer via the interstitial ink-free spaces of the surface decorated ink layer.

7. The method of claim 1, wherein the tie coating formulation is an emulsion comprising:
an aliphatic epoxy resin, wherein the aliphatic epoxy resin comprises epoxide functional groups, and the aliphatic epoxy resin has a monomer: 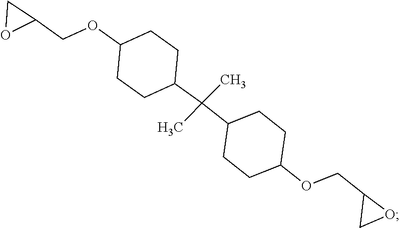 [SMILES: CC(C)(C1CCC(OCC2CO2)CC1)C1CCC(OCC2CO2)CC1]
wherein the emulsion has an emulsion particle size of 0.1 to 50 microns;
a first curing agent and a second curing agent, wherein each of the first curing agent and the second curing agent comprise amine hydrogen functional groups;
wherein the first curing agent has a viscosity of 100 to 1,000 cP and comprises compounds having the formula: 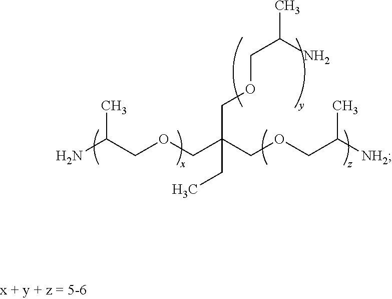
wherein the second curing agent has a viscosity of 25,000 to 50,000 cP, and comprises a polyamine of ammoniated oxirane; and
wherein the first curing agent has amine hydrogen functional groups in 0.25 to 2 equivalents, and the second curing agent has amine hydrogen functional groups in 0.05 to 0.5 equivalents, relative to one equivalent of epoxide functional groups in the aliphatic epoxy resin.

8. The method of claim 1, wherein the tie coating formulation comprises:
an emulsion comprising an aliphatic epoxy resin, wherein the aliphatic epoxy resin comprises a monomer including a cycloalkyl group, wherein the aliphatic epoxy resin further comprises epoxide functional groups, and wherein the emulsion has an emulsion particle size of 0.1 to 50 microns;
a first amine curing agent and a second amine curing agent, wherein each of the first amine curing agent and the second amine curing agent comprise amine hydrogen functional groups;
wherein the first amine curing agent comprises an oxyalkylene; and
wherein the second amine curing agent comprises a polyamine, and wherein the second amine curing agent has a higher viscosity than the first amine curing agent; and
wherein the first amine curing agent has amine hydrogen functional groups in 0.25 to 2 equivalents, and the second amine curing agent has amine hydrogen functional groups in 0.05 to 0.5 equivalents, relative to one equivalent of epoxide functional groups in the aliphatic epoxy resin.

9. The method of claim 1, wherein the tie coating formulation forms the crosslinked ink embedded-polymer matrix having a coating dry film thickness (DFT) of 0.01 mil or more.

10. The method of claim 1, wherein the surface of the cementitious building article directly bearing the crosslinked ink embedded-polymer matrix is a cured sealer coating or a cured primer coating provided on a raw surface of the cementitious building article.

11. The method of claim 1, wherein the surface of the cementitious building article directly bearing the crosslinked ink embedded-polymer matrix is a cured paint coating provided on a sealed surface, a primer surface and/or a raw surface of the cementitious building article.

12. The method of claim 1, wherein the surface of the cementitious building article directly bearing the crosslinked ink embedded-polymer matrix is a cured tie coating provided on a raw surface, a sealed surface or a painted surface, of the cementitious building article.

13. The method of claim 1, wherein the crosslinked ink embedded-polymer matrix is sandwiched between a lower tie coating and an upper tie coating having the same crosslinked polymer chemistry as the crosslinked ink embedded-polymer matrix.

14. A surface decorated cementitious building article for external use, the article comprising:
an ink printed surface decoration ink layer in the form of a tie coat comprising crosslinked ink embedded-polymer matrix covalently bonded to an adjacent coated supporting surface,
wherein the crosslinked ink embedded-polymer matrix comprises one or more of: a plurality of cured ink droplets and/or cured ink domains having interstitial ink-free spaces that access the surface bearing the surface decoration ink layer, the cured ink droplets and/or cured ink domains being embedded in the crosslinked ink embedded-polymer matrix, wherein at least some of the interstitial ink-free spaces are occupied by a crosslinked polymer of the crosslinked ink embedded-polymer matrix.

15. The surface decorated cementitious building article of claim 14, wherein the crosslinked ink embedded-polymer matrix embeds the cured ink droplets and/or cured ink domains in situ within the crosslinked polymer matrix while preserving the cementitious building article surface decoration.

16. The surface decorated cementitious building article of claim 14, wherein the adjacent coated supporting surface to which the crosslinked ink embedded-polymer matrix is covalently bonded is a surface provided with one or more of: a cured sealer coating, a cured primer coating, a cured paint coating, and a first cured tie coating.

17. The surface decorated cementitious building article of claim 16, wherein the crosslinked ink embedded-polymer matrix is provided with an overcoat of a second cured tie coating.

18. A surface decorated cementitious building article, the article comprising:
a discontinuous printed ink layer disposed on a surface of a cementitious building article substrate, the discontinuous printed ink layer comprising a plurality of cured ink droplets and/or cured ink domains arranged with interstitial ink-free spaces therebetween; and
a crosslinked polymer matrix disposed over the discontinuous printed ink layer and extending at least partially into the interstitial ink-free spaces,
wherein at least a portion of the crosslinked polymer matrix extends through the interstitial ink-free spaces to contact the surface of the cementitious building article substrate and the cured ink droplets and/or cured ink domains, and
wherein the crosslinked polymer matrix is formed by polymerization of a curable composition comprising monomers and/or oligomers within at least some of the interstitial ink-free spaces, the crosslinked polymer matrix securing the ink layer to the surface of the cementitious building article substrate.

19. The surface decorated cementitious building article of claim 18, wherein the cementitious building article substrate comprises one or more coating layers, and wherein the discontinuous printed ink layer is disposed over the one or more coating layers.

20. The surface decorated cementitious building article of claim 19, wherein the one or more coating layers comprises a sealer layer, a primer layer, a paint layer, or a combination thereof.
